(19) United States
(12) Patent Application Publication
(10) Pub. No.: US 2026/0292611 A1
(43) Pub. Date: Sep. 24, 2026

(54) METHODS, ARCHITECTURES, APPARATUSES AND SYSTEMS FOR JOINT RADIO AND NON-RADIO MEASUREMENT BASED MOBILITY

(71) Applicant: InterDigital Patent Holdings, Inc., Wilmington, DE (US)

(72) Inventors: Umer Salim, Vallauris (FR); Pascal Adjakple, Great Neck, NY (US); Ravikumar Pragada, Warrington, PA (US)

(73) Assignee: InterDigital Patent Holdings, Inc., Wilmington, DE (US)

(21) Appl. No.: 19/475,561

(22) PCT Filed: May 2, 2024
(86) PCT No.: PCT/US2024/027500

§ 371 Date: Oct. 15, 2025

Related U.S. Application Data
(60) Provisional application No. 63/464,434, filed on May 5, 2023.

(51) Int. Cl. H04W 36/00

(52) U.S. Cl. CPC H04W 36/0058

(57) ABSTRACT

Procedures, methods, architectures, apparatuses, systems, devices, and computer program products for network controlled L1/L2 triggered mobility (LTM) procedures are provided. An example method includes sending information indicating a capability of measuring radio quantities and non-radio quantities associated with measurement of one or more rotational or translational motions; receiving configuration information indicating zone configuration for determining a zone from radio and/or non-radio measurements and/or a set of mobility configurations associated with the radio and/or non-radio measurements and a set of joint events; estimating, based on the configuration information, one or more radio and/or non-radio measurements; and transmitting, based on a joint event of the set of joint events being triggered, a measurement report indicating the radio and/or non-radio measurements and zone information derived from the estimated non-radio measurements.

### CROSS-REFERENCE TO RELATED APPLICATION

This application claims priority to and the benefit of U.S. Provisional Application No. 63/464,434 filed in the U.S. Patent and Trademark Office on May 5, 2023, the entire contents of which being incorporated herein by reference as if fully set forth below in their entirety and for all applicable purposes.

### BACKGROUND

Evolution of wireless systems with the new applications requiring low-latency, high-reliability and high-availability has resulted in greater focus and activity to the service continuity while being in mobility and to minimize the service interruptions due to mobility. To that end, 3GPP has defined and standardized several mechanisms where mobility interruptions are minimized through faster switching of beams, cells and network nodes.

### SUMMARY

In a radio access network (RAN), current mobility procedures may operate at the radio resource control (RRC) layer. The RRC layer may also be referred to as Layer 3 (L3). To improve current mobility procedures, a WTRU and/or a network entity (e.g., a base station, a gNB) may perform (e.g., control) mobility procedures, such as lower layer triggered mobility procedures (e.g., L1/L2 mobility), for example, in a 5G New Radio (NR) system.

The present disclosure is generally directed to the fields of communications, software and encoding, including, for example, to methods, architectures, apparatuses, systems directed to Layer 1/Layer 2 (L1/L2) mobility of wireless transmit/receive units (WTRUs) which may be based on radio and/or non-radio measurements. L1/L2 mobility may be controlled based on radio and/or non-radio measurements.

In certain representative embodiments, procedures for activation and/or deactivation of L1/L2 configurations, radio and/or non-radio measurements may be performed (e.g., at a WTRU and/or a network entity) for L1/L2 triggered mobility (LTM).

In certain representative embodiments, network controlled L1/L2 triggered mobility (LTM) procedures are performed. One or more of the LTM procedures may include measurements and triggers over radio and/or non-radio measurement quantities. For example, WTRU capability being transmitted or transferred for lower layer mobility, and/or LTM handling and relevant assistance information may be used. One or more of the LTM procedures may include or be accompanied with reporting of a set of radio and/or non-radio measurements.

For example, a WTRU may receive LTM configuration(s) along with suitable LTM radio and non-radio measurement quantities and suitable events for reporting purpose. In an example, a WTRU may perform one or more configured radio and/or non-radio measurements. In an example, a WTRU may detect the change in non-radio and/or radio measurement quantities. In an example, a WTRU may determine its zone through non-radio measurements.

In an example, a WTRU and/or a network entity may evaluate the configured event(s) with the conditions set over (or associated with) measurements of radio and/or non-radio quantities. In an example, a WTRU may perform event-based WTRU reporting of its zone, location/position and radio measurement quantities according to the configuration, in case of event triggering.

In an example, a WTRU may receive one or more network commands to perform LTM mobility switch, and the network may use the WTRU reporting of radio and/or non-radio measurement quantities (and/or other system level aspects) to determine suitable target cell/beam configuration for the WTRU. In an example, a WTRU may perform an LTM mobility switch as per the network command or indication, or per one or more procedures discussed herein.

In an example, a WTRU may send information indicating a capability of measuring radio quantities and non-radio quantities associated with measurement of one or more rotational or translational motions; receive configuration information indicating zone configuration for determining a zone from radio and/or non-radio measurements and/or a set of mobility configurations associated with the radio and/or non-radio measurements and a set of joint events; estimate, based on the configuration information, one or more radio and/or non-radio measurements; and transmit, based on a joint event of the set of joint events being triggered, a measurement report indicating the radio and/or non-radio measurements and zone information derived from the estimated non-radio measurements.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a procedural diagram illustrating an example procedure for an intra-NR inter-gNB handover;

FIG. 3 is a procedural diagram illustrating an example procedure for intra-NR RAN conditional handover;

FIG. 4 is a system diagram illustrating a first example of multi-TRP transmission with single-DCI and a second example of multi-TRP transmission with multi-DCI;

FIG. 5 is a procedural diagram of an example procedure for initial configuration and configuration update for coverage information and LTM configurations;

FIG. 6 is a LTM measurement framework diagram illustrating an example of associations between a LTM measurement identity and LTM measurement resource configurations;

FIG. 7 is a LTM measurement framework diagram illustrating another example of associations between a LTM measurement identity and LTM measurement resource configurations;

FIG. 8 is a LTM measurement framework diagram illustrating another example of associations between a LTM measurement identity and LTM measurement resource configurations, LTM measurement quantity configurations, and reporting configurations;

FIG. 9 is a LTM measurement diagram illustrating an example LTM measurement model with L1/L2 filtering;

FIG. 10 is a LTM measurement diagram illustrating an example LTM measurement model with L1 and L3 based events;

FIG. 11 is a LTM measurement diagram illustrating an example LTM measurement model with measurement biasing;

FIG. 12 is a LTM measurement diagram illustrating an example LTM measurement model unified with L3 based measurements;

FIG. 13 is a procedural diagram illustrating an example of a lower layer (L1/L2) mobility procedure using radio and non-radio measurements;

FIG. 14 is a procedural diagram illustrating an example procedure for activation of LTM configurations based upon UE reporting;

FIG. 15 is a procedural diagram illustrating an example procedure for lower layer (L1/L2) mobility with UE reporting one or more target configuration candidates; and

FIG. 16 is a procedural diagram illustrating a representative procedure for lower layer (L1/L2) mobility with UE signaling over one or more target configuration candidates.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

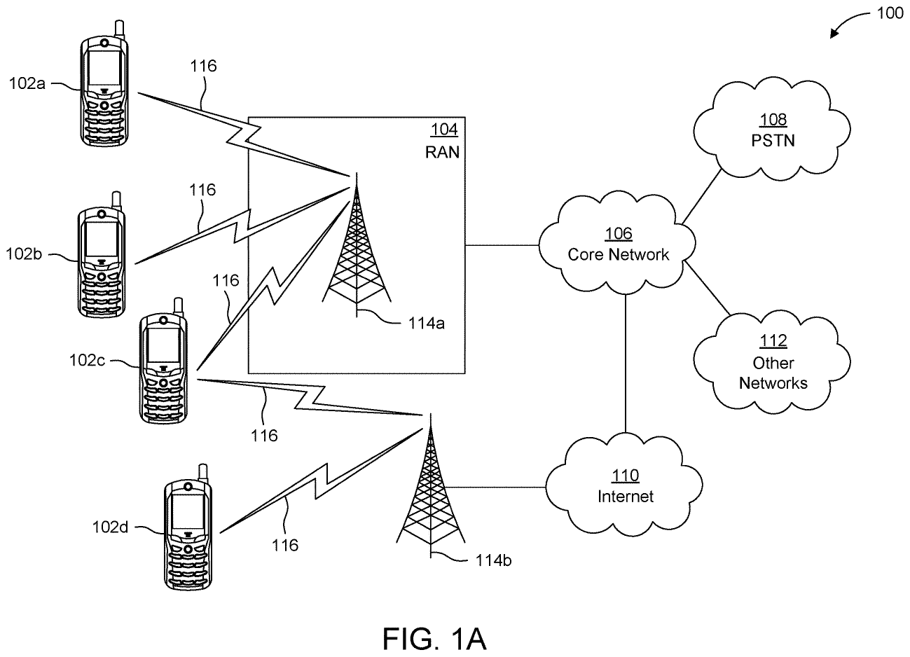

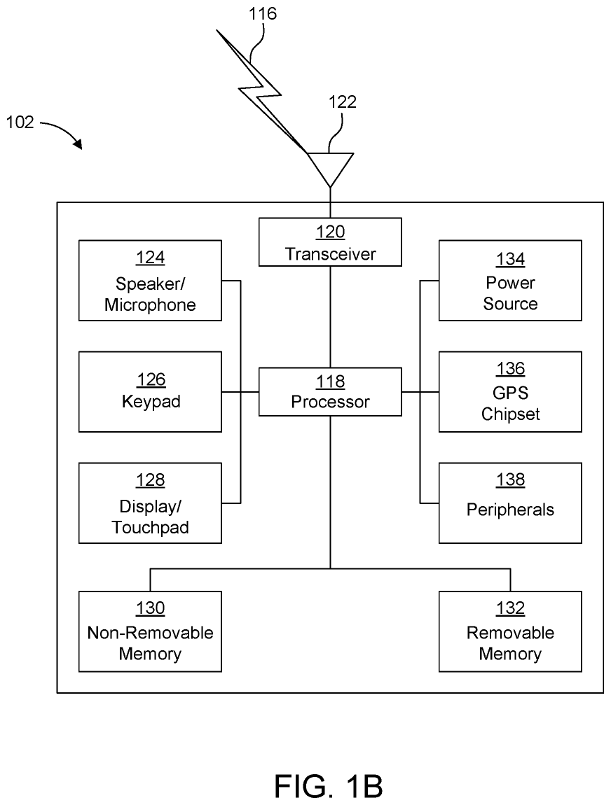

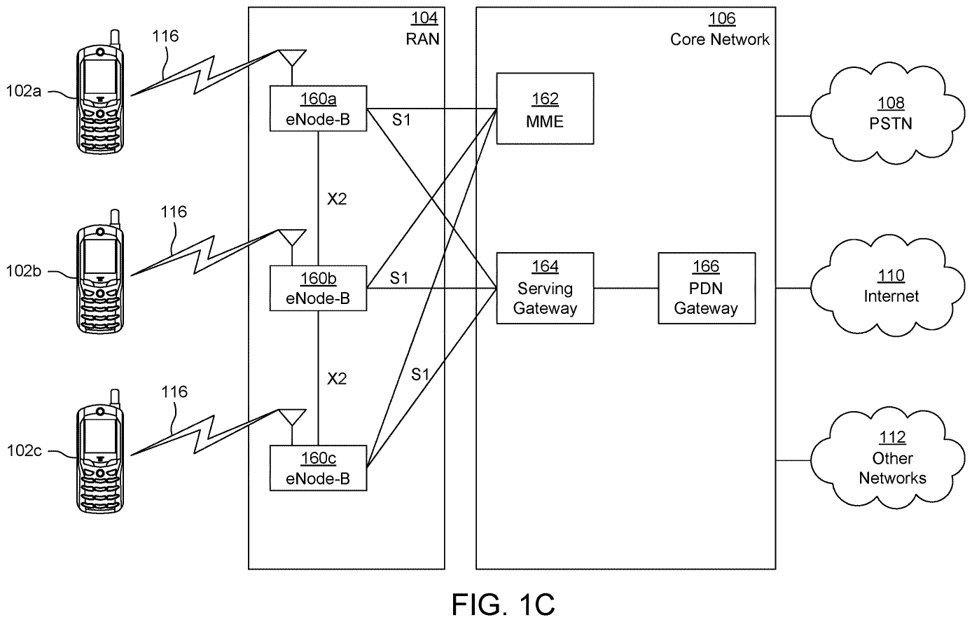

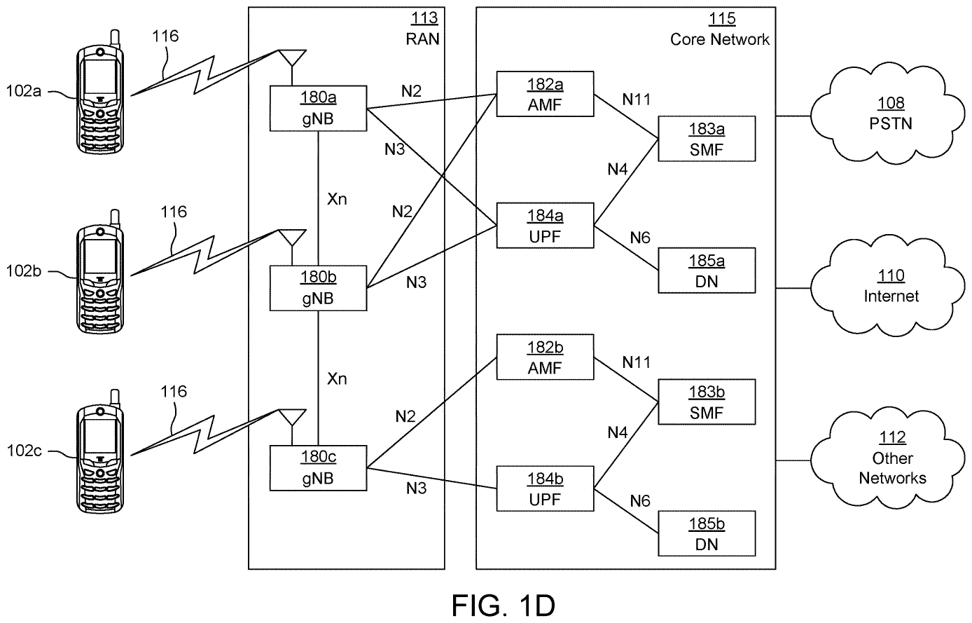

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

The following acronyms and abbreviations may be used herein:
3GPP: 3rd Generation Partnership Project
BFD: Beam Failure Detection
BFI: Beam Failure Instance
BFR: Beam Failure Recovery
BFDR: Beam Failure Detection and Recovery
DAPS: Dual Active Protocol Stack
C-RNTI: Cell RNTI
CE: Control Element
CFRA: Contention Free RACH Access
CHO: Conditional Handover
CN: Core Network
CORESET: Control Resource Set
CSI: Channel State Information
CSI-RS: CSI Reference Signals
CU: Control Unit
DAPS: Dual Active Protocol Stack
DCI: Downlink Control Information
DL: Downlink
DMRS: Demodulation Reference Signals
DRX: Discontinuous Reception
DU: Distributed Unit
E-UTRAN: Enhanced Universal Terrestrial Radio Access Network
FoV: Field of View
FR1: Frequency Range 1
FR2: Frequency Range 2
GCS: Global Coordinate System
gNB: Next Generation Node B
GNSS: Global Navigation Satellite System
GPRS: General Packet Radio Service
GSM: Global System for Mobile Communications
HO: Handover
IE: Information Element
ICBM: Intra-Cell Beam Management
Layer 1: L1
Layer 2: L2
Layer 1/Layer 2: L1/L2
Layer 3: L3
LCS: Local Coordinate System
LAN: Local Area Network
LMF: Location Management Function
LTM: L1/L2 Triggered Mobility
MAC: Medium Access Control
MAC-CE: MAC Control Element
MCG: Master Cell Group
MIB: Master Information Block
MIMO: Multiple Input Multiple Output
mmWave: Millimeter wave
NCJT: Non-Coherent Joint Transmission
NG-RAN: Next Generation Radio Access Network
NR: New Radio
NTN: Non-Terrestrial Network
OOO: Out of Sync
PCI: Physical Cell Identity
PDCCH: Physical Downlink Control Channel
PDCP: Packet Data Convergence Protocol
PDSCH: Physical Downlink Shared Channel
PHY: Physical
PLMN: Public Land Mobile Network
PRACH: Physical Random Access Channel
PSS: Primary Synchronization Sequence
PUCCH: Physical Uplink Control Channel
PUSCH: Physical Uplink Shared Channel
QCL: Quasi Co-Location
QoE: Quality of Experience
QoS: Quality of Service
RACH: Random Access Channel
RAN: Radio Access Network
RAT: Radio Access Technology
RB: Resource Block
RLC: Radio Link Control
RLF: Radio Link Failure
RLM: Radio Link Monitoring
RLM-RS: Radio Link Monitoring Reference Signals
RNA: RAN Notification Area
RNTI: Radio Network Temporary Identifier
RRC: Radio Resource Control
RS: Reference Signal
RSARP: Reference Signal Antenna Relative Phase
RSRP: Reference Signal Received Power
RSRQ: Reference Signal Received Quality
RSSI: Reference Signal Strength Indicator
RSTD: Reference Signal Time Difference
Rx: Receive
SCG: Secondary Cell Group
SCS: Sub-Carrier Spacing
SIB: System Information Block
SINR: Signal to Interference and Noise Ratio
SpCell: Special Cell. This is the primary cell of the master cell group. For dual connectivity operation, this could be the primary cell of the secondary cell group.
SRS: Sounding Reference Signals
SSB: Synchronization Signal and Physical Broadcast Control Channel Block
SSS: Secondary Synchronization Sequence
TA: Tracking Area
TCI: Transmission Configuration Indication
TRP: Transmission Reception Point
TTT: Time to Trigger
Tx: Transmit
UE: User Equipment
UL: Uplink
UTRAN: Universal Terrestrial Radio Access Network
WLAN: Wireless LAN

### Overview

### NR—Layer 3 Mobility Procedures

Generally, WTRU mobility may result in cell changes for service continuity. Legacy mobility procedures primarily operate at the RRC layer (e.g., layer 3 or L3). A network and a WTRU may exchange messages, measurements and configurations prior to cell change. An overview of L3 mobility procedures is provided as follows.

### NR Inter-gNB Handover Procedure

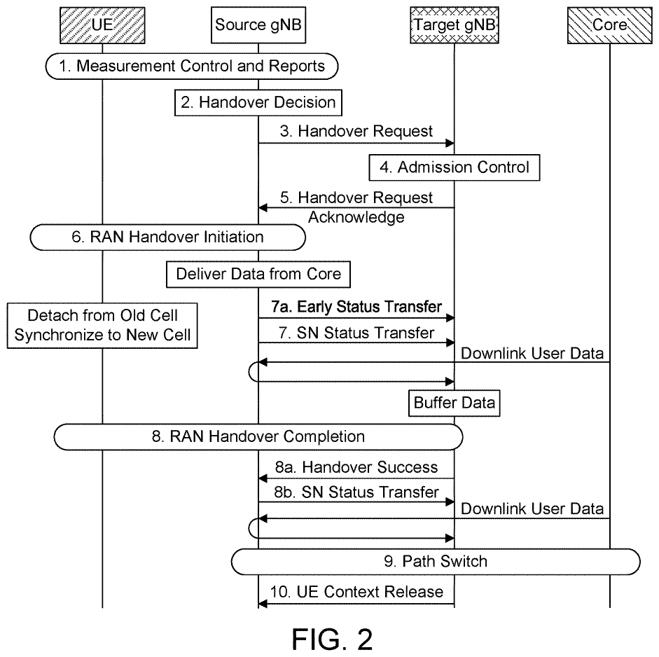

FIG. 2 is a procedural diagram illustrating an example procedure for an intra-NR inter-gNB handover. The procedure shown in FIG. 2 may be referred to as a legacy handover herein. When a UE is in RRC_Connected mode, cell and/or gNB-level mobility may require explicit RRC signaling to be triggered. A UE may report a cell quality measurement to a serving (e.g., source) cell of the WTRU when a neighboring cell quality is an offset better for a (e.g., preset) duration of time referred to as a time-to-trigger (TTT). Different events referred to as A1, A2, A3, A4, A5, etc. are defined for UE measurement report triggering in 3GPP TS 38.300. The TTT and the cell specific offsets may be specified during the measurement configuration step. If a handover (HO) decision is made based on the measurement report, the source gNB may issue a handover request to the target gNB. If the UE is admitted by the target gNB, the target gNB may send a handover request acknowledgement to the source gNB (e.g., which contains an RRC message to be sent to the UE). Next, the source gNB initiates the handover and sends the RRC Reconfiguration message to the UE. The source gNB can also include a set of dedicated RACH resources. After, the UE may synchronize to the target cell and complete the RRC handover procedure. The overall HO procedure is shown in FIG. 2.

For example, the HO process may fail due to poor channel qualities of the target gNB, the source gNB or both. In a scenario with directional links, handover problems may be exacerbated because the link qualities of the target and source gNBs can deteriorate quickly due to mobile blockers or UE rotations. First, the blockage of a target gNB during a handover procedure may result in a handover failure (HOF). When the UE receives RRC Reconfiguration message, a handover failure timer T304 is started. If the T304 timer expires before the handover is completed, a HOF is declared, and the UE may (e.g., must) perform connection re-establishment as described in 3GPP TS 38.331. Second, after a sudden UE rotation or a blockage, the source gNB may not be able to initiate a handover procedure in time based on the most recent measurement reports. Even the measurement reports from the UE may be lost due to poor link quality. Thus, without handover assistance from the source gNB, even when there are potential target gNBs with good channel qualities, the UE may need to either wait for the source gNB to recover from outage or declare an RLF.

### Dual-Active Protocol Stack (DAPS) Handover

As a potential solution to the target gNB being blocked, a dual-active protocol stack (DAPS) handover was specified in 3GPP 38.300 Rel-16. In DAPS handover, the UE does not release the source cell connection until random access to the target gNB is completed. If the target gNB link deteriorates before random access is completed, the UE can fall back to the source gNB.

### Conditional Handover (CHO)

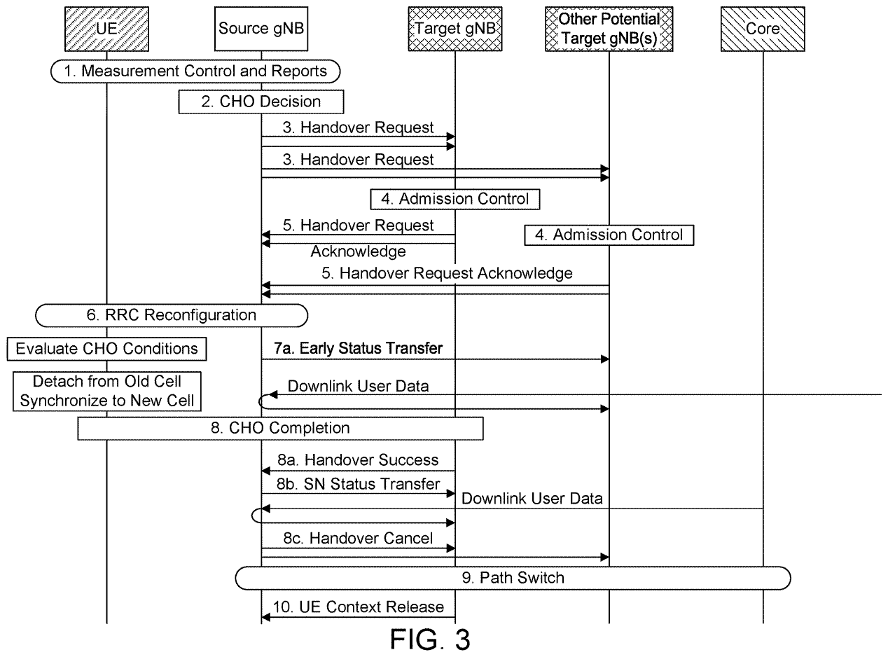

FIG. 3 is a procedural diagram illustrating an example procedure for intra-NR RAN conditional handover. To address the blockage of the source gNB, a conditional handover (CHO) was specified in 3GPP 38.331 Rel-16. In CHO, the UE may be configured to execute a handover when one or more handover execution conditions are met. The source gNB can proactively configure the UE to evaluate CHO execution conditions defined for candidate gNBs. Once the conditions are met (e.g., when the target gNB is an offset better than the source gNB), the UE may initiate the handover to a target gNB without the signaling from the source gNB. Thus, even when the source gNB is in outage state due to a sudden blockage or a rotation, the UE can still successfully complete a handover with the target gNB if a CHO execution condition is satisfied. The overall CHO procedure is illustrated in FIG. 3.

Although CHO is resilient to mobile blockers and can significantly reduce the number of RLFs originating from fast deteriorating links, the success of CHO depends on the availability of candidate gNBs before the failure of the source link, the link quality of the target links, as well as the conditional thresholds for the target gNBs. Even where candidate gNBs are present, a UE needs to be able to maintain the link quality with the selected candidate gNB until handover completion. Furthermore, careful configuration of the conditional thresholds for the handover execution may also be needed. Higher threshold values may lead to a UE failing to timely execute the handover to a target gNB resulting in a failed handover. On the other hand, lower threshold values may lead to a sub-optimal choice of a new serving gNB and potentially useless handovers in certain cases.

### Rel-16 Multi-TRP Operation and Rel-17 Inter-Cell Beam Management

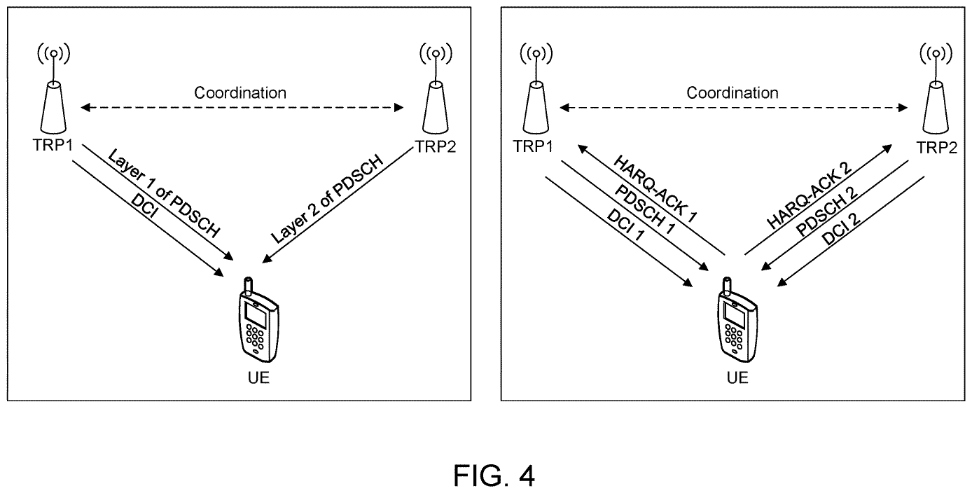

Multi-TRP transmission mechanisms which were standardized in 3GPP Rel-16 are limited to intra-cell cases. These multi-TRP transmission mechanisms are specified to support non-coherent joint transmission (NCJT), which may improve downlink data rates and spectral efficiency, such as for users at a cell edge. Considering various backhaul capabilities (e.g., ideal backhaul, non-ideal backhaul) in practical deployments, two different NCJT-based transmission schemes are supported: single-downlink control information (DCI)-based and multi-DCI-based. The left diagram in FIG. 4 is a system diagram illustrating an example of NCJT-based transmission with single-DCI. The right diagram in FIG. 4 is a system diagram illustrating an example of NCJT-based transmission with multi-DCI.

For example, Rel-16 single DCI based transmission schemes may be more suitable for ideal backhaul between the TRPs as a single DCI may schedule the resources from two TRPs. To receive DL data from different TRPs, the UE may be provided with two TCI states, and each TCI state corresponds to one TRP and provides the quasi co-location (QCL) information for the corresponding PDSCH layers. Different TCI code points may be activated by the MAC layer as described in 3GPP 38.321. The scheduling DCI indicates one of the activated TCI code points having 2 TCI states.

For example, Rel-16 multi-DCI based transmission schemes may support scenarios with non-ideal backhaul where each TRP uses its own DCI to schedule its resources. In the RRC configuration, two TRPs may be implicitly represented with two different control resource set (CORESET) groups. Each of which may be identified by the value of RRC parameter “CORESETPoolIndex.”

3GPP standardized inter-cell beam management (ICBM) in Rel-17 where multi-TRP operation has been extended to the inter-cell cases. A TCI state is allowed to be defined from a synchronization signal block (SSB) that is associated with a physical cell identity (PCI) different than the cell to which the UE is RRC_Connected, which enables inter-cell multi-TRP operation by proper configuration and activation of TCI states that can be associated with either of the PCIs.

Followed by Rel-16 standardization of intra-cell multi-TRP operation and Rel-17 inter-cell multi-TRP operation, L1/L2 triggered mobility (LTM) is part of ongoing 3GPP Rel-18 work.

For example, in networks employing higher carrier frequencies, narrow beam transmissions may occur requiring very dense deployments. A traditional mobility framework based upon higher layer measurements, cell measurements, reporting, cell changes and/or update decisions and executions may involve very large overhead and incur latencies which far exceed the timescale of mobility events with narrow beams.

In some examples, LTM is one of the promising areas to minimize mobility interruptions. A significant reduction in mobility interruptions may be possible by, for example, combining radio based and non-radio based measurements leading to a more deterministic manner of mobility handling. In some other examples, reduction in mobility interruptions may be realized by minimizing the latency associated with measurement reporting, decision making, and/or transmission of mobility commands.

For example, certain embodiments may enable L1/L2 mobility features, such as measurements and events set over a combination of radio and/or non-radio measurement quantities. For example, a WTRU may be configured to perform LTM procedures based on a combination of radio and non-radio measurements.

### Representative LTM Procedure Based Upon Joint Radio and Non-Radio Quantities (Location and Orientation) without Network Deployment Information

In certain representative embodiments, a WTRU may be provided configuration of zone determination but is not provided the network deployment information. In an example, the WTRU makes use of non-radio quantities, notably location, and orientation information, combined with 3GPP radio measurements to trigger the lower layer reporting to the network. The reporting lets the network know a suitable cell and beam for the WTRU for which the cell issues cell switch command to the WTRU.

In one embodiment, a WTRU may be configured with new or updated WTRU capability, for example, WTRU capability transfer for lower layer mobility/LTM handling and relevant assistance information, to support LTM procedure based upon radio and/or non-radio measurement quantities.

In one embodiment, a WTRU may receive configuration to determine zone information and the orientation specific parameters and references (e.g., reference TRP selection).

In one embodiment, a WTRU may receive LTM configurations along with suitable LTM radio and non-radio measurement quantities and suitable events for reporting purpose set over a combination of configured measurements. In this embodiment, non-radio measurements and events on zone entry (e.g., LTM-CM2) and orientation matching a given TRP (e.g., LTM-OT1) are combined with radio signal measurements. The network may configure the WTRU with events capturing radio and non-radio measurements. The network configuration may indicate the joint events such as LTM-J1, LTM-J2, . . . LTM-J5. In one example, the network may configure a set of individual events such as LTM-CM2O1 for non-radio measurements and LTM-A3/LTM-A4 for radio measurements. The configuration may indicate that triggering of these events would trigger WTRU reporting.

In one embodiment, a WTRU may perform configured radio and non-radio measurements over its location and orientation according to the configured periodicity.

In one embodiment, a WTRU may detect the change in non-radio or radio measurement quantities.

In one embodiment, a WTRU may determine its zone through non-radio measurements.

In one embodiment, a WTRU may evaluate the configured events with the conditions set over location and orientation.

In one embodiment, a WTRU may perform event based reporting, the WTRU reporting may include sending/reporting its zone information, location/position and configured radio measurement quantities according to the configuration, in case of event triggering for WTRU entering a specific zone and having orientation matching a given TRP according to the configuration.

In one embodiment, a WTRU may receive the network command to perform LTM mobility switch where the network may use the WTRU reporting and other system level aspects to determine the suitable target cell/beam configuration for the WTRU.

In one embodiment, a WTRU may perform the LTM mobility switch as per the network command(s) or indication.

In one embodiment, a WTRU may perform the protocol stack handling as per the network indication in dynamic signaling or part of the LTM configuration.

In one embodiment, a WTRU may transmit uplink (UL) indication as per the network configuration/indication where the network may indicate through LTM switching command or through prior configuration to transmit a reference signal (RS) or UL control (e.g., PUCCH) based indication.

### LTM Based Upon Radio and Non-Radio Measurements with WTRU Autonomous Activation of Measurement Configurations Based Upon WTRU Determined Zone Determination

In certain representative embodiments, a WTRU may be provided the configuration of zone determination but is not provided the network deployment information. In this case, the WTRU makes use of its location information to determine its zone according to the network configuration. As part of the LTM procedure, the network configures the WTRU with suitable LTM candidates. To reduce the measurements and tracking overhead associated to LTM candidate tracking/synchronization, the LTM measurements are mapped to relevant zones. These measurements thus need to be estimated and reported only upon WTRU determining itself in those zones. Thus, this provides a selection mechanism for WTRU to activate suitable set of measurement configurations. Thus, upon entering in specific locations/zones, the WTRU may activate the relevant measurement configurations. This activation results in WTRU tracking the radio and non-radio measurements quantities which are part of these active measurement configurations. These measurements can then result in WTRU reporting to the network according to the reporting and triggers in these measurements.

In certain representative examples, a WTRU may perform WTRU capability transfer for lower layer mobility and/or LTM handling and relevant assistance information to support LTM procedure, based upon radio and non-radio measurement quantities.

In certain representative examples, a WTRU may receive (e.g., from network) configuration and suitable parameters to determine zone information.

In certain representative examples, a WTRU may receive LTM configurations for candidate cells.

In certain representative examples, a WTRU may receive LTM relevant measurement configurations. The measurement configurations include, for example, the definitions and parameters for radio and non-radio measurement quantities which are linked to LTM candidate configurations. In addition, the measurement configuration provides the information of association to certain zones where these measurement configurations become activated and need to be estimated/monitored/tracked. The measurement may be part of measConfig in RRCreconfiguration or through a new information element (IE) for LTM procedures (e.g., especially designed for LTM procedures). The association of measurement configuration to zones may be achieved through explicitly providing a set of zone identities where this measurement configuration gets activated, or this information may be provided in a different information element.

In certain representative examples, a WTRU may perform configured non-radio measurements over its location according to the configured periodicity.

In certain representative examples, a WTRU may detect a change in non-radio or radio measurement quantities.

In certain representative examples, a WTRU may determine its zone through non-radio measurements.

In certain representative examples, upon change of the zone of a WTRU, the WTRU may activate the measurement configurations which are configured to be activated in the new zone. In some cases, the WTRU may de-activate the measurement configurations which are not configured to be activated in the new zone.

In certain representative examples, a WTRU may estimate the radio and non-radio measurement quantities associated to the activated measurement configurations.

In certain representative examples, a WTRU may evaluate the configured radio and non-radio events with the conditions set over measurements of radio and non-radio quantities.

In certain representative examples, a WTRU may perform event based WTRU reporting of its zone information, location/position, and radio measurement quantities according to the configuration (e.g., in case of event triggering).

In certain representative examples, a WTRU may receive the network command to perform LTM mobility switch where the network may use the WTRU reporting and other system level aspects to determine the suitable target cell/beam configuration for the WTRU.

In certain representative examples, a WTRU may perform the LTM mobility switch as per the network command or indication.

In certain representative examples, a WTRU may perform the protocol stack handling as per the network indication in dynamic signaling or part of the LTM configuration.

In certain representative examples, a WTRU may transmit UL indication as per the network configuration/indication where the network may indicate through LTM switching command or through prior configuration to transmit a reference signal (RS) or UL control (e.g., PUCCH) based indication.

### LTM Based Upon Joint Events on Radio and Non-Radio Quantities and Network Deployment Information

In certain representative embodiments, a WTRU may indicate (e.g., to a network) a capability thereof for supporting lower layer mobility and/or LTM handling as well as (e.g., the capability to receive and/or use) relevant assistance information to support LTM procedures based on joint radio and non-radio measurement quantities.

In certain representative embodiments, a WTRU may receive information indicating coverage and/or deployment topologies. For example, the WTRU may receive one or more relevant configurations and/or indications from the network (e.g., related to zone determination).

In certain representative embodiments, a WTRU may receive information indicating one or more LTM configurations, along with suitable LTM radio and/or non-radio measurement quantities and suitable joint events (e.g., for reporting purpose) set over a combination of radio measurements and non-radio measurements. The network may indicate any of proposed joint events (such as one or more of LTM-J1 to LTM-J6) as part of the LTM configuration(s).

In certain representative embodiments, a WTRU may perform one or more (e.g., configured) radio and/or non-radio measurements, based on one or more LTM configuration(s) received from the network.

In certain representative embodiments, a WTRU may detect a change in one or more non-radio and radio measurement quantities.

In certain representative embodiments, a WTRU may determine its zone through non-radio measurements.

In certain representative embodiments, a WTRU may evaluate the configured joint event with the conditions set over measurements of radio and non-radio quantities.

In certain representative embodiments, a WTRU may perform event based WTRU reporting of its zone information, location/position, and radio measurement quantities according to the configuration (e.g., in case of event triggering).

In certain representative embodiments, a WTRU may receive the network command or indication to perform LTM mobility switch, and the network may use the WTRU reporting of radio and non-radio measurement quantities and other system level aspects to determine the suitable target cell/beam configuration for the WTRU.

In certain representative embodiments, a WTRU may perform the LTM mobility switch as per the network command or indication.

In certain representative embodiments, a WTRU may perform protocol stack handling as per the network indication in dynamic signaling or part of the LTM configuration.

In certain representative embodiments, a WTRU may transmit an UL indication as per the network configuration/indication, where the network may indicate (e.g., to the WTRU), through LTM switching command or through prior configuration, to transmit a reference signal (RS) or UL control (e.g., PUCCH) based indication.

### LTM Based on WTRU Reporting Potential Target Configuration Candidate

In certain representative embodiments, a network controlled LTM switching procedure is provided. In some examples, a WTRU may perform radio and non-radio measurements, and may assist in the LTM switching by providing the indication of suitable LTM target configuration(a) to the network. The selection of the suitable LTM target configuration is performed by the WTRU, for example, through tracking, measuring, and/or evaluating radio and non-radio quantities as per the network configuration or indication.

In certain representative embodiments, a WTRU may indicate (e.g., to a network) a capability thereof for supporting lower layer mobility and/or LTM handling as well as (e.g., the capability to receive and/or use) relevant assistance information to support LTM procedures based on joint radio and non-radio measurement quantities.

In certain representative embodiments, a WTRU may receive information indicating coverage and/or deployment topologies. For example, the WTRU may receive one or more relevant configurations and/or indications from the network (e.g., related to zone determination).

In certain representative embodiments, a WTRU may receive information indicating one or more LTM configurations, along with suitable LTM radio and/or non-radio measurement quantities and suitable joint events (e.g., for configuration selection purpose) over a combination of radio measurements and non-radio measurements. The network may indicate any of the proposed joint events (such as one or more of LTM-J1 to LTM-J6) as part of the configuration with suitable parameters and thresholds for the selection of a candidate configuration.

In certain representative embodiments, a WTRU may perform one or more (e.g., configured) radio and/or non-radio measurements, based on one or more LTM configuration(s) received from the network.

In certain representative embodiments, a WTRU may detect a change in one or more non-radio and radio measurement quantities.

In certain representative embodiments, a WTRU may determine its zone through non-radio measurements.

In certain representative embodiments, a WTRU may evaluate the configured joint event with the conditions set over measurements of radio and non-radio quantities for one or more activated LTM configuration candidates.

In certain representative embodiments, if one or more events associated with the configuration selection are triggered for at least one of the activated configuration candidates, the WTRU may select the at least one associated configuration candidate for network reporting. The WTRU may transmit an UL indication of the selected configuration candidate (e.g., to the network).

In certain representative embodiments, a WTRU may receive the network command or indication to perform LTM mobility switch. In an example, the network indication may indicate the WTRU to perform an LTM mobility switch to a target candidate, and the indicated target candidate may (or may not) be the same as the one selected by the WTRU (e.g., the selected configuration candidate by the WTRU).

In certain representative embodiments, a WTRU may perform protocol stack handling as per the network indication in dynamic signaling or part of the LTM configuration.

In certain representative embodiments, a WTRU may transmit an UL indication as per the network configuration or indication, and the network may indicate (e.g., to the WTRU), through LTM switching command or through prior configuration, to transmit a reference signal (RS) or UL control (e.g., PUCCH) based indication.

In certain representative examples, in case of more than one candidate configuration triggering the selection events, the WTRU may select the highest priority configuration for UL indication to the network, and the priority indication may be part of the LTM candidate configurations.

In certain representative examples, in case of more than one candidate configuration triggering the selection events, the WTRU may select the candidate configuration being transmitted from its current distributed unit (DU), and the DU information may be provided as part of the LTM configured candidate configurations.

In certain representative examples, in case of more than one candidate configuration triggering the selection events, the WTRU may provide a set of (e.g., a number of “N”) successful candidates as part of the UL indication. For example, a number of “N” successful candidates is includes or indicated in the network configuration.

### LTM Based on WTRU Transmitting UL Indication over Target Configuration Candidate(s)

In certain representative embodiments, an example of a network controlled LTM switching procedure is provided. For example, a WTRU may perform radio and non-radio measurements, and may assist in LTM switching by providing the indication of the suitable LTM target configuration (e.g., to the network). The selection of the suitable LTM target configuration may be performed, by the WTRU, through tracking, measuring, and/or evaluating radio and non-radio quantities as per the network configuration. In some examples, the WTRU is configured with transmission parameters for the candidate configurations, such that the indication relevant to the selected candidate is transmitted over the resource of the selected candidate. The signaling to the selected candidate may be RACH, a slim RACH preamble, and/or the transmission of a specific RS (such as SRS). The WTRU may be provided with relevant QCL parameters for indication transmission over the configured resource(s).

In certain representative embodiments, a WTRU may indicate (e.g., to a network) a capability thereof for supporting lower layer mobility and/or LTM handling as well as (e.g., the capability to receive and/or use) relevant assistance information to support LTM procedures based on joint radio and non-radio measurement quantities.

In certain representative embodiments, a WTRU may receive information indicating coverage and/or deployment topologies. For example, the WTRU may receive one or more relevant configurations and/or indications from the network.

In certain representative embodiments, a WTRU may receive information indicating one or more LTM configurations, along with suitable LTM radio and/or non-radio measurement quantities and suitable joint events (e.g., for configuration selection purpose) over a combination of radio measurements and non-radio measurements. The network may indicate any of the proposed joint events (such as one or more of LTM-J1 to LTM-J6) as part of the configuration for its selection. In some examples, each respective candidate configuration provides an UL indication resource and signaling parameters through which the WTRU may provide the UL indication upon selection of a candidate configuration.

In certain representative embodiments, a WTRU may perform one or more (e.g., configured) radio and/or non-radio measurements, based on one or more LTM configuration(s) received from the network.

In certain representative embodiments, a WTRU may detect a change in one or more non-radio and radio measurement quantities.

In certain representative embodiments, a WTRU may determine its zone through non-radio measurements.

In certain representative embodiments, a WTRU may evaluate the configured joint event with the conditions set over measurements of radio and non-radio quantities for one or more activated LTM configuration candidates.

In certain representative embodiments, if one or more events associated with the configuration selection are triggered for at least one of the activated configuration candidates, the WTRU may select the at least one associated configuration candidate. The WTRU may select the UL indication resource associated with the selected candidate configuration. The WTRU may transmit an UL indication (e.g., to the network) on the selected resource, using the signaling parameters associated with the selected candidate configuration.

In certain representative embodiments, a WTRU may receive the network command or indication (e.g., from a serving cell) to perform LTM mobility switch. In an example, the network indication may indicate the WTRU to perform an LTM mobility switch to a target candidate, and the indicated target candidate may (or may not) be the same as the one selected by the WTRU (e.g., the selected configuration candidate by the WTRU).

In certain representative embodiments, a WTRU may perform an LTM mobility switch to the target that the network indicated, based on the received network command or indication.

In certain representative embodiments, a WTRU may perform protocol stack handling based on the network indication (e.g., indicated in dynamic signaling or part of the LTM configuration).

In certain representative embodiments, a WTRU may transmit an UL indication as per the network configuration or indication, and the network may indicate (e.g., to the WTRU), through LTM switching command or through prior configuration, to transmit a reference signal (RS) or UL control (e.g., PUCCH) based indication.

In certain representative examples, in case of more than one candidate configuration triggering the selection events, the WTRU may select the highest priority configuration for UL indication to the network, and the priority indication may be part of the LTM candidate configurations.

In certain representative examples, in case of more than one candidate configuration triggering the selection events, the WTRU may select a candidate configuration being transmitted from its current distributed unit (DU), and the DU information may be provided as part of the LTM configured candidate configurations.

### Joint Radio and Non-Radio Measurements Based Solutions to Minimize Mobility Interruptions

The evolution of wireless systems with new applications requiring low-latency, high-reliability, and/or high-availability has resulted in greater focus and activity to service continuity while undergoing mobility and/or to minimize the service interruptions due to mobility. To that end, 3GPP has defined and standardized several mechanisms where mobility interruptions may be minimized through faster switching of beams, cells and network nodes.

In certain representative embodiments, a WTRU may achieve and/or control lower layer (e.g., L1/L2) triggered mobility using combined radio and non-radio measurement quantities for improving mobility procedures (e.g., deterministic mobility). In some examples, the enhanced mobility procedures include combining any of (i) the knowledge of network deployment of its nodes/cells/beams, (ii) the capabilities of WTRUs to make non-radio measurements in different forms, for example, tracking their movements and/or determining updated geographic location/position and orientation, (iii) the combining of the formerly described non-radio measurements with the measurements made over radio signals, (iv) lower-latency measurement framework for event evaluation and measurement reporting, and/or (v) fast execution of the lower layered triggered mobility procedures over such framework.

For example, in some cellular networks (e.g., public cellular networks), operators may be hesitant to share the deployment configuration fully with the devices as that may pose a certain level of risk to their installations. One aspect related to controlled environments and factory settings (such as warehouses) is the fact that the communicating devices (such as robots, industrial machines etc.) are also installed and operated by the same owner. This provides confidence that the network topology configuration will not be used for purposes other than the ones for which it is shared with the devices. To make broader use of the proposed strategies while still keeping the precise information secure, the deployment topology is provided in a different form where the zones are provided with suitable indication of cells/beams which are of interest in this zone. The proposed LTM strategy based upon joint radio and non-radio measurements can be broadly split into two major phases. In some examples, the first phase is the joint radio and non-radio measurements based LTM preparation phase. The preparation phase comprises the configuration and WTRU capability transfer to support one or more LTM procedures. The second phase is the execution phase that would be discussed in detail below.

In certain representative embodiments, the WTRU ability to fast detect its location/orientation and geographic coordinates may be used to choose the suitable node/cell/beam to which the WTRU should be connected to. The network may share a suitable finite piece of its deployment/coverage topology to the WTRUs which WTRUs use to report their precise instantaneous coverage coordinates to the network. The details on the coverage topology contents, configuration, maintenance, signaling mechanisms, and WTRU post-processing are provided herein.

Various embodiments are related to L1/L2 triggered mobility (LTM) procedures, the design for such LTM configurations and the updating procedure are provided below. In addition, WTRU capability and assistance information are discussed that the WTRU will provide to the network prior to getting configured for LTM configurations.

In certain representative embodiments, non-radio measurements may be used and/or combined with radio measurements in LTM procedures. Various embodiments for measurement frameworks combined over radio and non-radio measurements are described herein. For example, a WTRU may integrate (e.g., combine) measurements over 3GPP radio signals, non-3GPP radio signals, data from local sensors and other interfaces. To reduce latency and achieve stable measurements, different measurement models are proposed which may select measurement quantities from either L1, L3 or combinations thereof. Various embodiments for the framework for LTM measurements including measurement modeling, configuration, quantities, and/or event definitions are described herein. Various embodiments provide events for which trigger conditions are a combination of radio and non-radio measurement quantities, in order to achieve, for example, zero interruption mobility.

In certain representative embodiments, if an LTM procedure is running based only on radio measurements, due to noise and fading impacting the quality of radio signal estimations, there could be ping-pong effects where a WTRU may be switching back and forth among a group of cells. The use of non-radio measurements in combination with radio measurements helps avoid such ping-pong situations.

In certain representative embodiments, LTM switching procedures may be referred to as network controlled. For example, the network issues explicitly the command for a WTRU to switch from its serving cell to a target cell. In this examples, the network indicates an LTM cell switch command and provides information indicating (to the WTRU) how to handle of the data and control planes while switching cell using an LTM procedure. Several indication mechanisms are provided through which the network can configure the WTRU to provide indication on the target cell after the LTM cell switching.

In certain representative embodiments, an LTM cell switching procedure may include combining one or more (or all) of the preparation and execution steps, for example, assistance, configurations, measurements, WTRU reporting, the network command, and WTRU indication.

Various embodiments use the terminology of lower layer triggered mobility or L1/L2 triggered mobility (LTM) to certain representative procedures, where the cell switching triggers, commands and confirmations are exchanged primarily on lower layers of WTRU(s) and network, contrary to the legacy mobility procedures running over RRC signaling or layer 3. These lower layers are PHY layer or MAC layer (or a combination of both) as will be detailed in the embodiments.

### Joint Radio and Non-Radio Measurements Based LTM—Preparation

In certain representative embodiments, a preparation phase for joint radio and non-radio measurements based LTM procedure may refer to and/or include procedures relating to the configuration of the deployment topology, LTM cell configurations, measurement configurations, and WTRU capability signaling to the network to support LTM procedures.

### Deployment and Coverage Zones

Generally, cellular networks are planned networks with operators deploying network nodes at suitable locations to provide sufficient coverage to their subscribers. It should be expected that a network operator has (e.g., very precise) knowledge of its deployment of cells, and the beams within those cells in terms of coverage zone attributes, such as the locations (e.g., reference locations) of cells and/or transmission points (TRPs), potential spatial directions of transmissions (e.g., defined by azimuth, elevation angles and location coordinates of the TRPs), beam width information (e.g., 3-dimentional beam width information, horizontal and vertical direction information, transmission range information, and/or coverage shape information, such as location coordinates of points that constitute the coverage border of a beam, cell and/or TRP).

### Deployment Topology

In certain representative embodiments, a deployment topology may include information indicating the locations of TRPs, coverage of beams and/or orientation of beams. For example, a location (e.g., of a TRP) may be represented in terms of 2D coordinates, such as latitude and longitude coordinates. For example, a location may be represented in terms of 3D coordinates, such as with the addition of altitude or height to 2D coordinates. For example, 2D and/or 3D location representations may be in global and/or local coordinate systems.

In certain representative embodiments, beams from a given TRP may be represented using azimuthal and elevation angles. For example, suitable references may be used like cardinal directions and zenith, or reference directions can be provided as part of the configuration. Such angles may be provided with suitable refinements and/or quantization to capture meaningfully the mobility procedures and signal strengths within or out of the coverage for a given beam. In addition to the angles, the beam widths in these directions may be (e.g., additionally) provided, such as explicitly, for the beams. With the TRP location parameters and/or the beam angles (e.g., plus widths), a UE can prepare a local topology where it can determine (e.g., see) the coverage of different beams from different TRPs. In certain embodiments, additional attributes, such as range and/or power can be added to cell and/or beam information to further refine the deployment topology.

### Coverage Topology

In certain representative embodiments, a coverage topology may include information indicating the geographic coverage from different TRPs, such as for different beams. For example, a coverage topology may provide the coverage boundaries of different TRPs and/or different beams. A coverage topology may incorporate and/or indicate the nature of the terrain, topographic aspects, buildings, and other geographic parameters on the deployment topology to prepare suitable zones and boundaries associated to the coverage of different TRPs and/or different beams.

In certain representative embodiments, a coverage topology may include information indicating (e.g., be provided in the form of suitable) geometric shapes. To indicate the shapes delimiting the cells and/or beam level coverage, different reference shapes may be defined (e.g., predefined). The reference shapes can include (e.g., be in the form) any of circles, ovals, ellipses, and/or ellipsoids or other geometric shapes, such as with suitable parameterization. For example, a coverage topology may be indicated using these shapes with suitable attributes. These attributes may be associated with (e.g., provide links to) the cell and/or beam identities to which a given shape and/or area is associated.

### Configuration

As used herein, the terms deployment topology and coverage topology may be used synonymously (e.g., unless otherwise distinguished).

In certain representative embodiments, a coverage topology may be associated with an area, which may be referred to as a coverage topology area. For example, a coverage topology area may correspond to any of one or more cells, a RAN Notification Area (RNA), a tracking area (TA), and/or a PLMN, etc.

For example, each coverage topology may be defined at different granularities. The granularity of a coverage topology may be part of a coverage topology configuration. In an example, a coverage topology may be defined at a cell level. The information of geographic coverage from different gNBs and/or TRPs may be indicated to UEs with suitable signaling. For example, cell level coverage can be useful for different hand-over and cell change procedures.

For example, a coverage topology granularity may be represented (e.g., reflected in) the form of coverage zones. For cell level procedures, one or more coverage topology zones may have a (e.g., given) cell level granularity. For beam level procedures, where for example a UE may need to track, maintain, and/or switch beams, the coverage topology granularity may be defined (e.g., differently), such as at a beam level. Zones in a coverage topology may be associated with (e.g., attributed to) different beams.

For example, one or more zones can be attributed to one or more (e.g., given) beams from one or more (e.g., given) TRPs. A (e.g., further refined) granularity may be achieved by defining and associating zones to different directions from any (e.g., each) gNB and/or TRP. The zones in the coverage topology can be indicative of the geographic area which corresponds to a given set of reference signals. For beam level zones, in one design, each zone can indicate the coverage area for an SSB beam. In another beam level zone design, each zone can indicate the coverage area for an SSB beam or a CSI-RS beam where SSB/CSI-RS beam is the coverage for the corresponding SSB/CSI-RS signals. The configuration may specify a one-to-one or one-to-many correspondence where one-to-many correspondence may exist when criteria for zone delimitation is not SSB but some other signal or GPS coordinates. The one-to-many correspondence many exist as well for overlaid networks where multiple cells/beams may be serving overlapping areas.

For example, any (e.g., each) zone can be identified with an identity, which can be provided as part of the configuration. For example, any (e.g., each) zone identity may be any (e.g., deterministic combination) of identities of cells, TRPs, SSB and/or CSI-RS beams that it is attributed to. In certain representative embodiments, one or more formulae to compute a zone identity may be known to the network and/or the device a-priori. The network and/or devices may use (e.g., additional) modulating parameters, such as lengths, widths, number of SSB beams etc., which can be part of system information or the configuration.

For example, a different granularity for the zones can be at any of the gNB, TRP and/or cell level. For cell level zones, a zone may indicate an area where the cell has sufficient coverage. One or more criteria for sufficient coverage may be specified in terms of existing cell selection, re-selection criterion, and/or new criterion associated to suitable reference signals may be specified. For example, a cell level zone may group any (e.g., all) the SSB and/or CSI-RS zones associated to a given cell. A cell level zone may represent an area where any of the SSB and/or CSI-RS signals for the cell may be received with a known and/or configured quality. A zone representation may be extended to a (e.g., larger) granularities for RNA, TA and/or PLMN based coverage zones. A cell level zone identity may be a cell identity. A cell level zone identify may be a (e.g., deterministic) modification of the cell identity by combining it with one or more other parameters. For example, a same design may be used for zones to represent the coverage for RNA, TA, and/or PLMN etc.

In certain representative embodiments, a zone may be defined for any (e.g., each) location using longitude and latitude values. For example, zone dimension (e.g., length) information may be provided as part of the configuration. One or more formulas to compute the zones may be pre-defined and/or may be signaled as part of the configuration (e.g., from a pre-defined set). For example, a UE may compute zone identity as standardized in the 3GPP NR Sidelink work in Release-16. For example, the longitude and latitude values may be the geodesic distances from the geographical coordinates (0,0), as in used in the NR sidelink framework. Suitable parameters may be provided as part of the configuration to choose the zone modularity along the longitude and latitude directions. A (e.g., only one) single parameter may be used to choose the same modularity along longitude and latitude directions. For example, the parameter may be a fixed value to ease (e.g., reduce overhead signaling of) the configuration. In certain representative embodiments, all the devices may compute their zones and the zones for any location against the longitude and latitude coordinates of that location.

### Network Deployment Configuration

In certain representative embodiments, a deployment topology comprises of information about the location of TRPs and coverage/orientation of beams. For example, a location of one or more TRPs may be represented in terms of 2D coordinates, such as latitude and longitude coordinates. For example, a location may be represented in 3D coordinates, such as with the addition of altitude and/or height to 2D coordinates. 2D and/or 3D representations may be reference global or local coordinate systems. A zone configuration follows sidelink design, the TRP locations may be provided against the zones (e.g., instead of the longitude and latitude coordinates).

For example, one or more beams from a given TRP may be represented using azimuthal and elevation angles. Suitable references may be used like cardinal directions and zenith, or reference directions may be provided as part of the configuration. These angles may be provided with suitable refinement and/or quantization to meaningfully capture the mobility procedures and signal strengths within or out of the coverage for a given beam. For example, (e.g., in addition to the angles) the beam widths, such as in these directions, may be provided, such as explicitly for the beams.

### Network Coverage Configuration

In certain representative embodiments, the network may (e.g., directly) provide a coverage configuration in the form of (e.g., rich) shapes which may capture any (e.g., all) of the specific aspects of the local terrain, such as shadowing from buildings and/or other objects. For example, the network may not only precisely know the deployment of its cells, TRPs and/or beams but may also have access to topographical data using a navigation system, cameras, and/or the ongoing measurements on cells and/or beams from the devices which allow the network to (e.g., advantageously) have very precise coverage topology information. For example, using historic data in the form of network measurements, cells and/or beam transitions may be used to update and/or refine the coverage topologies. On the downside, this approach may have a large signaling overhead. For example, an amount of information that may need to be exchanged may be huge as the precise coverage for even a single beam may require a set of objects and their attributes communicated to a UE. The (e.g., large) signaling overhead may require several message exchanges at the RRC level leading to increased configuration latency.

In certain representative embodiments, zone configuration may the sidelink design. For example, the network may (e.g., will) provide different cells and/or beams coverage indication which provides the association of these cells and beams to zones.

### Hybrid Configuration

In certain representative embodiments, a topology configuration may be a hybrid of two approaches described herein. For example, a part of a configuration may be indicated in the form of a network deployment based configuration and a part of the configuration may be indicated using a coverage topology based configuration.

### Initial Configuration of Deployment and Coverage Topology

In certain representative embodiments, an initial configuration for a coverage topology may be communicated to a UE in the form of dedicated RRC signaling. For example, a UE in the RRC active state with mobility may be provided an initial coverage topology configuration. From the UE perspective, the signaling may be dedicated but the network may provide the same information to a set of UEs. These UEs can be in the vicinity of each other. Hence, the same coverage topology may be relevant for them.

In certain representative embodiments, the network (e.g., the base station) may broadcast coverage topology information. A (e.g., new) coverage topology system information block (SIB) may be specified. It should be understood that the coverage topology information broadcasted by a cell and/or a TRP may be configured to reflect the local deployment environment of the cell or TRP broadcasting the coverage topology.

In certain representative embodiments, an initial configuration may provide a coarse coverage topology which may need to be refined. Refinement to suitable granularities and coverage extension may be performed on the initial coverage topology (e.g., to be fully useful). For example, a coverage topology may be refined (e.g., suitably) through dedicated signaling. For example, a refinement may be network initiated, such as when configuring certain applications and/or flows with QoS constraints (e.g., necessitating proactive mobility). For example, a UE may request (e.g., initiate) the refinement of the coverage topology.

### WTRU Processing to Achieve Effective Coverage Topology

In certain representative embodiments, a network deployment topology may be shared with multiple UEs following the configuration solutions as described herein. For example, additional attributes may be added to a cell configuration. For example, a (e.g., new) configuration may be added having the geographic attributes and may link TRP and/or beam level configurations to legacy cell configurations. For mobility events and effective selection of beams, cells, and/or TRPs, a UE may be configured with (e.g., receive) a detailed effective coverage topology that may be referred to as an on-the-ground coverage topology. For example, a deployment topology may need to be rich (e.g., detailed) enough so that the deployment topology captures all the topographical and shadowing aspects. For example, a coverage topology may (e.g., should) take into account not only the TRP locations and beam attributes, but may (e.g., should also) incorporate the physical nature of the environment around including the specifics of the terrain, the buildings with all their physical attributes which may shadow, block and/or reflect the beams. In certain representative embodiments, a UE may acquire and/or fabricate an on-the-ground coverage topology.

### UE Processing over Network Provided Coverage Topology

In certain representative embodiments, a network provided deployment configuration may be made detailed (e.g., very rich) and refined and provided in the form of rich shapes which capture any (e.g., all) the specific aspects of the local terrain, shadowing from buildings and/or other objects. To indicate the shapes delimiting the cells and/or beam level coverage, different reference shapes may be defined. For example, reference shapes can be in the form of circles, ovals, ellipses, ellipsoids or other geometric forms, such as with suitable parameterization. The network may indicate these shapes with suitable attributes and provide their links (e.g., association) to the cell and/or beam identities. One advantage of doing so is that the network may precisely know the deployment details of its cells, TRPs and/or beams. For example, topographical data may be accessed using any of a navigation system, cameras, and/or the ongoing measurements on cells and/or beams from the devices which let it know very precise coverage topology. One additional advantage is the use of (e.g., all) historic data in the form of network measurements, cell and/or beam transitions that may be used to update and refine detailed coverage topologies. On the downside, there may be a large signaling overhead incurred. For example, the amount of information that may need to be exchanged may be huge as the precise coverage for (e.g., even) a single beam may require a set of objects and their attributes communicated to a UE. The large signaling overhead may require several message exchanges at the RRC level leading which may lead to increased configuration latency as well.

### UE Processing over Network Provided Deployment Topology

In certain representative embodiments, a network may provide to UEs a snapshot of the network's node deployments and (e.g., limited) information about the beams transmitted therefrom. For example, a network may provide such information as part of a deployment configuration. For example, the network may provide information about the TRP locations, beam angles and/or beam specific parameters (e.g., without modulating the coverage with the features of the local terrain). Due to reduced information as compared to the approach where the network provides a detailed coverage topology, the signaling overhead and latency performance may be improved.

In certain representative embodiments, devices may receive deployment features and/or parameters for TRPs and/or beams and may use local knowledge obtained through other technologies (e.g., local stored topography, positioning systems, cameras) to prepare a refined coverage topology which adds topographical aspects to a deployment configuration. For example, after local processing and fabrication, a UE may have an effective topology which delimits different coverage zones associated to different beams and/or cells. A refined coverage topology may be used in the beam and/or cell level mobility procedures at the UE. A local physical coverage topology may be refined with the mobility and/or additional information obtained from other sensors. As devices prepare effective topology information using the network provided deployment parameters combined with the information from local sensors, this requires availability of local sensors, additional storage and/or compute capabilities to prepare an effective topology by combing network deployment topology with the information from local sensors.

In certain representative embodiments, the obtaining of a refined coverage topology at the devices may be standardized. For example, there may be devices which are not equipped with the necessary local sensors, or the devices don't have the necessary compute power to process and fabricate a topology themselves. The network may send a refined topology to such devices. For example, the devices having the necessary local sensors, compute and/or storage power may receive only limited deployment features from the network and prepare an effective topology locally. The manner in which a topology is received may be dependent upon UE power consumption requirements, battery quality, remaining battery and/or as a function of active applications and their attributes.

### Maintenance of Deployment and Coverage Topologies

In certain representative embodiments, based on the detection of change in a coverage topology area, a UE may re-acquire a coverage topology for its current location. For example, the re-acquisition of a topology may use dedicated RRC signaling. For example, the re-acquisition of a topology may use a coverage topology SIB. For example, a UE may detect (e.g., determine) a change in coverage topology area based on any of the following: 1) a change in a serving cell and/or (re)selection to a cell that doesn't belong to a current coverage topology area; 2) a (re)selection to a RNA that doesn't belong and/or doesn't correspond to the current coverage topology area; 3) execution of a RNA update procedure and/or transmission of a RNA update message to the network (e.g., a base station); 4) a (re)selection to a TA that doesn't belong and/or a topology doesn't correspond to the current coverage topology area; 5) execution of a TA update procedure and/or transmission of a TA update message to the network (e.g., core network); and/or 6) (re)selection to a PLMN that doesn't belong and/or a or topology doesn't correspond to the current coverage topology area.

### Release of Deployment and Coverage Topology Configurations

In certain representative embodiments, a UE may discard information of a topology configuration, such as when the information becomes outdated. For example, an outdated indication may be derived if a UE changes its coverage area and is not able to acquire an updated coverage topology. For example, a topology configuration may be associated with the use of one or more time intervals (e.g., explicit timers) which may result in a UE releasing a configuration if expired. For example, a time interval (e.g., timer) may be refreshed if the UE is staying (e.g., remains) in the area associated with its current coverage topology. For example, a coverage topology area may be defined in terms of a RNA, TA, PLMN and/or another suitable criterion.

For example, the network may send an (e.g., explicit) indication to the UE to release its coverage topology configuration.

For example, a UE may (e.g., will) release a coverage topology configuration after the UE transitions out of a RRC active state (e.g., after receiving an RRC Release message)

### Network Indication of Deployment and Coverage Topologies

In certain representative embodiments, a deployment and/or coverage topology may be provided to a UE (e.g., by the network). Cell and/or beam configurations and/or mobility configurations may be associated with a deployment and/or coverage topology.

### Topology Indication as Part of Cell/Beam Configuration

In certain representative embodiments, a (e.g., deployment) topology may be part of a cell configuration. For example, a cell configuration may be part of a conditional (re)configuration associated to a PsCell or SCell. The cell configuration may be part of a conditional handover or conditional PSCell change/addition procedure. A deployment topology may be associated to any of the serving cell configurations and may be used for any of the beam management procedures, such as for beam switching, beam failure recovery. In certain representative embodiments, new attributes may be added to (e.g., included in) the cell configuration which may define the TRPs where this cell is being transmitted, the locations of these TRPs in suitable global or local coordinate systems, and/or the beam coverage attributes for the beams being transmitted through these TRPs. The cell configuration may provide the information on SSB beams and/or CSI-RS beams. The attributes for beams may be in the form of azimuthal and elevation angles with suitable reference directions. The reference directions may be taken from cardinal directions and/or may be indicated as part of the configuration itself. The range for the beams may be indicated as a per beam attribute or a single value which may indicate the unobstructed range (e.g., in view of the transmit power). The beam attributes may (e.g., additionally) define the beam width in horizontal and/or vertical directions. For example, a simple deployment may specify one single beam width attribute for the horizontal direction and one for the vertical direction which may be assumed to be the same for any (e.g., all) of the configured beams. For example, in deployments with varying beam width sizes, the network may provide one value for a TRP, and delta values may be provided for each beam. For example, the network may provide beam width as part of the beam configuration without any TRP or cell level indication. For example, the coverage for any (e.g., each) beam may be specified as an ellipsoid with suitable parametrization.

### Topology Indication as an Independent Dedicated Configuration

In certain representative embodiments, a topology may be provided as an individual configuration to UEs. For example, a coverage topology configuration may not be part of the cell configuration and/or the conditional (re-)configuration. A coverage topology may depend upon the geographic deployment and coverage but the configuration and signaling may be provided by the network independent of the cell configuration and/or other conditional (re-)configurations.

For example, a coverage topology configuration may be in the form of network nodes deployment and beam attributes. For example, a coverage topology configuration may be in the form of on the ground detailed coverage incorporating the topographic and terrain specific features. A coverage and/or deployment topology configuration may provide the linkage (e.g., association) of indicated TRP locations and beam attributes to the cell identities and cell configurations.

### Topology Indication as Broadcast Signaling

In certain representative embodiments, a deployment and/or coverage topology indication may be transmitted by the network in the form of broadcast signaling. This information can be broadcast by the network and the relevant devices may be pre-informed or may have prior knowledge of how to receive and decode this information. For example, the control information to locate topology related broadcast information may be broadcast, such as through (e.g., special) paging and/or downlink control information informing all the devices about the broadcast based topology information.

In certain representative embodiments, a topology indication may be treated as part of the system information. For example, a (e.g., new) system information block (SIB) may be designed which carries and conveys the deployment and/or coverage topology indication. The network may use periodic transmission of a topology SIB to keep the UEs aware of the topology information. The UEs which may be starting the relevant services where outages need to be minimized may send a (e.g., explicit) request to the network requesting the transmission of the topology SIB.

### Activation of Deployment and Coverage Topologies

In certain representative embodiments, the network may provide one or more snapshots of a deployment and/or coverage topology through RRC signaling. For example, the RRC signaling may be broadcast based or UE dedicated signaling. For example, the network may send a MAC-CE which may include information indicating one of the deployment/coverage topology snapshots which is considered as an activated topology. The activated topology may be used in LTM procedures, such as those described herein.

In certain representative embodiments, any of RRC signaling, MAC-CE and/or DCI may be used for topology activation. For example, a customized MAC-CE may be designed for this purpose, such as where the identity of the topology provides a pointer to one of the topologies configured through RRC signaling. For example, PHY based signaling, such as DCI, may be used to activate one of the configured topologies.

### LTM Configurations

As used herein, the terms LTM configuration, LTM candidate configuration, candidate configuration, target configuration and configuration, in general, may be used synonymously (e.g., unless otherwise distinguished).

For example, a LTM configuration may include a cell configuration (e.g., cell configuration information). A cell configuration may be provided by the network to the UE at various abstraction levels. As an example, the network may provide a cell configuration to the UE in the form of a serving cell configuration, such as by providing the information elements of “SCellConfig” or “SpCellConfig”. As an example, the network may provide a cell group configuration. A cell group configuration may include at least one “SpCellConfig”. As an example, the network may provide a cell configuration through an RRC-reconfiguration. An RRCReconfiguration message which may include a cell group configuration.

For example, a LTM configuration may include a measurement configuration (e.g., measurement configuration information). A measurement configuration may indicate a set of measurements over suitable radio and non-radio measurements. A measurement configuration may specify conditions which may trigger events upon fulfillment. For example, a LTM configuration may provide an association of one or more cell configurations and one or more measurement configurations.

In certain representative embodiments, a lower layer triggered mobility procedure may be used to switch a current serving cell for a more suitable target cell. For example, a current serving cell may be a primary cell of a master cell group, the primary cell of a secondary cell group, or any of the serving cells in the master, or secondary, cell group. Cell switching may require applying the cell configuration of a target LTM candidate configuration. For example, the LTM configuration may be provided as part of a cell group configuration, such as with a “CellGroupConfig” information element. For example, the LTM configuration may be provided through “SpCellConfig” or “SCellConfig” information elements (e.g., but may impose certain limitations in terms of LTM mobility scope).

For example, a UE may perform procedures related to monitoring and/or evaluating certain suitable LTM measurement quantities and, based on certain conditions getting fulfilled, events may be triggered. Any (e.g., each) event is associated with certain target configurations and triggering of an event may result in the UE executing the mobility to the associated target configuration. Details on LTM measurements and example events are described herein. An event may be linked to certain LTM configurations and triggering of the event may subsequently result in the WTRU reporting the configured reports to the network. In some cases, the WTRU may perform a mobility switch to the relevant candidate configuration for which the execution conditions are fulfilled.

In some examples, with LTM, a suitable set of configurations may be provided to the WTRU prior to mobility events, such configurations may be based on (e.g., exploit) the knowledge of cells (e.g., deployed through a same DU or through different DUs). In some examples, an LTW procedure may exploit the knowledge and overlap of configurations for cells (e.g., deployed through the same DU or through different DUs).

With dense networks using access points serving smaller areas through narrow beams and with the roll out of LTM feature, a UE may (e.g., potentially) be configured with several LTM configurations in addition to higher layer configurations already supported. Supporting many LTM configurations may provide the advantage that a UE may be able to make a faster LTM switch to one of the configured LTM candidates. One downside may be that the network needs to provide all these configurations to the UE which may consume transmission resources. In addition, the UE needs to keep all these configurations locally available to apply in case of LTM switching and needs to make measurements over the configured candidates and provide reporting to the network.

Following are some of the approaches that can be used how the configurations are provided from the network to the UE and how they are maintained at the UE.

### LTM Candidate Cells and Beams as Individual Configuration

In certain representative embodiments, the network may provide an (e.g., individual) configuration for any (e.g., each) LTM candidate, such as at the granularity of a cell and/or a beam. For example, a (e.g., extremely) large overhead may be incurred in terms of transmission resources and the UE maintaining individual configurations.

### LTM Candidate Cell as Individual Configuration

In certain representative embodiments, the network may provide an individual configuration for any (e.g., each) LTM candidate cell. For example, the configuration may be linked to (e.g., associated with) different beams of a candidate cell. The beams may be identified through any of a SSB index, a CSI-RS index and/or a suitable TCI state (e.g., representing QCL relation to a suitable reference signal).

### LTM Candidate Cell as Delta Configuration

In certain representative embodiments, a cell configuration for any (e.g., each) LTM candidate cell may be provided as a delta configuration with respect to a suitable reference configuration. For example, the cell configuration may be applied for configured beams and/or TCI states of the candidate cell.

For example, a suitable reference configuration against which a delta configuration is provided can be a primary serving cell. For example, using dual connectivity, the reference configuration may be the primary serving cell of a corresponding cell group.

For example, a reference configuration may be explicitly provided to the UE. The network may choose (e.g., indicate) a suitable configuration which may best minimize the delta configurations' size and the overhead (e.g., in view of a serving DU and/or neighboring DUs).

For example, to minimize the signaling overhead, the network may choose (e.g., indicate) a suitable reference configuration as part of a LTM delta candidate configuration. As an example, the network may provide a LTM configuration for a cell C1 as a delta configuration. Within the delta configuration for C1, information (e.g., a pointer) may indicate which reference configuration is to be used as the reference configuration for the candidate C1. The network may select the reference configuration suitably, such as by providing the reference to one of the cell configurations which the UE has been provided with and/or is the cell configuration over a same DU. If the UE has not received any cell configuration on the same DU as candidate C1, the network may indicate (e.g., provide a pointer) to a cell configuration on a different DU.

For example, the network may provide one or more reference-DU-configurations associated to DUs for which the network intends to provide candidates for LTM switching. The identities of DUs may be provided in suitable format as part of these reference configurations. Any (e.g., each) delta configuration may be provided as a delta configuration on top of the reference-DU-configuration. For example, the reference-DU-configuration identity may be indicated with each candidate delta configuration.

In the examples with reference and delta configurations, a UE may perform LTM switching and may apply a complete configuration which is derived jointly from a reference configuration and a delta configuration for the LTM candidate. In cases of conflict and/or overlap, the UE may prioritize the configuration values and/or parameters, such as by using those provided as part of the delta configuration.

### LTM Configuration Activation and Updates

### Activation of LTM Configurations

In certain representative embodiments, the network may provide one or more LTM configurations to a WTRU. The WTRU may (e.g., initially) activate a subset of the LTM configurations. Depending upon application requirements, WTRU mobility levels, WTRU capabilities to support simultaneous LTM configurations, WTRU subscription level and/or other network level consideration, the network may indicate (e.g., choose) to activate only a subset of the configured LTM configurations.

For example, the network may use any of RRC signaling, MAC-CE, and/or DCI to activate an LTM configuration. For example, the network may send a MAC-CE which can activate one or more LTM configurations. Two different MAC-CEs may be used to accommodate a different number of LTM configurations which may need to be activated for an eventual LTM procedure. For example, customized MAC-CEs can be used where the identities of the LTM configurations provide an indication (e.g., pointers) to the LTM configurations configured through RRC signaling. For example, a PHY based signaling, such as DCI, may be used to activate one or more of the configured LTM configurations.

### Update for LTM Configuration(s)

In certain representative embodiments, the network may provide a (e.g., initial) configuration of suitable LTM candidate cells and/or beams, such as to a UE in RRC_Connected state. Prior to receiving an initial configuration, the UE may send initial mobility assistance information to the network. The assistance information may include radio and/or non-radio measurement quantities. The network may provide initial coverage information to the UE which is suitable according to its geographic location and/or the network deployment. The network may (e.g., also) provide the initial mobility configuration which may be associated with L1/L2 triggered mobility. For example, an initial LTM configuration may include suitable LTM configurations which may be triggered (e.g., based on L1/L2 measurements). For example, the choice of the suitable configuration candidates may be based on any of UE capability for LTM mobility (e.g., as indicated to the network), UE mobility requirements for active services and/or applications (e.g., QoS and/or QoE), UE non-radio measurements (e.g., geographic coordinates and/or orientation), and/or network dynamics (e.g., cell load, amount of active traffic with different QoS, subscription levels, differentiated services). For example, the network may provide an initial configuration of LTM candidates to a given UE based on any of the above (e.g., combinations thereof).

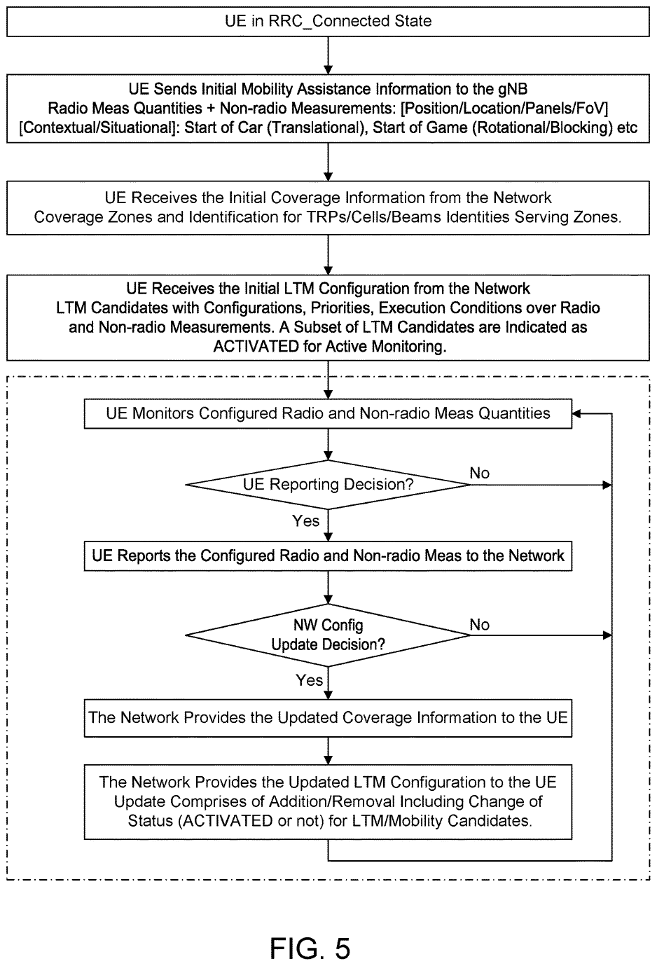

FIG. 5 is a procedural diagram of an example procedure for initial coverage and/or LTM configurations and coverage and/or LTM configuration updating. In certain representative embodiments, the procedure in FIG. 5 may be performed by a UE in RRC_Connected state (e.g., after sending a RRCResumeComplete and/or RRCSetupComplete message). The UE may send initial mobility assistance information to a base station (e.g., gNB). For example, the assistance information may include radio measurement quantities and/or non-radio measurement quantities (e.g., position, location, panels, and/or field of view). For example, the UE may send the assistance information at the start of a car (e.g., transitional) and/or a start of a game (e.g., rotational and/or blocking). The UE may receive initial coverage information from the network. For example, the initial information may include coverage zones and/or identification of TRP, cell, and/or beam identities serving zones. The UE may receive information indicating one or more initial LTM configurations from the network. For example, the LTM candidates may be associated with configurations, priorities, execution condition (e.g., using radio and/or non-radio measurements), and/or activation status. For example, a subset of LTM candidates may be indicated as ACTIVATED for active monitoring by the UE. The UE may monitor the configured radio and/or non-radio measurement quantities. The UE may determine whether a reporting decision is triggered and may proceed to report information indicating the configured radio and/or non-radio measurement quantities. The network may determine whether to provide updated information, such as updates associated with the existing LTM configurations (e.g., the initial and/or activated LTM configurations). For example, the network may send information indicating updated coverage information to the UE. For example, the network may send information indicating one or more updated LTM configurations to the UE. For example, the network may update by addition and/or removal and/or change activation status of one or more LTM configurations and/or mobility candidates.

In certain representative embodiments, the initial configurations related to coverage information and/or LTM candidates may not be suitable anymore, such as where the UE moves away from its previously reported location to a new location which may have a different set of suitable LTM candidate configurations. Thus, if the reported measurements from the UE, for radio and/or non-radio measurement quantities, change such that the previously configured LTM candidates are not suitable anymore, the network may update the configuration. The update process may an update of network coverage information and/or LTM candidate configurations as described herein. For example, an update may be the incremental addition and/or removal of previously provided configurations. For example, the network may decide to provide a new configuration.

Although not shown in the flowchart, the network can decide to update the configurations without explicit reports from the UE. One scenario can be where the network can estimate change of UE location/position through uplink signals. These uplink signals can be the UE uplink transmissions like PUSCH, PUCCH or some suitable reference signals, e.g., sounding reference signals etc.

In certain representative embodiments, the network may decide to update a LTM configurations independent of UE reported information. The update may be made without any report from the UE, and/or after UE reporting, such when indicating no change in the UE location and/or position. A network update may be triggered based on a change in network dynamics in terms of active traffic and/or active devices. This may lead to a situation where some of the previously configured LTM candidates may not have resources to support an incoming UE through the LTM procedure. The network may remove some of the previously configured LTM candidates and provide the configuration of additional LTM candidates to the UE.

### Joint Radio and Non-Radio Quantity Based LTM Measurements

In certain representative embodiments, radio measurements and/or non-radio measurements (e.g., any combinations thereof) may be used in lower layer mobility procedures. In certain representative embodiments, radio measurements and/or non-radio measurements (e.g., any combinations thereof) may be used in LTM procedures. For example, the measurement framework, configurations, quantities, and reporting mechanisms may be used to provide one or more measurement reports to the network, and the network uses these potentially combined with other network/device information to proceed with network controlled and/or network triggered mobility procedures. In these procedures, the network may send a command to a target WTRU for LTM switching to a given target cell and/or beam(s), such as where the target cell and/or beam(s) may be broadcast by the network from a same DU (e.g., intra-DU scenarios) or from a different DU (e.g., inter-DU scenarios), as compared to a current serving cell and/or beam(s). In some examples, the LTM measurement framework may enable suitable configuration of LTM measurements, triggers and execution conditions, which may be used to trigger WTRU managed LTM mobility to a target cell/beam. For example, the cells and/or beams, execution conditions, and/or measurement quantities may be pre-configured by the network.

In certain representative embodiments, LTM measurements may be (e.g., primarily) lower layer measurements where the processing, necessary filtering (e.g., when configured) and/or reporting (e.g., when configured) occur at lower layers. For example, the lower layers may refer to L1 and/or L2. For example, L3 (e.g., the RRC layer of the radio protocol stack) may provide the configurations of the lower layers (e.g., PHY layer and MAC layer), and the lower layers may make and process measurements according to the configuration received through the RRC. In certain representative embodiments, LTM procedures may include involvement from L3 as described herein.

In certain representative embodiments, one or more UEs may be equipped with interfaces from any of non-3GPP RATs, local sensors, and/or may obtain environmental information and/or quantities from certain accumulation points. Use of these quantities and their integration with the measurements over 3GPP standardized RATs may be provided in a (e.g., harmonized) framework where the UEs may use the data from one or more non-3GPP RATs alone or in combination with the data and/or measurements over one or more 3GPP RATs. For example, measurements and/or data quantities from non-3GPP RATs and/or sensors may be used for beam change and/or cell change procedures.

Although the measurement framework may be described over (e.g., using) 3GPP radio signals, non-3GPP radio signals and/or local sensors in the context of lower layer mobility, some representative embodiments may be applied to other procedures and/or scenarios (e.g., other than LTM). For example, measurements and/or events may be used to adapt certain aspects of lower layer procedures, such as channel state information feedback. For example, measurements and/or events may be employed to start monitoring certain frequencies, cells, TRPs and/or beams at the trigger of certain events. For example, measurements and/or events may be employed for higher layer procedures, such as any of legacy handover, conditional handover, and/or conditional PSCell change and/or addition procedures.

### UE Capabilities for LTM PHY Measurements

In certain representative embodiments, a UE may provide information indicating one or more capabilities of the UE to make PHY layer measurements on radio signals and/or non-radio signals and/or sources. For example, a capability may be provided (e.g., initiated) by the UE itself while attaching to the network and/or when transitioning RRC states. For example, the network may (e.g., also explicitly) request the UE capability to make PHY layer and/or LTM measurements and the UE may respond with information indicating the one or more capabilities of the UE.

For example, one or more relevant PHY layer measurements for LTM procedures are quantities computed over one or more reference signals. For example, a reference signal may refer to any of a (e.g., secondary) synchronization sequence (SS), a channel state information reference signal (CSI-RS), a positioning reference signal (PRS) and/or a sounding reference signal (SRS). For example, the resources and the reference antenna connectors may be defined similar to 3GPP 38.215, such as for any of the computation of reference signal received power (RSRP), reference signal received quality (RSRQ), signal-to-noise and interference ratio (SINR) and/or Received Signal Strength Indicator (RSSI).

Measurements on 3GPP Radio Quantities: In certain representative embodiments, a UE may be capable of measuring one or more quantities on the PHY layer and may indicate the UE capability for any of these quantities, a number of measurements on intra- and inter frequencies, and/or a number of frequencies and/or bands it can support for simultaneous measurements. In certain representative embodiments, PHY measurement quantities may be determined using (e.g., estimated over) any of SSBs, CSI-RSs, PRSs and/or SRSs.

In certain representative embodiments, a UE may perform measurements to determine radio quantities which may include any of: SS reference signal received power (SS-RSRP); CSI reference signal received power (CSI-RSRP); SS reference signal received quality (SS-RSRQ); CSI reference signal received quality (CSI-RSRQ); SS signal-to-noise and interference ratio (SS-SINR); CSI signal-to-noise and interference ratio (CSI-SINR); SRS reference signal received power (SRS-RSRP); Received Signal Strength Indicator (RSSI); DL PRS reference signal received power (DL PRS-RSRP); DL reference signal time difference (DL RSTD); UE Rx-Tx time difference; and/or SS reference signal antenna relative phase (SS-RSARP). A UE may determine other radio quantities (e.g., in addition to) the above quantities.

Measurements on Non-3GPP Radio Quantities: In certain representative embodiments, a UE may provide information indicating the UE capability to measure and report one or more non-3GPP signal quantities through other available receivers on the device (e.g., of the UE). For example, non-3GPP signal quantities may be based on any of GNSS, WLAN and/or Bluetooth relevant measurements and the like.

GNSS Code Measurements: For example, GNSS measurements may include a GNSS code phase measurement (e.g., integer and/or fractional parts) of the spreading code of a GNSS satellite signal, such as provided by configuration or having a reference power.

GNSS Carrier Phase Measurements: For example, GNSS measurements may include a number of carrier-phase cycles measurement (e.g., integer and/or fractional parts) of a GNSS satellite signal, such as provided by configuration or having a reference power.

WLAN RSSI: For example, WLAN measurements may include an IEEE 802.11 WLAN RSSI measurement.

Bluetooth Measurements: For example, Bluetooth measurements may include any of a Bluetooth signal power and/or source ID measurements.

RF Pattern Identification and Matching based Measurements: For example, other non-3GPP radio measurements may include measurements for RF pattern identification and/or matching.

Terrestrial Beacon Systems: For example, other non-3GPP radio measurements may include measurements of terrestrial beacon signals.

Non-Radio Measurements available from local sensors: In certain representative embodiments, a UE may have one or more (e.g., local) sensors which may provide (e.g., additional) non-radio measurements. Some examples are motion sensors (e.g., accelerometers, gyroscopes), environmental sensors (e.g., barometer or barometric pressure sensor), position sensors (e.g., magnetometers, orientation sensors) and/or velocity measurement sensors. For example, the sensors may provide any of the following measurements: linear acceleration and/or change of linear acceleration; velocity and/or change of velocity; orientation and/or change of orientation; angular velocity and/or change of angular velocity; atmospheric pressure and/or change of atmospheric pressure; and/or magnetic field and/or change of magnetic field.

In certain representative embodiments, a UE may obtain quantities through non-3GPP interfaces. For example, a UE capability indication may provide information associated with and/or identifying one or more sensors, one or more measurements available through the sensors, and/or an accuracy indication for those measurements.

Combinations of Radio and Non-Radio Measurements: In certain representative embodiments, one or more measurements may be defined which may be obtained by combining one or more radio measurements and/or one or more non-radio measurements. For example, a measurement may be a combination of UE orientation with respect to a reference TRP. For example, UE self-orientation may be defined in a suitable manner (e.g., the principal angle of its primary antenna (or antenna array) and can be obtained from local sensors). For example, the UE self-orientation may be known at the network or may be conveyed as part of capability exchange information. In certain representative embodiments, a UE orientation (e.g., with respect to a reference TRP) may be defined as an angle at the UE between its self-orientation and a line joining the UE to the reference TRP. This determination may then use a variety of sources and methods. For example, a UE can use GPS signals processed at UE local sensors (e.g., hardware, firmware, and/or software) combined with a TRP location provided by the network over 3GPP radio signals. For example, a UE may process TRP transmitted 3GPP radio signals and local estimates made over these signals, such as angle of arrival, to determine an angle of a reference TRP from a principal or broadside angle of its antenna array. The determination may use local sensors, such as a magnetometer and/or other orientation sensors in addition to the processing performed over the 3GPP radio signals. This information may be used at the UE along with its self-orientation information to estimate the UE orientation with respect to the reference TRP. For example, this class of measurements may be used (e.g., stored) as a sub-group of non-radio measurements.

In certain representative embodiments, a UE may be a multi-panel UE and a reference panel may be used at the UE side. For example, a reference panel may have a larger number of antenna elements, have better sensitivity, and/or be a primary antenna panel by implementation and/or better connection to UE Tx/Rx chains. For a multi-panel UE, reference panel information may be shared with the network, such as when the UE provides information about their antenna panels implementation.

In certain representative embodiments, multi-TRP transmission may occur and a reference TRP may be used, such as for orientation determination purposes. A reference TRP may be a TRP transmitting DCI for single DCI based multi-TRP transmissions. For multi-DCI based multi-TRP, a reference TRP may identified, such as the TRP having a lower CORESETPooIndex. For example, the network may indicate explicitly the reference TRP. For UE based selection, a UE may choose a TRP that it receives through its reference antenna panel in cases of multi-panel UEs. For example, a reference TRP selection may be left to the UE and the UE may provide information indicating the reference TRP to the network through suitable signaling.

For measurement configurations which are part of 3GPP positioning and location services, an RRC request to a location management function (LMF) may be used to obtain positioning service for a target UE. The UE may then be configured with suitable reference signals and methods for positioning purposes, the results of which can be used in LTM based procedures. For example, the RRC layer may be permitted to request a target UE to launch the location services with the LMF and then the LMF may provide the information related to positioning signals and procedures to the RRC layer of the UE.

### Configuration for LTM Measurements

In certain representative embodiments, LTM measurements may be defined for each cell group. For example, in cases of dual connectivity, one configuration may be provided for a master cell group (MCG) and another configuration may be provided for a secondary cell group (SCG).

LTM configuration as part of Cell Group Configuration: In certain representative embodiments, a LTM measurement configuration may be provided as part of a cell group configuration. For example, a (e.g., new) structure of “LTM_meas_config” may be defined within the “CellGroupConfig”. Providing the configuration of LTM measurements within the CG configuration may be advantageous in that the configuration does not need to be provided with each cell change.

LTM configuration as part of RRC Configuration: In certain representative embodiments, a LTM measurement configuration may be provided through RRC_Reconfiguration signaling. For example, a UE may associate one configuration to the MCG and another configuration to the SCG. The configurations may advantageously be maintained after a cell group configuration gets updated.

LTM configuration as part of Serving Cell Configuration: In certain representative embodiments, a LTM measurement configuration may be embedded inside a serving cell configuration. The serving cell configuration may provide the configuration for LTM measurements. For example, a (e.g., new) structure of “LTM_meas_config” within the “ServingCellConfig” may be provided. Each cell may be advantageously configured with relevant LTM measurements. The serving cell configuration may increase in size and serving cell updates requiring configuration updates may result in higher overhead.

In certain representative embodiments, a LTM measurement configuration may include information indicating the configuration of LTM measurement resources and/or LTM reporting configuration. For example, the configuration may include the quantity configuration. The quantity configuration may provide the lower layer filtering, processing and/or other measurement criteria applied to the LTM measurements (e.g., prior to reporting according to the reporting configuration).

In certain representative embodiments, a LTM measurement configuration may provide a plurality of (e.g., different) LTM measurement resources and/or LTM measurement reporting configurations. A high overhead may be incurred for a UE in terms of making measurements, processing, and reporting them to the network. For example, a UE may (e.g., will only) make measurements for the LTM candidates which have been indicated and/or determined to be ACTIVATED. The activation for LTM candidate configurations may be done through explicit network configuration, conditional upon radio or non-radio conditions, and/or after timer expiry.

### LTM Measurement Resources

In certain representative embodiments, a set of measurement resources may be related to radio measurement resources which are being transmitted from a 3GPP RAT (e.g., NG-RAN, EUTRAN, UTRAN, GPRS, and/or GSM). For example, sources may be configured with suitable parametrization. The sources may include any of SSBs, CSI-RSs, PRSs, SRSs and/or other reference signals, such as those designed for measurement purposes. In addition to resource identification, a suitable resource mapping in terms of time and frequency, sub-carrier spacing (SCS), power control relevant parameters, periodicities for periodic resources, cell identities associated to measurement resources, and/or QCL information for measurement resources may be provided.

For example, one or more (e.g., new and/or additional) parameters may be provided to the measurement resources which may be used in LTM procedures. For example, the parameters may include any of DU identity or a suitable DU identifier, CU identity or a suitable CU identifier, and/or TRP identity or identifier. In certain embodiments, these parameters may be provided where some aspects of LTM procedures need such information to be known at the UE, such as based upon which UE is expected to take certain actions.

### LTM Reporting Configuration

In certain representative embodiments, reporting configuration may provide the reporting attributes in terms of periodic, semi-persistent and aperiodic nature of the configured measurement reporting. For example, one or more reporting attributes may be provided in terms of periodic, semi-persistent and/or aperiodic nature of the configured measurement reporting. A reporting configuration may include the resources to be used to provide the report to the network. LTM reporting resources may include PUCCH resources, PUSCH resources, and/or a service request (SR) sent to the network when reporting conditions or trigger conditions are fulfilled. As such, the latency may be reduced as reporting can be configured to be made over PHY layer or MAC layer (in the form of a MAC CE) which can be custom designed to convey the report of the configured quantities.

For some scenarios and procedures, where latency may not be an issue or the report size can be large, reporting may be RRC (or L3) based.

Reporting configuration provides the LTM triggers and execution conditions on the measurement quantities which are associated to a given reporting configuration.

A reporting configuration may provide a sub-selection of measurement resources according to one or more criteria. For example, a reporting configuration may indicate the reporting of the N quantities which are measured to be strongest and/or largest in the configured measurement period. For example, a reporting configuration may provide the reporting of the N largest quantities, such as if they are larger than a configured threshold. The value of N may be configurable. In some cases, N may take the value of 1, 2, 3 or more. For example, where N is configured as 1, only the strongest measurement may be reported among the measurements made on configured resources.

### LTM Measurement Quantities for Reporting

In certain representative embodiments, a LTM measurement framework may provide the measurement quantities for reporting purposes. A configuration for measurement quantities may provide the additional processing and/or filtering that is to be applied to raw measurements prior to reporting. For example, the processing may include any of thresholding, quantization in particular formats, mapping to certain formats and/or bit ranges. For example, filtering coefficients may be specified to achieve a certain level of noise and/or channel variation filtering. For example, to achieve seamless mobility within shorter intervals of time, filtering may be enabled and/or disabled by configuration. For example, filtering coefficients may be set to values such that they enable raw measurement reporting.

For example, an LTM measurement configuration may include the 3GPP Based radio measurement quantities such as any of SSB-index-RSRP, SSB-index-RSRQ, SSB-index-SINR, CRI-RSRP, CRI-RSRQ, CRI-CQI, CRI-SINR, PRS and/or SRS quantities as described herein.

For example, a LTM measurement configuration may include the quantities for reporting and relevant post-processing/filtering for non-radio measurement quantities (e.g., of non-3GPP based radio signals available from local sensors and/or other interfaces).

### LTM Measurement Framework

In certain representative embodiments, LTM measurements may use an identity of a LTM reporting configuration as a LTM measurement identity. For example, a reporting configuration may include information indicating (e.g., pointers) to the LTM measurement resource configurations and LTM quantity configurations. For example, LTM measurements may be enabled, disabled, activated, deactivated or triggered by signaling, such as through DCI using the identify of a LTM reporting configuration.

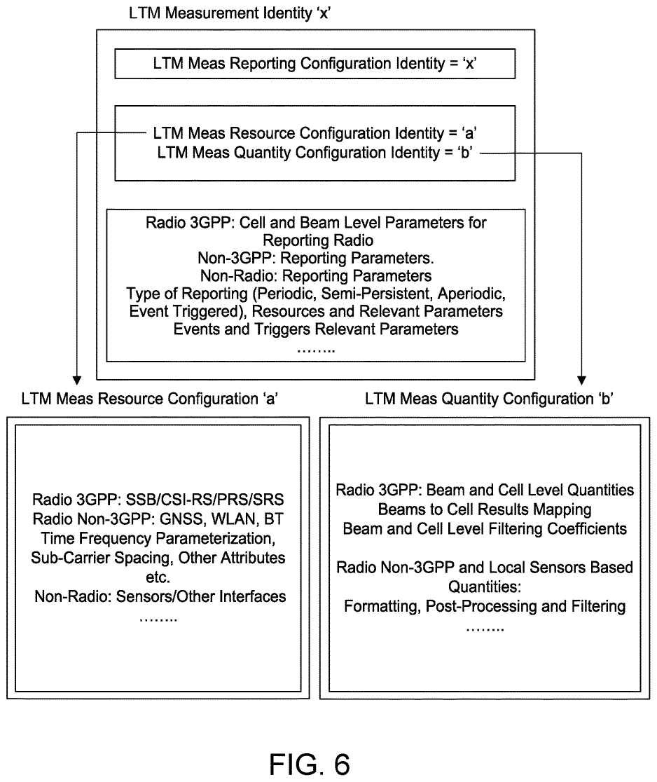

FIG. 6 is a LTM measurement framework diagram illustrating an example of associations between a LTM measurement identity and LTM measurement resource configurations. In FIG. 6, a LTM measurement reporting configuration having an identity ‘x’ may include information indicating one or more LTM measurement resource configurations having identities ‘a’ and ‘b’. As shown in FIG. 6, the LTM measurement resource configuration ‘a’ may include a first set of radio 3GPP measurement types, radio non-3GPP measurement types, and non-radio measurement types (e.g., from sensors and/or other interfaces), and the LTM measurement resource configuration ‘b’ may include a second (e.g., different) set of radio 3GPP measurement types, radio non-3GPP measurement types, and non-radio measurement types (e.g., from local sensors).

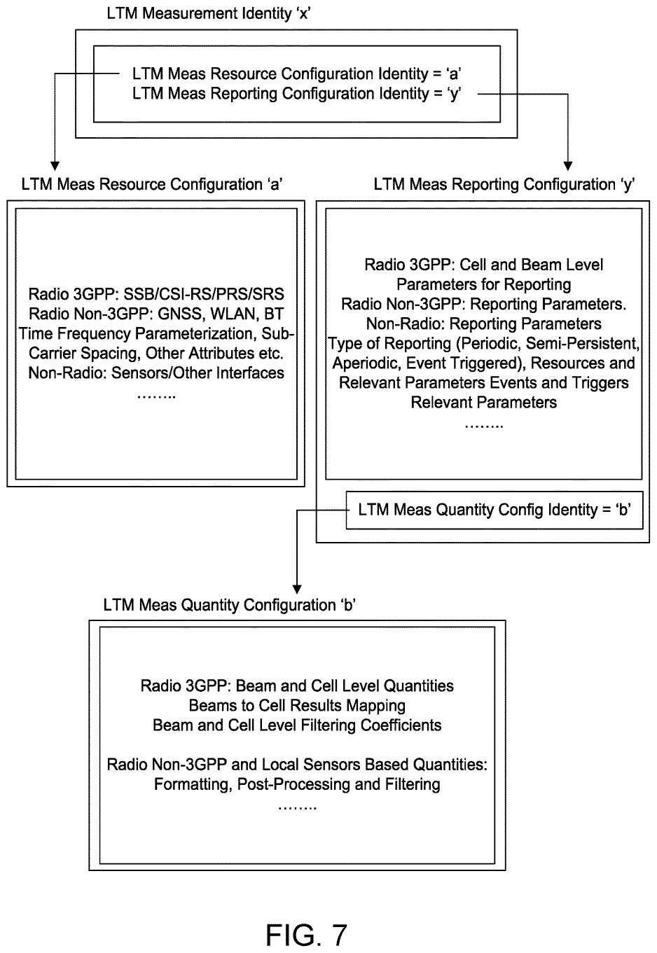

In certain representative embodiments, LTM measurements may use separate configurations for LTM measurement resources and LTM reporting. For example, a separate LTM measurement identity may include information indicating two configurations (e.g., provides two pointers). For example, one indication (e.g., pointer) is to a set(s) of LTM measurement resource identities, and another indication (e.g., pointer) is to an LTM reporting configuration. For example, a reporting configuration identity (e.g., object) may not be distinguishable (e.g., unique) using a LTM measurement identity as the LTM measurement identity may link a given reporting configuration to different sets of measurement resources to generate multiple LTM measurements. For example, a LTM measurement reporting configuration may include another indication (e.g., pointer) to a suitable LTM measurement quantity configuration. FIG. 7 is a LTM measurement framework diagram illustrating another example of associations between a LTM measurement identity and LTM measurement resource configurations. As shown in FIG. 7, a LTM measurement reporting configuration ‘y’ may include an association with a LTM measurement quantity configuration ‘b’. In another example, parameters of a quantity configuration may be directly specified within a reporting configuration.

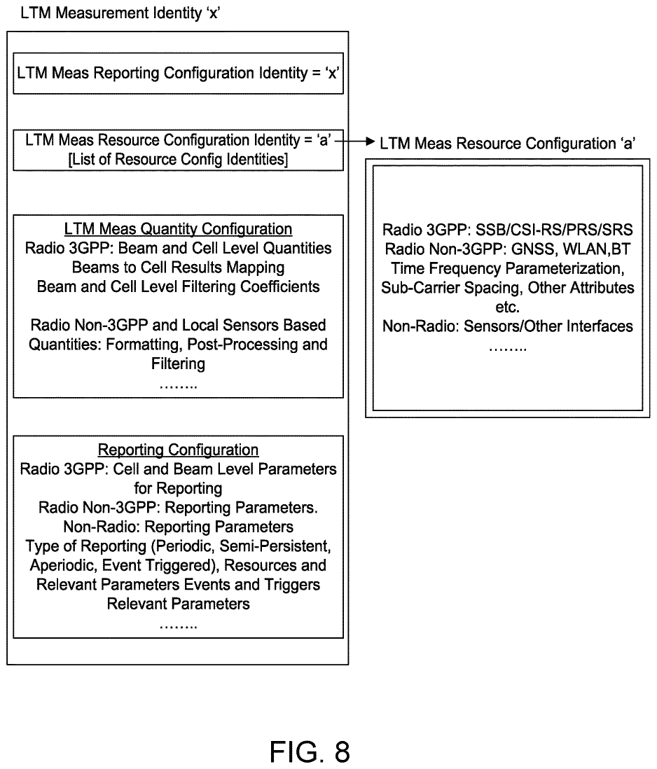

In certain representative embodiments, a reporting configuration may provide all the parameters related to reporting, quantity configuration and a list or a set of indications (e.g., pointers) to LTM measurement resource configuration identities. FIG. 8 is a LTM measurement framework diagram illustrating another example of associations between a LTM measurement identity and LTM measurement resource configurations, LTM measurement quantity configurations, and reporting configurations.

In certain representative embodiments, the frameworks shown in FIGS. 6, 7 and 8 may be modified and/or combined to provide associations between the different configurations.

### Activation and Deactivation of Measurements Associated with Non-Radio Quantities and Events

In certain representative embodiments, LTM measurements associated with LTM candidate configurations may be associated with non-radio quantities and/or events.

For example, a LTM measurement configuration may provide one or more activation conditions using one or more non-radio quantities. The non-radio quantities may be specified as conditional events with suitable definitions of thresholds and/or offsets used to determine the conditions. As an example, the activation of an LTM measurement configuration may be conditioned upon ab event when UE enters a specific zone. Various events which may be used are described herein.

For example, LTM measurement configuration activation may be based on (e.g., conditioned upon) an event when a UE device approaches (e.g., moves closer) to a network deployed transmission point (e.g., and its orientation is aligned with the transmission point). For example, the activation condition may be achieved by evaluating a set of events as described herein.

For example, one or more deactivation conditions may be specified (e.g., explicitly) as part of a LTM measurement configuration. As an example, when activation conditions are not fulfilled, a UE may (e.g., will) deactivate the corresponding measurement configuration. As an example, if the activation condition is based (e.g., conditioned) on a UE entering a specific zone, if the UE exits the activation zone, the UE may be configured to use the exit as a deactivation condition and may (e.g., will) stop making the measurements for the corresponding measurement configuration.

For example, the activation and/or deactivation conditions for LTM measurement configurations may be specified as part of a reporting configuration.

For example, the activation conditions may be specified as part of or using a measurement identity.

For example, the activation conditions may be specified as part of or using a resource identity.

### Integration of Non-3GPP and Non-Radio Measurements in LTM Measurement Reports

In certain representative embodiments, a LTM measurement framework may be enhanced to report radio measurements made over non-3GPP radio signals and/or non-radio measurement quantities.

For example, non-radio quantities may refer to the measurements available through local sensors and/or other non-radio interfaces.

For example, non-3GPP based radio measurements may refer to radio measurements which are made over (e.g., using) non-3GPP signals. Non-3GPP based radio measurements may refer to measurements defined for positioning and NTN ephemeris data. Non-3GPP based radio measurements may include the measurements from GNSS, WLAN, Bluetooth, and/or signals from other radio technologies that UE may be capable of measuring and reporting.

In certain representative embodiments, a LTM measurement framework may be enhanced with a reporting identity that may provide a reporting configuration for non-radio measurements. The reporting configuration may provide a combination of radio measurement resources (by indicating their identities) and non-radio measurement quantities through suitable parameterization. The configuration may comprise non-radio quantities (e.g., only) and the LTM report may comprise of non-radio measurements (e.g., only). For non-radio-measurements, the reporting configuration may provide the information about the quantities with the events that need to be evaluated, reported and used for decision making to perform LTM switching, or otherwise broadly used in some form of conditional evaluation which may lead to switching or reconfiguration. These measurements may also indicate the type of filtering to be applied to the non-radio-measurement quantities through suitable parameters of quantity configurations. The filtering operation may be specified using the existing filtering mechanisms and/or coefficients for radio measurements, or other (e.g., new) filtering procedures and/or coefficients may be provided which are suitable to non-radio measurements.

Measurements Available from Local Sensors: In certain representative embodiments, such as in addition to the above mentioned measurements, a UE may have local sensors which may provide additional measurements. Some examples are gyroscopes, accelerometers, barometric sensors, and/or velocity measurement sensors which may provide measurements, such as velocity, acceleration, orientation, atmospheric pressure and the like. These measurements can be further processed to compute other (e.g., more elaborate) quantities. For example, some of these quantities may in addition be obtained through non-3GPP interfaces.

### LTM Measurement Models and Processing

### Measurement Modeling

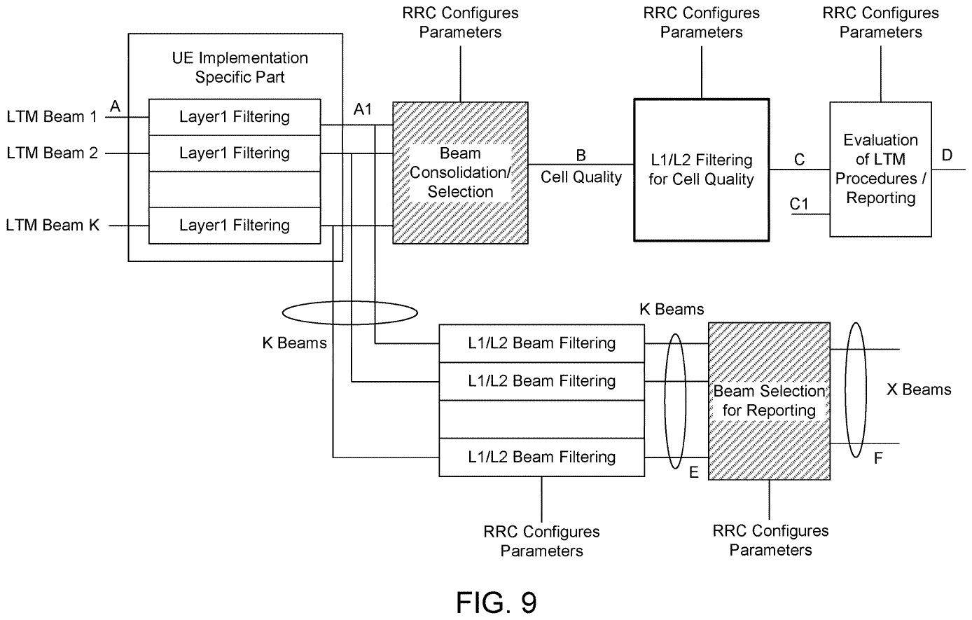

FIG. 9 is a LTM measurement diagram illustrating an example LTM measurement model with L1/L2 filtering. In certain representative embodiments, L1 filtering may be left to UE implementation, such as with specified performance requirements. For example, in FIG. 9, beam consolidation to cells and filtering procedures may be specified by the RRC layer. L1/L2 filtered values may then be used to evaluate the trigger conditions for LTM procedures and/or for reporting procedures.

In FIG. 9, the LTM measurement model includes the following features:
A: Measurements (beam specific samples) internal to the physical layer.
Layer 1 filtering: Internal layer 1 filtering of the inputs measured at point A. The exact filtering may implementation dependent. For example, how the measurements are actually executed in the physical layer by an implementation (inputs A and Layer 1 filtering) is not constrained by the standard.
A¹: Measurements (e.g., beam specific measurements) reported by L1 to L3 after L1 filtering.
Beam Consolidation/Selection: Beam specific measurements are consolidated to derive cell quality. The behaviour of the Beam consolidation/selection may be standardised, and the configuration may be provided by RRC signalling. Reporting period at B may be equal to one measurement period at point A¹.
B: Measurement (e.g., cell quality) derived from beam-specific measurements reported to L3 after beam consolidation/selection.
L1/L2 filtering for cell quality: Filtering performed on the measurements provided at point B. The behaviour of the L1/L2 filtering may be configured by the network. Filtering reporting period at point C may equal one measurement period at point B.
C: Measurement after processing in the L1/L2 filter. The reporting rate may be identical to the reporting rate at point B. This measurement may be used as input for one or more evaluation of reporting criteria.
Evaluation of reporting criteria: Checks whether actual measurement reporting is necessary at point D. The evaluation may be based on more than one flow of measurements at reference point C (e.g., to compare between different UE measurements). This is illustrated by inputs at points C and C1. The UE may evaluate the reporting criteria at least every time a new measurement result is reported at points C, C1. The reporting criteria may be standardised, and the configuration may be provided by RRC signalling.
D: Measurement report information (message) sent on the radio interface.
L1/L2 Beam filtering: Filtering performed on the measurements (e.g., beam specific measurements) provided at point A¹. The behaviour of the L1/L2 beam filters may be part of the configuration. Filtering reporting period at E may equal one measurement period at A¹.
E: Measurement (e.g., beam-specific measurement) after processing in the beam filter. The reporting rate may be identical to the reporting rate at point A¹. This measurement may be used as input for selecting the X measurements to be reported.
Beam Selection for beam reporting: Select the X measurements from the measurements provided at point E. The behaviour of the beam selection may be standardised, and the configuration of this module may be provided by RRC signalling.
F: Beam measurement information included in or with the measurement report information sent on the radio interface

In certain representative embodiments, a LTM measurement configuration may provide the framework through which the network may configure LTM measurements including radio and/or non-radio measurement quantities. The configured measurement quantities may be candidates for periodic, semi-persistent, aperiodic and/or event triggered reporting, such as may be indicated in “LTM Measurement Reporting Configuration”. For example, the events once triggered can in turn trigger the reporting of event fulfillment and execution of relevant LTM switching to a target candidate cell and/or beam. For example, any of one or more conditions, events, thresholds may be provided as part of the “LTM Measurement Reporting Configuration”.

Although the configuration to lower layers may be (e.g., primarily) managed through the RRC layer, the configured measurement quantities, radio and non-radio measurement based, may be configured with suitable conditions used to trigger certain LTM relevant events on the PHY layer. A number of example conditions and events are described herein. In the PHY based evaluation, the PHY layer itself may (e.g., will) perform the configured post-processing and filtering after making the measurements and/or getting the measurement quantities from other interfaces and local sensors.

In certain representative embodiments, condition evaluation may be performed to generate events and trigger certain procedures at the MAC layer. For example, the PHY layer may be kept simple, and the measurements may be passed on to the MAC layer at suitable intervals according to the configuration. The post-processing and filtering can be configured to be performed at the PHY layer or MAC layer or partially at both layers (e.g., L1 and L2). For example, the MAC layer may be responsible to evaluate the conditions on the processed quantities and generate suitable events. One advantage of this approach may be that by disabling the MAC processing/filtering, the latency can be similar to PHY latency.

In certain representative embodiments, the configuration may specify the filtering and post-processing to be performed with the periodicity specified and/or indicated. It may be up to UE implementation to implement the filtering and post-processing in any of its layers. For example, the processing and time availability for the final quantities used to evaluate LTM triggers may be independent as to at which layer and/or block they are implemented.

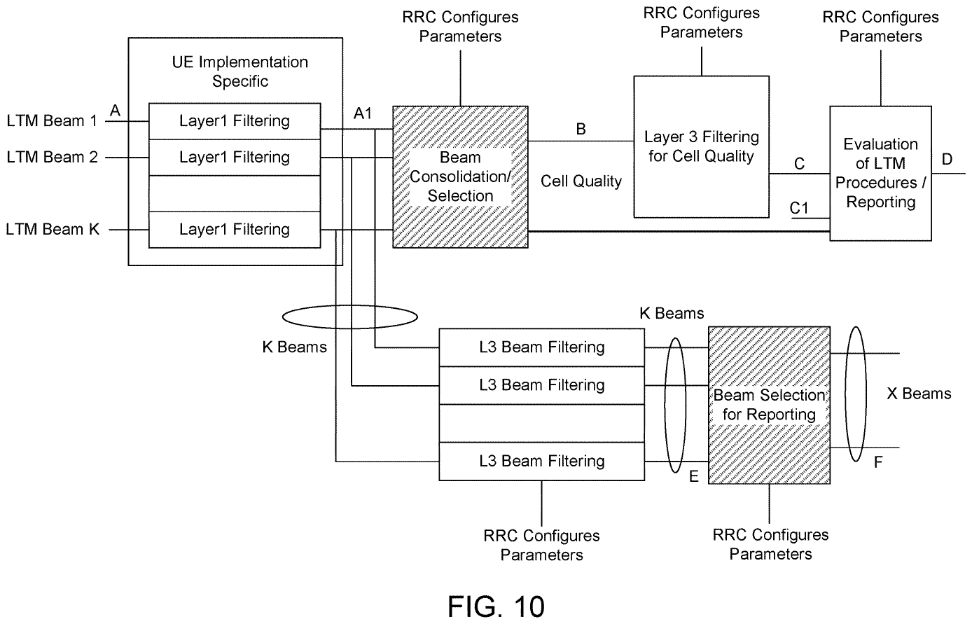

FIG. 10 is a LTM measurement diagram illustrating an example LTM measurement model with L1 and L3 based events. In FIG. 10, the LTM measurement model may include features which are generally the same as FIG. 9.

In certain representative embodiments, a LTM measurement framework may combine L1 and L3 filtered measurements and the LTM events may be set to be evaluated on the L1 measurement quantities or L3 measurement quantities or a combination of the measurement quantities (e.g., L1 and L3). For example, the combining may be specified by the network and configured by the RRC layer as shown in FIG. 10. As shown in FIG. 10, the L1 beam consolidated measurements may be provided (e.g., as indicated by the bold black line) to the evaluation block, which also receives L3 filtered quantities. For example, the event triggers and execution conditions may need to specify whether the quantities to be evaluated are L1 or L3 or both.

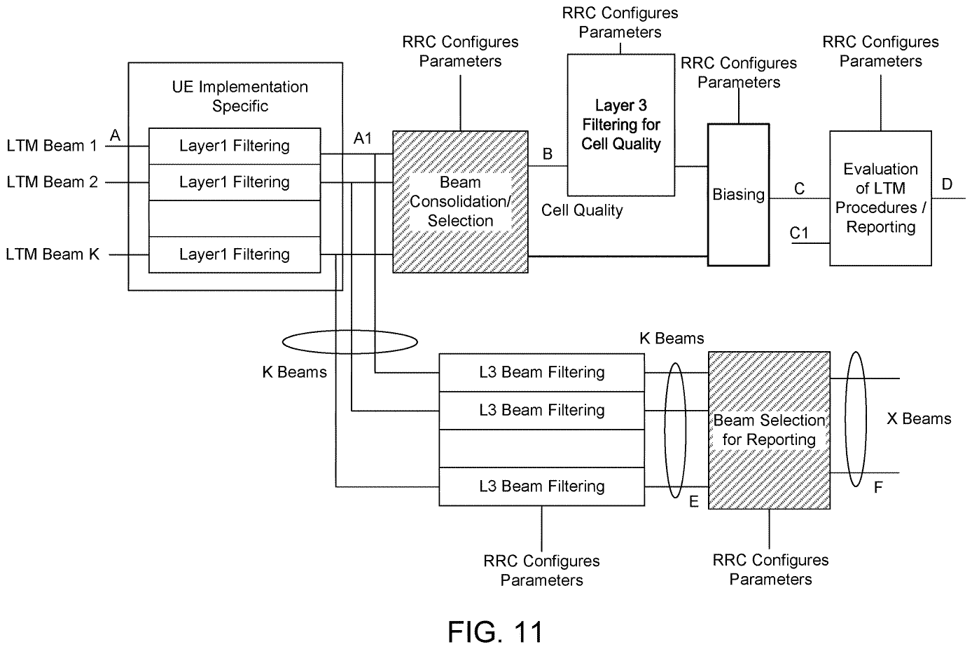

FIG. 11 is a LTM measurement diagram illustrating an example LTM measurement model with measurement biasing. In FIG. 11, the LTM measurement model may include features which are generally the same as FIGS. 9 and 10.

In certain representative embodiments, the L1 and L3 measurement quantities may be combined prior to the evaluation of events. For example, the combining may be performed at the Biasing processing block in FIG. 11. This block may be configured with appropriate configuration parameters through which lower layer measurements may be biased with L3 filtered quantities. The biasing block may be configured to apply biasing to lower layer measurements based upon L3 filtered measurements according to the configuration parameters. The biasing block may be modeled as a weighted combining of the L1 and L3 measurements. For example, the weights may be provided as part of the configuration. In another example, the biasing block may be considered as combining and filtering of input L1 and L3 quantities. The network may provide control (e.g., using RRC) configuring) over a suitable stable operating point for biased measurements which may be used to evaluate the execution conditions prior to triggering the reporting and/or the LTM cell switching procedures.

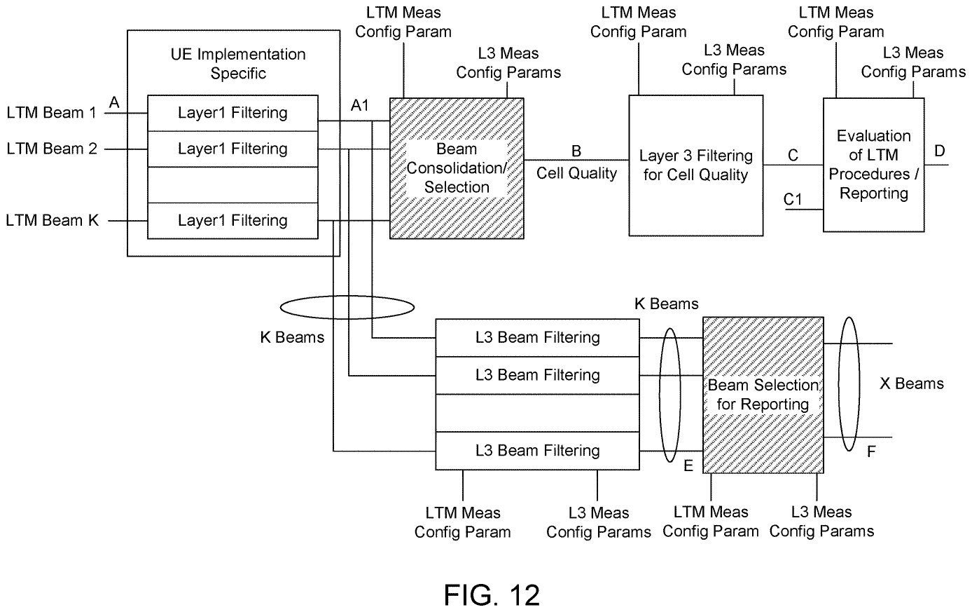

FIG. 12 is a LTM measurement diagram illustrating an example LTM measurement model unified for LTM and L3 measurements. In FIG. 12, the LTM measurement model may include features which are generally the same as FIGS. 9-11.

In certain representative embodiments, a (e.g., unified) model for L3 and LTM measurements may be used. Each of the blocks (e.g., beam consolidation, L3 filtering for cells/beams, and/or event evaluation parameters, such as offsets, hysteresis) may be provided with two sets of configuration parameters. One set may be used for L3 legacy measurements, and the second set may be used for LTM relevant measurements processing and events evaluation and/or monitoring. For example, a unified model for L3 and LTM measurements is shown in FIG. 12, where LTM measurement configuration parameters and L3 measurement configuration parameters are provided (e.g., separately). Though not shown in FIGS. 11-14, the candidate quantities may include radio and non-radio measurements as described herein.

As described herein, the network may share (e.g., a piece of) deployment and/or coverage information and one or more UEs may be configured with suitable LTM measurements comprising radio and non-radio quantities toward target cells and/or beams. A UE may monitor and evaluate the configured quantities and, upon triggering of certain events, execute a LTM switch to a target candidate cell and/or beam for which configured conditions get satisfied.

In certain representative embodiments, the reporting configurations may be expanded to include the (e.g., new) non-radio measurements based events where UEs will use the data from local sensors. These events may use the deployment attributes of cells and beams, both serving (from primary cell group or secondary cell group), neighboring cells/beams, and/or LTM configured candidate cells/beam as provided by the network configuration. That is, the events may be created based upon the non-data measurements. The events may then be combined with the radio measurements based events to validate the suitability of cells and/or beams, such as for satisfactory signal strength.

In certain representative embodiments, composite events may be used where conditions are specified for both non-radio measurement quantities (e.g., location, position, orientation) and radio measurement quantities (e.g., RSRP, RSRQ, SINR of SSBs, CSI-RSs or other reference signals) and these composite events may be triggered when the suitable conditions from both radio and non-radio measurement groups are fulfilled. The triggering of composite events may be used as a trigger to execute certain UE procedures and actions. For example, the events from LTM measurements (e.g., radio and non-radio based) may be used to trigger procedures, such as but not limited to, LTM switching to a suitable target cell and/or beam.

### Post-Processing and Filtering

In certain representative embodiments, a configuration may provide the selection of the suitable parameters related to additional post-processing and/or filtering coefficients which can be applied to one or more of the (e.g., raw) LTM measurements. For example, post-processing and/or filtering may be configured for any (e.g., all) LTM measurements. For example, post-processing and/or filtering may be fully applicable to any of 3GPP radio, non-3GPP radio, and/or non-radio measurements. Filtering and/or post-processing may be applied (e.g., as additional processing) to make the measurements quantities suitable for use in LTM procedures, such for any of intra-DU cell and/or beam switching, inter-DU cell and/or beam switching, and/or inter-CU cell and/or beam switching. Th measurement framework described herein may be used in other cell and/or beam level procedures (e.g., non-LTM procedures).

### Derivation of Cell Quantities from Beam Measurements

In certain representative embodiments, a LTM measurement framework may include the derivation of cell level quantities from beam level measurements (e.g., addition to the post-processing and/or filtering). The parameters and/or thresholds to derive the cell level quantities for reporting and/or event evaluation purposes (e.g., when configured) from beam level measured quantities may be specified as part of a “LTM Measurement Quantity configuration.” For example, a “LTM Measurement Quantity configuration” may be indicated using an association (e.g., identity) from a “LTM Measurement Reporting Configuration”. For example, a mapping (e.g., mapping rules and relevant parameters) may be provided (e.g., directly) as part of a “LTM Measurement Reporting Configuration”.

### LTM Measurement Events and Triggers for Conditional Reporting

In certain representative embodiments, a UE configured with LTM measurements may monitor and evaluate events configured over a suitable combination of radio and non-radio measurements. The measurement quantities over which the event conditions are set may follow measurement models as described herein. For example, reference measurement models may include where event conditions may be set on any of the following: L1 measurement quantities alone; L3 measurement quantities alone; Joint events on L1 and L3 measurement quantities; and/or L1 measurement quantities biased with L3 measurement quantities.

In certain representative embodiments, for non-radio measurement quantities, filtering information may be specified separately, or the non-radio measurement quantities may be configured to processed using the LTM measurement models described herein. For example, the non-radio measurements (e.g., after processing and/or filtering) are fed (e.g., input) to the event evaluation block.

Examples of procedures which use examples of these events are described herein. For example, some of the exemplary events may be based on using radio, non-radio and/or joint measurements.

As described below, a plurality of events are provided which relate to radio quantities from 3GPP and/or non-3GPP RATs and/or non-radio quantities. A plurality of joint events over these quantities are also described. For the example events, trigger conditions may use offsets and/or hysteresis values (e.g., which may not always be used) for LTM measurements. For example, trigger conditions without offset and/or hysteresis values may allow for a UE to react quickly with changing channel conditions. For example, tuning parameters, offsets and/or hysteresis values may be removed altogether from the condition definitions, and/or they can be assigned zero or suitable values to achieve a desired latency.

### LTM Events Using 3GPP Radio Signal Measurements

In certain representative embodiments, a set of events may be referred to using the prefix, LTM-Ax. The nomenclature for these events may resemble the events defined in TS 38.331. For example, the set of events may be performed over measurements which are LTM measurements (e.g., which may be lower layer measurements with or without filtering as indicated in “LTM Measurement Configuration”). For example, the set of events may be evaluated at lower layers (e.g., L1, L2) and/or may trigger LTM measurement reporting or suitable LTM cell switching procedures.

### LTM Event LTM-A1 (serving Becomes Better Than Threshold)

In certain representative embodiments, an event LTM-A1 may be used to slow down LTM based measurements monitoring and reporting. For example, a UE may (e.g., shall):
consider the entering condition for this event to be satisfied when condition A1-1, as specified below, is fulfilled; and/or
consider the leaving condition for this event to be satisfied when condition A1-2, as specified below, is fulfilled;
for this measurement, consider the NR serving cell corresponding to the associated measObjectNR associated with this event.

For example, an inequality A1-1 (e.g., an entering condition) may be defined as Ms>Thresh.

For example, an inequality A1-2 (e.g., a leaving condition) may be defined as Ms<Thresh.

For example, the above conditions may be defined with some hysteresis values (e.g., which can be provided as part of the measurement configuration).

For example, the inequality A1-1 (e.g., an entering condition) may be defined as Ms Hys>Thresh.

For example, the inequality A1-2 (e.g., a leaving condition) may be defined as Ms+Hys<Thresh.

For example, any of the foregoing variables may be defined as follows:
Ms may be the measurement result of the serving cell, not taking into account any offsets;
Hys may be the hysteresis parameter for this event (e.g., hysteresis as defined within reportConfigNR for this event);
Thresh may be the threshold parameter for this event (e.g., a1-Threshold as defined within reportConfigNR for this event);
Ms may be expressed in dBm in case of RSRP, or in dB in case of RSRQ and RS-SINR;
Hys may be expressed in dB; and/or
Thresh may be expressed in the same units as Ms.

### LTM Event LTM-A2 (Serving Becomes Worse Than Threshold)

In certain representative embodiments, an event LTM-A2 may be used to trigger fast reporting and/or a change of LTM measurement periodicity. For example, a UE may (e.g., shall):
consider the entering condition for this event to be satisfied when condition A2-1, as specified below, is fulfilled; and/or
consider the leaving condition for this event to be satisfied when condition A2-2, as specified below, is fulfilled;
for this measurement, consider the serving cell indicated by the measObjectNR associated to this event.

For example, an inequality A2-1 (e.g., an entering condition) may be defined as Ms+Hys<Thresh.

For example, an inequality A2-2 (e.g., a leaving condition) may be defined as Ms−Hys>Thresh.

For example, any of the foregoing variables may be defined as follows:
Ms may be the measurement result of the serving cell (e.g., not taking into account any offsets);
Hys may be the hysteresis parameter for this event (e.g., hysteresis as defined within reportConfigNR for this event);
Thresh may be the threshold parameter for this event (e.g., a2-Threshold as defined within reportConfigNR for this event);
Ms may be expressed in dBm in case of RSRP, or in dB in case of RSRQ and RS-SINR;
Hys may be expressed in dB; and/or
Thresh may be expressed in the same units as Ms.

### LTM Event LTM-A3 (Neighbor Becomes Offset Better Than SpCell)

In certain representative embodiments, an event LTM-A3 may be used to conditionally trigger UE reporting and/or leading to LTM switching. The event may be used to increase the measurement and/or reporting periodicity for a target neighbor candidate. For example, a UE may (e.g., shall):
consider the entering condition for this event to be satisfied when condition A3-1, as specified below, is fulfilled; and/or
consider the leaving condition for this event to be satisfied when condition A3-2, as specified below, is fulfilled;
use the SpCell for Mp, Ofp and Ocp.

For example, any cell(s) that triggers the event may have reference signals indicated in the measObjectNR associated to this event which may be different from the NR SpCell measObjectNR.

For example, an inequality A3-1 (e.g., an entering condition) may be defined as Mn+Ofn+Ocn−Hys>Mp+Ofp+Ocp+Off.

For example, an inequality A3-2 (e.g., a leaving condition) may be defined as Mn+Ofn+Ocn+Hys<Mp+Ofp+Ocp+Off.

For example, any of the foregoing variables may be defined as follows:
Mn may be the measurement result of the neighbouring cell (e.g., not taking into account any offsets);
Ofn may be the measurement object specific offset of the reference signal of the neighbour cell (e.g., offsetMO as defined within measObjectNR corresponding to the neighbour cell);
Ocn may be the cell specific offset of the neighbour cell (e.g., cellIndividualOffset as defined within measObjectNR corresponding to the frequency of the neighbour cell), and set to zero if not configured for the neighbour cell;
Mp may be the measurement result of the SpCell (e.g., not taking into account any offsets);
Ofp may be the measurement object specific offset of the SpCell (e.g., offsetMO as defined within measObjectNR corresponding to the SpCell);
Ocp may be the cell specific offset of the SpCell (e.g., cellIndividualOffset as defined within measObjectNR corresponding to the SpCell), and is set to zero if not configured for the SpCell;
Hys may be the hysteresis parameter for this event (e.g., hysteresis as defined within reportConfigNR for this event);
Off may be the offset parameter for this event (e.g., a3-Offset as defined within reportConfigNR for this event);
Mn, Mp may be expressed in dBm in case of RSRP, or in dB in case of RSRQ and RS-SINR; and/or
Ofn, Ocn, Ofp, Ocp, Hys, Off may be expressed in dB.

### LTM Event LTM-A4 (Neighbor Becomes Better Than Threshold)

In certain representative embodiments, an event LTM-A4 may be used to conditionally trigger UE reporting and/or leading to LTM switching. The event may also be used to increase the measurement and/or reporting periodicity for a target neighbor candidate. For example, a UE may (e.g., shall):
consider the entering condition for this event to be satisfied when condition A4-1, as specified below, is fulfilled; and/or
consider the leaving condition for this event to be satisfied when condition A4-2, as specified below, is fulfilled.

For example, an inequality A4-1 (e.g., an entering condition) may be defined as Mn+Ofn+Ocn−Hys>Thresh.

For example, an inequality A4-2 (e.g., a leaving condition) may be defined as Mn+Ofn+Ocn+Hys<Thresh.

For example, any of the foregoing variables may be defined as follows:
Mn may be the measurement result of the neighbouring cell (e.g., not taking into account any offsets);
Ofn may be the measurement object specific offset of the neighbour cell (e.g., offsetMO as defined within measObjectNR corresponding to the neighbour cell);
Ocn may be the measurement object specific offset of the neighbour cell (e.g., cellIndividualOffset as defined within measObjectNR corresponding to the neighbour cell), and may be set to zero if not configured for the neighbour cell;
Hys may be the hysteresis parameter for this event (e.g., hysteresis as defined within reportConfigNR for this event);
Thresh may be the threshold parameter for this event (e.g., a4-Threshold as defined within reportConfigNR for this event);
Mn may be expressed in dBm in case of RSRP, or in dB in case of RSRQ and RS-SINR;
Ofn, Ocn, Hys are expressed in dB; and/or
Thresh may be expressed in the same units as Mn.

### LTM Event LTM-A5 (SpCell Becomes Worse Than Threshold1 and Neighbour Becomes Better Than Threshold2)

In certain representative embodiments, an event LTM-A5 may be used to conditionally trigger UE reporting and/or leading to LTM switching. The event may also be used to increase the measurement and/or reporting periodicity for a target neighbor candidate. For example, a UE may (e.g., shall):
consider the entering condition for this event to be satisfied when both condition A5-1 and condition A5-2, as specified below, are fulfilled; and/or
consider the leaving condition for this event to be satisfied when condition A5-3 or condition A5-4, (e.g., at least one of the two, as specified below) is fulfilled;
use the SpCell for Mp.

For example, the parameters of the reference signal(s) of the cell(s) that triggers the event may be indicated in the measObjectNR associated to the event which may be different from the measObjectNR of the NR SpCell.

For example, an inequality A5-1 (e.g., an entering condition 1) may be defined as Mp+Hys<Thresh1.

For example, an inequality A5-2 (e.g., an entering condition 2) may be defined as Mn+Ofn+Ocn−Hys>Thresh2.

For example, the inequality A5-3 (e.g., a leaving condition 1) may be defined as Mp−Hys>Thresh1.

For example, the inequality A5-4 (e.g., a leaving condition 2) may be defined as Mn+Ofn+Ocn+Hys<Thresh2.

For example, any of the foregoing variables may be defined as follows:
Mp may be the measurement result of the NR SpCell (e.g., not taking into account any offsets);
Mn may be the measurement result of the neighbouring cell (e.g., not taking into account any offsets);
Ofn may be the measurement object specific offset of the neighbour cell (e.g., offsetMO as defined within measObjectNR corresponding to the neighbour cell);
Ocn may be the cell specific offset of the neighbour cell (e.g., cellIndividualOffset as defined within measObjectNR corresponding to the neighbour cell), and set to zero if not configured for the neighbour cell;
Hys may be the hysteresis parameter for this event (e.g., hysteresis as defined within reportConfigNR for this event);
Thresh1 may be the threshold parameter for this event (e.g., a5-Threshold1 as defined within reportConfigNR for this event);
Thresh2 may be the threshold parameter for this event (e.g., a5-Threshold2 as defined within reportConfigNR for this event);
Mn, Mp may be expressed in dBm in case of RSRP, or in dB in case of RSRQ and RS-SINR;
Ofn, Ocn, Hys may be expressed in dB;
Thresh1 may be expressed in the same units as Mp; and/or
Thresh2 may be expressed in the same units as Mn.

### LTM Event LTM-A6 (Neighbour Becomes Offset Better Than SCell)

In certain representative embodiments, an event LTM-A6 may be used to conditionally trigger UE reporting and/or leading to LTM switching for SCell replacement. The event may also be used to increase the measurement and/or reporting periodicity for the target neighbor candidate. For example, a UE may (e.g., shall):
consider the entering condition for this event to be satisfied when condition A6-1, as specified below, is fulfilled; and/or
consider the leaving condition for this event to be satisfied when condition A6-2, as specified below, is fulfilled;
for this measurement, consider the (secondary) cell corresponding to the measObjectNR associated to this event to be the serving cell.

For example, the reference signal(s) of the neighbour(s) and the reference signal(s) of the SCell are both indicated in the associated measObjectNR.

For example, an inequality A6-1 (e.g., an entering condition) may be defined as Mn+Ocn−Hys>Ms+Ocs+Off.

For example, an inequality A6-2 (e.g., a leaving condition) may be defined as Mn+Ocn+Hys<Ms+Ocs+Off.

For example, any of the foregoing variables may be defined as follows:
Mn may be the measurement result of the neighbouring cell (e.g., not taking into account any offsets);
Ocn may be the cell specific offset of the neighbour cell (e.g., cellIndividualOffset as defined within the associated measObjectNR), and set to zero if not configured for the neighbour cell;
Ms may be the measurement result of the serving cell (e.g., not taking into account any offsets);
Ocs may be the cell specific offset of the serving cell (e.g., cellIndividualOffset as defined within the associated measObjectNR), and is set to zero if not configured for the serving cell;
Hys may be the hysteresis parameter for this event (e.g., hysteresis as defined within reportConfigNR for this event);
Off may be the offset parameter for this event (e.g., a6-Offset as defined within reportConfigNR for this event);
Mn, Ms may be expressed in dBm in case of RSRP, or in dB in case of RSRQ and RS-SINR; and/or
Ocn, Ocs, Hys, Off may be expressed in dB.

### LTM Events Using Non-3GPP Radio and Non-Radio Measurements

In certain representative embodiments, LTM events may use the information from local sensors and/or non-3GPP interfaces, such as non-3GPP and/or non-radio measurements. In some embodiments, 3GPP radio signals may be used to improve the quality of the measurement quantities, such as for positioning related measurements. For example, a UE may be capable of obtaining non-3GPP and/or non-radio measurements through processing without using 3GPP radio signals.

For example, minimization of mobility interruptions through lower layer cell switching where additional benefit and deterministic mobility aspects may be gained by making use of information from non-3GPP radio signals. For example, combines non-3GPP radio signals and information data from local sensors, other interfaces may achieve such effects. Any of the following events may be used in LTM procedures.

### LTM Non-Radio Event LTM-V1 (Velocity Becomes Larger Than a Threshold)

In certain representative embodiments, an event LTM-V1 may be used. For example, a UE may (e.g., shall):
consider the entering condition for this event to be satisfied when condition V1-1, as specified below, is fulfilled; and/or
consider the leaving condition for this event to be satisfied when condition V1-2 as specified below, is fulfilled.

For example, an inequality V1-1 (e.g., an entering condition) may be defined as Mv−Hys>Thresh1.

For example, an inequality V1-2 (e.g., a leaving condition) may be defined as Mv+Hys<Thresh2.

For example, any of the foregoing variables may be defined as follows:
Mv may be the UE velocity estimated by UE through its local sensors (e.g., not taking into account any offsets);
Hys may be the hysteresis parameter for this event (e.g., hysteresis as defined within configuration for this event);
Thresh1 may be the threshold for this event defined as a reference velocity within configuration for this event and used as velocity threshold to enter this event;
Thresh2 may be the threshold for this event defined as a reference velocity within configuration for this event and used as velocity threshold to exit this event;
Mv may be expressed in Km/hour;
Hys may be expressed in the same units as Mv; and/or
Thresh1 and Thresh1 may be expressed in the same units as Mv.

### LTM Non-Radio Event LTM-R1 (Device Rotation Occurring for an Amount Larger Than a Threshold)

In certain representative embodiments, an event LTM-R1 may be used. For example, a UE may (e.g., shall):
consider the entering condition for this event to be satisfied when condition R1-1, as specified below, is fulfilled; and/or
consider the leaving condition for this event to be satisfied when condition R1-2, as specified below, is fulfilled.

For example, an inequality R1-1 (e.g., an entering condition) may be defined as Mr−Hys>Thresh1.

For example, an inequality R1-2 (e.g., a leaving condition) may be defined as Mr+Hys<Thresh2.

For example, any of the foregoing variables may be defined as follows:
Mr may be the UE rotation estimated by UE through its local sensors (e.g., not taking into account any offsets), where the rotation estimation is over a duration not exceeding a duration Td configured as part of the configuration;
Hys may be the hysteresis parameter for this event (e.g., hysteresis as defined within configuration for this event);
Thresh1 may be the threshold for this event defined as an amount of reference rotation within configuration for this event and used as rotation threshold to enter this event;
Thresh2 may be the threshold for this event defined as an amount of reference rotation within configuration for this event and used as rotation threshold to exit this event;
Mr may be expressed in degrees. Mr may be expressed in radians. The unit for Mr may be configured as part of the configuration;
Hys may be expressed in the same units as Mr; and/or
Thresh1 and Thresh2 may be expressed in the same units as Mr.

### LTM Non-Radio Event LTM-O1 (Device Orientation Changing from Current Orientation Larger Than a Threshold)

In certain representative embodiments, an event LTM-O1 may be used. For example, a UE may (e.g., shall):
consider the entering condition for this event to be satisfied when condition O1-1, as specified below, is fulfilled; and/or
consider the leaving condition for this event to be satisfied when condition O1-2, as specified below, is fulfilled.

For example, an inequality O1-1 (e.g., an entering condition) may be defined as Mo−Hys>Thresh1.

For example, an inequality O1-2 (e.g., a leaving condition) may be defined as Mo+Hys<Thresh2.

For example, any of the foregoing variables may be defined as follows:
Mo may be the change in UE orientation estimated by UE through its local sensors (e.g., not taking into account any offsets), where the orientation estimation is over a duration not exceeding a duration Td configured as part of the configuration;
Hys may be the hysteresis parameter for this event (e.g., hysteresis as defined within configuration for this event);
Thresh1 may be the threshold for this event defined as an amount of reference orientation change within configuration for this event and used as threshold to enter this event;
Thresh2 may be the threshold same as Thresh1 and used as rotation threshold to exit this event;
Mo may be expressed in degrees. Mo may be expressed in radians. The units for Mo may be configured as part of the configuration;
Hys may be expressed in the same units as Mo; and/or
Thresh1 and Thresh2 may be expressed in the same units as Mo.

### LTM Non-Radio Event LTM-OT1 (Device Orientation Matching the Direction of a Given TRP/Cell within Thresholds)

In certain representative embodiments, an event LTM-OT11 may be used.

For example, the conditions for this event evaluate if the UE orientation is aligned towards a given TRP within a configured threshold. For example, the UE self-orientation may be defined in a suitable manner, such as the principal angle of its primary antenna, antenna array, and/or obtained from local sensors. For example, the UE orientation with respect to a reference TRP may be defined as the angle at the UE between its self-orientation and a line joining the UE to the reference TRP. This determination can then use a variety of sources and methods. For example, a UE may use GPS signals processed at UE local sensor (e.g., hardware, firmware, and/or software) combined with a TRP location provided by the network. In another example, a UE may process TRP transmitted 3GPP radio signals and by local estimates made over these signals, such as angle of arrival, determine the angle of the reference TRP from a principal or broadside angle of its antenna array. This information may then be used at the UE along with its self-orientation information to estimate the UE orientation with respect to the reference TRP.

In certain representative embodiments, a current event LTM-OT1 can be configured such that the network provides a reference location to be used to evaluate UE orientation alignment with respect to the reference orientation. For example, the network may ensure UE orientation alignment with respect to any reference orientation and/or direction which may have no link to any of deployment topology.

For example, a UE may (e.g., shall):
consider the entering condition for this event to be satisfied when condition OT1-1, as specified below, is fulfilled; and/or
consider the leaving condition for this event to be satisfied when condition OT1-2, as specified below, is fulfilled.

For example, an inequality OT1-1 (e.g., an entering condition), such as the device has an absolute orientation matching a target cell beam, may be defined as abs(Ou−Thresh1)<Hys1.

For example, an inequality OT1-2 (e.g., a leaving condition) may be defined as abs(Ou−Thresh1)>Hys1.

For example, any of the foregoing variables may be defined as follows:
Ou is the UE orientation estimated by UE through its local sensors (e.g., not taking into account any offsets). The reference for orientation estimation for this event may be the TRP location or a suitable RS (e.g., beam) of the target cell and/or TRP. The use of TRP location and/or a signal from the TRP as reference makes this orientation estimation alignment with respect to the given TRP. The reference TRP indication, location, and/or signal to be used as reference from a given TRP may be provided as part of the network configuration;
Hys1 may be the hysteresis parameter for orientation condition used for this event;
Thresh1 may be the threshold for this event defined as an amount of reference orientation within the configuration for this event and used as a rotation threshold to enter this event;
Ou may be expressed in degrees with respect to a configured measurement reference. Ou may be expressed in radians. The units for Ou may be configured as part of the configuration;
Hys1 may be expressed in the same units as Ou; and/or
Thresh1 may be expressed in the same units as Ou.

### LTM Non-Radio Event LTM-OD1 (Device Orientation and Distance Matching the Location of a Given TRP/Cell-Coverage within Thresholds)

In certain representative embodiments, an event LTM-OD1 may be used. For example, a UE may (e.g., shall):
consider the entering condition for this event to be satisfied when both condition OD1-1 and condition OD1-2, as specified below, are fulfilled; and/or
consider the leaving condition for this event to be satisfied when condition OD1-3 or condition OD1-4, as specified below, is fulfilled.

For example, an inequality OD1-1 (e.g., an entering condition 1), such as where the device has an absolute orientation matching a target cell beam, may be defined as abs(Ou−Thresh1)<Hys1.

For example, an inequality OD1-2 (e.g., an entering condition 2), such as where the device is within a suitable distance from a target TRP, may be defined as MI+Hys2<Thresh2.

For example, an inequality OD1-3 (e.g., a leaving condition 1) may be defined as abs(Ou−Thresh1)>Hys1.

For example, an inequality OD1-4 (e.g., a leaving condition 2) may be defined as Mi+Hys2>Thresh2.

For example, any of the foregoing variables may be defined as follows:
MI may be the UE location, represented by the distance between UE and a reference location parameter for this event (e.g., a reference location of candidate TRP for this event and/or not taking into account any offsets);
Ou may be the UE orientation estimated by UE through its local sensors (e.g., not taking into account any offsets). The reference for orientation estimation for this event can be a suitable RS (e.g., beam) of a target TRP;
Hys1 may be the hysteresis parameter for orientation condition used for this event;
Thresh1 may be the threshold for this event defined as an amount of reference orientation within the configuration for this event and used as rotation threshold to enter this event;
Thresh2 may be the threshold for this event defined as a distance from a reference location configured in configuration for this event;
Ou may be expressed in degrees with respect to a configured measurement reference. Ou may be expressed in radians. The units for Ou may be configured as part of the configuration;
Hys1 may be expressed in the same units as Ou;
Thresh1 may be expressed in the same units as Ou;
MI may be expressed in meters;
Hys2 may be expressed in the same units as MI, and/or
Thresh2 may be expressed in the same units as MI.

### LTM Non-Radio Event LTM-OD2 (Device Orientation and Distance Matching Better the Location of a Given TRP/Cell-Coverage Than the Serving TRP/Cell According to Configured Thresholds)

In certain representative embodiments, an event LTM-R1 may be used. For example, a UE may (e.g., shall):
consider the entering condition for this event to be satisfied when both condition OD2-1 and condition OD2-2, as specified below, are fulfilled; and/or
consider the leaving condition for this event to be satisfied when condition OD2-3 or condition OD2-4, as specified below, is fulfilled.

For example, an inequality OD2-1 (e.g., an entering condition 1), such as where the device has an absolute orientation aligning better with a target cell TRP than a serving cell orientation, may be defined as abs(Ou−On)−Hys1<abs(Ou−Op).

For example, an inequality OD2-1 (e.g., an entering condition 2), such as where the device is within a suitable distance from a target TRP, may be defined as Dn−Hys2<Dp.

For example, an inequality OD2-3 (e.g., a leaving condition 1) may be defined as abs(Ou−On)+Hys1>abs(Ou−Op).

For example, an inequality OD2-4 (e.g., a leaving condition 2) may be defined as Dn+Hys2>Dp.

For example, any of the foregoing variables may be defined as follows:
Ou may be the UE reference orientation in absolute units estimated by UE through its local sensors (e.g., not taking into account any offsets);
Op may be the orientation of the serving TRP in absolute units from the UE as estimated by UE using the location of the serving TRP received in the configuration;
On may be the orientation of the neighbour TRP in absolute units from the UE as estimated by UE using the location of the neighbour TRP received in configuration;
Hys1 may be the hysteresis parameter for orientation condition used for this event;
Dp may be the distance between UE location and the location of the serving TRP where the location of the serving TRP is part of the configuration;
Dn may be the distance between UE location and the location of the neighbour TRP where the location of the neighbour TRP is part of the configuration;
Hys2 may be the hysteresis parameter for distance condition used for this event;
Ou may be expressed in degrees with respect to a configured measurement reference. Ou may be expressed in radians. The units for Ou may be configured as part of the configuration;
Op, On and Hys1 may be expressed in the same units as Ou;
Dn may be expressed in meters; and/or
Dp and Hys2 may be expressed in the same units as Dn.

### LTM Non-Radio Event LTM-CM1 (Device Crossing Out the Boundary of a Specific Zone in the Coverage Topology)

In certain representative embodiments, an event LTM-CM1 may be used. For example, a UE may (e.g., shall):
consider the entering condition for this event to be satisfied when condition CM1-1, as specified below, is fulfilled; and/or
consider the leaving condition for this event to be satisfied when condition CM1-2, as specified below, is fulfilled.

For example, an inequality CM1-1 (e.g., an entering condition), such as where the device crosses a boundary in the coverage topology, may be defined as MI1−Hys>Thresh1.

For example, an inequality CM1-2 (e.g., a leaving condition) may be defined as MI1+Hys<Thresh1.

For example, any of the foregoing variables may be defined as follows:
MI1 may be the UE location, represented by the distance between UE and a reference location parameter for this event (e.g., not taking into account any offsets);
Hys may be the hysteresis parameter for this event (e.g., hysteresis as defined within reportConfigNR for this event);
Thresh1 may be the threshold for this event defined as a distance from a reference location (e.g., serving TRP) to a boundary of the coverage topology. UE may (e.g., will) derive Thresh1 from the coverage topology using the information of its current location, the serving TRP location, and/or the boundary definition according to the configuration. A boundary definition may correspond to the coverage of a RNA, TA, PLMN, and/or TRP coverage. The configuration may provide the information whether Thresh1 is LOS distance (in that case, Thresh1 is the distance of the coverage boundary on the line joining the serving TRP and UE) or a different calculation is to be used;
MI1 may be expressed in meters;
Hys may be expressed in the same units as MI1; and/or
Thresh1 may be expressed in the same units as MI1.

### LTM Non-Radio Event LTM-CM2 [Device Entering a Specific Zone)

In certain representative embodiments, an event LTM-CM2 may be used.

In certain representative embodiments, this event may evaluate the UE entering a specific zone. A zone identification may be provided to the UE through configuration. For example, the network may provide the coordinates for the zone center, its shape, and/or the lengths delimiting the zone. For example, a zone may be in the form of hexagon, square, or a rectangle. The network may provide the center coordinates, 1 length parameter for square zones, 2 length parameters for rectangular zones, or more parameters for other refined shaped zones. For example, a zone may represent sidelink style zones which are obtained through a configured processing over the GPS coordinates. The network may provide the UE the configuration to compute the zones. The UE may obtain its location and/or position estimate through local sensors. The UE location information may be aided by using radio and/or non-radio signals. The computed location may allow the UE to calculate its distance from the center of the zone. Knowing the zone boundary, the UE may determine whether it has entered into a zone or not.

In certain representative embodiments, the zones may be associated to the network deployment and/or coverage. For example, the network may specify the zone center as a deployed TRP. The zone boundaries may be provided through suitable choice of parameters which could be delimited in the square, rectangular or hexagon shapes by specifying associated parameters as described herein.

In certain representative embodiments, the network may associate the configured zones to the effective coverage information of its cells, beams, and/or TRPs, such as through acquisition of past measurements reports from UEs, drive tests and the like.

For example, a UE may (e.g., shall):
consider the entering condition for this event to be satisfied when condition CM2-1, as specified below, is fulfilled; and/or
consider the leaving condition for this event to be satisfied when condition CM2-2, as specified below, is fulfilled.

For example, an inequality CM2-1 (e.g., an entering condition), such as where the device crosses into a specific zone in the coverage topology, may be defined as MI1−Hys <Thresh1.

For example, an inequality CM1-2 (e.g., a leaving condition) may be defined as MI1+Hys>Thresh1.

For example, any of the foregoing variables may be defined as follows:
MI1 may be the UE location, represented by the distance between UE and a reference location parameter for this event (e.g., not taking into account any offsets). The reference location is attributed to the specific zone to which this event is associated;
Hys may be the hysteresis parameter for this event (e.g., hysteresis as defined within reportConfigNR for this event);
Thresh1 may be the threshold for this event defined as a distance from a reference location (e.g., reference gNB/TRP location of the reference zone) to a boundary of the coverage topology. The UE may (e.g., will) derive Thresh1 from the coverage topology using the information of its current location, the reference gNB/TRP location, and/or the boundary definition according to the configuration. A boundary definition may correspond to the coverage of a RNA, TA, PLMN and/or gNB/TRP coverage. The configuration may provide the information whether Thresh1 is LOS distance (in that case, Thresh1 is the distance of the coverage boundary on the line joining the reference TRP and UE) or a different calculation is to be used. The network may provide the value for Thresh1 matching the zone configuration. If zone configuration suffices, the network may expect the UE to derive the values for this threshold;
MI1 may be expressed in meters;
Hys may be expressed in the same units as MI1; and/or
Thresh1 may be expressed in the same units as MI1.

### LTM Non-Radio Event LTM-CM2V1 [LTM-CM2 && LTM-V1] (Device Entering a Specific Zone in the Coverage Topology and Velocity Becoming Larger Than a Configured Threshold)

In certain representative embodiments, an event LTM-CM2V1 may be used.

The LTM-CM2V1 event may be used to conditionally trigger UE reporting for LTM switching based upon non-radio measurements, such as location coordinates and/or velocity estimation. The event may also be used to increase the measurement and/or reporting periodicity for a target neighbor candidate.

For example, this joint event is set on location estimation (e.g., which may be obtained through non-radio measurements) and velocity estimation (e.g., non-radio measurements). For example, this event may be specified solely over non-radio measurement quantities. In other examples, configurations may be provided where the location estimates are obtained (e.g., solely) over radio measurements, measurements over 3GPP radio signals, or a combination of any or more the former sets.

For example, a UE may (e.g., shall):
consider the entering condition for this event to be satisfied when condition CM2V1-1 and condition CM2V1-2, as specified below, are fulfilled; and/or
consider the leaving condition for this event to be satisfied when condition CM2V1-3 or CM2V1-4, as specified below, is fulfilled.

For example, an inequality CM2V1-1 (e.g., an entering condition 1), such as where the device crosses into a specific zone in the coverage topology, may be defined as MI−Hys1<Thresh1.

For example, an inequality CM2V1-1 (e.g., an entering condition 2) may be defined as Mv−Hys2>Thresh2.

For example, an inequality CM2V1-3 (e.g., a leaving condition) may be defined as MI+Hys1>Thresh1.

For example, an inequality CM2V1-4 (e.g., a leaving condition) may be defined as Mv+Hys2<Thresh2.

For example, any of the foregoing variables may be defined as follows:
MI may be the UE location, represented by the distance between UE and a reference location parameter for this event (e.g., not taking into account any offsets). The reference location is attributed to the specific zone to which this event is associated;
Hys1 may be the hysteresis parameter for this event (e.g., hysteresis as defined within reportConfigNR for this event) to be used in location conditions;
Thresh1 may be the threshold for this event defined as a distance from a reference location (e.g., reference gNB/TRP location of the reference zone) to a boundary of the coverage topology. A UE may (e.g., will) derive Thresh1 from the coverage topology using the information of its current location, the reference gNB/TRP location, and/or the boundary definition according to the configuration. A boundary definition may correspond to the coverage of a RNA, TA, PLMN and/or gNB/TRP coverage. The configuration may provide the information whether Thresh1 is LOS distance (in that case, Thresh1 is the distance of the coverage boundary on the line joining the reference TRP and UE) or a different calculation is to be used;
Mv may be the UE velocity estimated by UE through its local sensors (e.g., not taking into account any offsets);
Hys2 may be the hysteresis parameter for this event (e.g., hysteresis as defined within the configuration for this event) to be used for velocity condition evaluation;
Thresh2 may be the threshold for this event defined as a reference velocity within the configuration for this event and used as velocity threshold to enter/exit this event. For example, two separate thresholds may be configured for entry and exit conditions;
MI may be expressed in meters;
Hys1 may be expressed in the same units as MI1 (or MI);
Thresh1 may be expressed in the same units as MI1 (or MI);
Mv may be expressed in Km/hour or mph;
Hys2 may be expressed in the same units as Mv, and/or
Thresh2 may be expressed in the same units as Mv.

### LTM Non-Radio Event LTM-CM2O1 [LTM-CM2 && LTM-OT1] (Device Entering a Specific Zone in the Coverage Topology and Orientation Matching a Configured Orientation within a Threshold)

In certain representative embodiments, an event LTM-CM2O1 may be used.

In certain representative embodiments, the event LTM-CM2O1 may be used to trigger UE reporting based upon non-radio measurements, such as location coordinates providing zone entry information and/or orientation to a given TRP for a candidate configuration. The event may also be used to increase the measurement and/or reporting periodicity for a target neighbor candidate.

For example, this joint event is set on location estimation (e.g., which may be obtained through non-radio measurements) and orientation estimation (e.g., non-radio measurements). For example, this event may be specified solely over non-radio measurement quantities. In other examples, configurations may be provided where the location and/or orientation estimates are obtained (e.g., solely) over radio measurements, measurements over 3GPP radio signals, or a combination of any or more the former sets.

For example, a UE may (e.g., shall):
consider the entering condition for this event to be satisfied when condition CM2O1-1 and condition CM2O1-2, as specified below, are fulfilled; and/or
consider the leaving condition for this event to be satisfied when condition CM2O1-3 or CM2O1-4, as specified below, is fulfilled.

For example, an inequality CM2O1-1 (e.g., an entering condition 1), such as where the device crosses into a specific zone in the coverage topology, may be defined as MI−Hys1<Thresh1.

For example, an inequality CM2O1-2 (e.g., an entering condition 2) may be defined as abs(Mo−Hys2)<Thresh2.

For example, an inequality CM2O1-3 (e.g., a leaving condition) may be defined as MI+Hys1>Thresh1.

For example, an inequality CM2O1-4 (e.g., a leaving condition) may be defined as abs(Mo+Hys2)>Thresh2.

For example, any of the foregoing variables may be defined as follows:
MI may be the UE location, represented by the distance between UE and a reference location parameter for this event (e.g., not taking into account any offsets). The reference location is attributed to the specific zone to which this event is associated;
Hys1 may be the hysteresis parameter for this event (e.g., hysteresis as defined within reportConfigNR for this event) to be used in location conditions;
Thresh1 may be the threshold for this event defined as a distance from a reference location (e.g., reference gNB/TRP location of the reference zone) to a boundary of the coverage topology. A UE may (e.g., will) derive Thresh1 from the coverage topology using the information of its current location, the reference gNB/TRP location, and/or the boundary definition according to the configuration. A boundary definition may correspond to the coverage of a RNA, TA, PLMN and/or gNB/TRP coverage. The configuration may provide the information whether Thresh1 is LOS distance (in that case, Thresh1 is the distance of the coverage boundary on the line joining the reference TRP and UE) or a different calculation is to be used;
Mo may be the UE orientation estimated by UE through its local sensors (e.g., not taking into account any offsets), where the orientation estimation is over a duration not exceeding a duration Td configured as part of the configuration. The reference for orientation estimation for this event can be one of the cardinal directions, a suitable location (e.g., GPS coordinates), from UE antenna (e.g., a TRP location), and/or a suitable RS (e.g., beam) of the target TRP. An orientation estimation may (e.g., will) provide a measure how closely UE is aligned to a reference location and/or direction with respect to a reference UE antenna or antenna panel. The reference location and/or direction and the reference UE antenna for orientation estimation may all be provided as parts of the configuration;
Hys2 may be the hysteresis parameter for this event (e.g., hysteresis as defined within configuration for this event);
Thresh2 may be the threshold for this event defined as an amount of reference orientation change within the configuration for this event and used as threshold to enter this event;
MI may be expressed in meters;
Hys1 may be expressed in the same units as MI;
Thresh1 may be expressed in the same units as MI;
Mo may be expressed in degrees. Mo may be expressed in radians. The units for Mo may be configured as part of the configuration;
Hys2 may be expressed in the same units as Mo; and/or
Thresh2 may be expressed in the same units as Mo.

### LTM Joint Events Using Conditions over Radio and Non-Radio Measurements

In certain representative embodiments, LTM events may use trigger conditions which are set over (e.g., evaluated using) radio and non-radio measurement quantities. For example, the non-radio quantities use the information from local sensors and/or non-3GPP interfaces. For example, 3GPP radio signals may be used to improve (e.g., modify) the quality of the non-radio measurement quantities. For example, the LTM events may radio and non-radio quantities to aid finding an accurate time, location, and/or zone for when the reporting should be made for (e.g., to aid) LTM procedures. For example, combinations of radio and non-radio quantities with known deployment, coverage, and/or environmental condition information and/or measurements of statistical radio quantities may be beneficial in the avoidance of mobility interruptions.

### Joint Event LTM-J1 [LTM-CM2 && LTM-A4] (Device Entering a Specific Zone in the Coverage Topology and the Reference Cell in this Zone Becomes Better Than a Threshold)

In certain representative embodiments, a joint event LTM-J1 may be used.

In certain representative embodiments, the joint event LTM-J1 may be used to trigger WTRU initiated reporting for LTM switching based upon radio measurements and location coordinates. The event may also be used to increase the measurement and/or reporting periodicity for a target neighbor candidate.

For example, the joint event LTM-J1 may be used (e.g., set on) location estimation (e.g., which may be obtained through non-radio measurements) and reference cell quality (e.g., radio measurements).

For example, a WTRU may (e.g., shall):
consider the entering condition for this event to be satisfied when condition J1-1 and condition J1-2, as specified below, are fulfilled; and/or
consider the leaving condition for this event to be satisfied when condition J1-3 or J1-4, as specified below, is fulfilled.

For example, an inequality J1-1 (e.g., an entering condition), such as where the device crosses into a specific zone in a coverage topology, may be defined as MI−Hys1<Thresh1.

For example, an inequality J1-2 (e.g., an entering condition) may be defined as Mn+Ofn+Ocn−Hys2>Thresh2.

For example, an inequality J1-3 (e.g., a leaving condition) may be defined as MI+Hys1>Thresh1.

For example, an inequality J1-4 (e.g., a leaving condition) may be defined as Mn+Ofn +Ocn+Hys2<Thresh2.

For example, any of the foregoing variables may be defined as follows:
MI may be the UE location, represented by the distance between UE and a reference location parameter for this event (e.g., not taking into account any offsets). The reference location is attributed to the specific zone to which this event is associated;
Hys1 may be the hysteresis parameter for this event (e.g., hysteresis as defined within reportConfigNR for this event) to be used in location conditions;
Thresh1 may be the threshold for this event defined as a distance from a reference location (e.g., reference gNB/TRP location of the reference zone) to a boundary of the coverage topology. A UE may derive Thresh1 from the coverage topology using the information of its current location, the reference gNB/TRP location, and/or a boundary definition according to the configuration. A boundary definition may correspond to the coverage of a RNA, TA, PLMN, and/or gNB/TRP coverage. The configuration provides the information whether Thresh1 is LOS distance (in that case, Thresh1 is the distance of the coverage boundary on the line joining the reference TRP and UE) or a different calculation is to be used;
Mn may be the measurement result of the neighbouring cell (e.g., not taking into account any offsets);
Ofn may be the measurement object specific offset of the neighbour cell (e.g., offsetMO as defined within measObjectNR corresponding to the neighbour cell);
Ocn may be the measurement object specific offset of the neighbour cell (e.g., cellIndividualOffset as defined within measObjectNR corresponding to the neighbour cell), and set to zero if not configured for the neighbour cell;
Hys2 may be the hysteresis parameter for this event (e.g., hysteresis as defined within reportConfigNR for this event) to be used in cell measurement conditions;
Thresh2 may be the threshold parameter for this event (e.g., a4-Threshold as defined within reportConfigNR for this event);
MI may be expressed in meters;
Hys1 may be expressed in the same units as MI1;
Thresh1 may be expressed in the same units as MI1;
Mn may be expressed in dBm in case of RSRP, or in dB in case of RSRQ and RS-SINR;
Ofn, Ocn, Hys2 may be expressed in dB; and/or
Thresh2 may be expressed in the same units as Mn.

### Joint Event LTM-J2 [LTM-OD2 && LTM-A4] (Device Orientation and Distance Matching Better the Location of a Given TRP Than the Serving TRP According to the Configured Thresholds)

In certain representative embodiments, a joint event LTM-J2 may be used.

In certain representative embodiments, the joint event LTM-J2 may be used to trigger WTRU initiated reporting for LTM switching based upon radio measurements and local estimation of orientation and/or distance. The event may also be used to increase the measurement and/or reporting periodicity for a target neighbor candidate.

For example, the joint event LTM-J2 may be set on location plus orientation estimation (e.g., which may be obtained through radio, non-radio, or combined radio and non-radio Measurements) and reference cell quality (e.g., radio measurements). For example, the event may provide (e.g., very) refined control when a UE should be moved from one LTM cell to another cell, such as under network control or UE control itself through a prior configuration.

For example, a UE may (e.g., shall):
consider the entering condition for this event to be satisfied when conditions J2-1, J2-2 and J2-3, as specified below, are fulfilled; and/or
consider the leaving condition for this event to be satisfied when any of the conditions J2-4, or J2-5 or J2-6, as specified below, is fulfilled.

For example, an inequality J2-1 (e.g., an entering condition 1), such as where the device has an absolute orientation aligning better with a target cell TRP than a serving cell orientation, may be defined as abs(Ou−On)−Hys1<abs(Ou−Op).

For example, an inequality J2-2 (e.g., an entering condition 2), such as where the device is within a suitable distance from a target TRP, may be defined as Dn−Hys2<Dp.

For example, an inequality J2-3 (e.g., an entering condition 3) may be defined as Mn+Ofn+Ocn−Hys3>Thresh3.

For example, an inequality J2-4 (e.g., a leaving condition 1) may be defined as abs(Ou−On)+Hys1>abs(Ou−Op).

For example, an inequality J2-5 (e.g., a leaving condition 2) may be defined as Dn+Hys2>Dp.

For example, an inequality J2-6 (e.g., a leaving condition 3) may be defined as Mn+Ofn +Ocn+Hys3<Thresh3.

For example, any of the foregoing variables may be defined as follows:
Ou may be the UE reference orientation in absolute units estimated by UE through its local sensors (e.g., not taking into account any offsets);
Op may be the orientation of the serving TRP in absolute units from the UE as estimated by UE using the location of the serving TRP received in configuration;
On may be the orientation of the neighbour TRP in absolute units from the UE as estimated by UE using the location of the neighbour TRP received in configuration;
Hys1 may be the hysteresis parameter for orientation condition used for this event;
Dp may be the distance between UE location and the location of the serving TRP where the location of the serving TRP is part of the configuration;
Dn may be the distance between UE location and the location of the neighbour TRP where the location of the neighbour TRP is part of the configuration;
Hys2 may be the hysteresis parameter for distance condition used for this event;
Mn may be the measurement result of the neighbouring cell (e.g., not taking into account any offsets);
Ofn may be the measurement object specific offset of the neighbour cell (e.g., offsetMO as defined within measObjectNR corresponding to the neighbour cell);
Ocn may be the measurement object specific offset of the neighbour cell (e.g., cellIndividualOffset as defined within measObjectNR corresponding to the neighbour cell), and set to zero if not configured for the neighbour cell;
Hys3 may be the hysteresis parameter for this event (e.g., hysteresis as defined within reportConfigNR for this event) to be used in cell measurement conditions;
Thresh3 may be the threshold parameter for this event (e.g., a4-Threshold as defined within reportConfigNR for this event);
Ou may be expressed in degrees with respect to a configured measurement reference. Ou may be expressed in radians. The units for Ou may be configured as part of the configuration.
Op, On and Hys1 may be expressed in the same units as Ou;
Dn may be expressed in meters;
Dp and Hys2 may be expressed in the same units as Dn;
Mn may be expressed in dBm in case of RSRP, or in dB in case of RSRQ and RS-SINR;
Ofn, Ocn, Hys3 may be expressed in dB; and/or
Thresh3 may be expressed in the same units as Mn.

### Joint Event LTM-J3 [LTM-CM2 && LTM-A3] (Device Entering a Specific Zone in the Coverage Topology and the Reference Cell in this Zone Becomes Better than SpCell)

In certain representative embodiments, a joint event LTM-J3 may be used.

In certain representative embodiments, the joint event LTM-J3 may be used to trigger WTRU initiated reporting leading to LTM switching replacing the SpCell based upon radio measurements and/or location coordinates according to the coverage information from the network. The event may also be used to increase the measurement and/or reporting periodicity for the target neighbor candidate.

For example, the joint event LTM-J3 may be set on location estimation (e.g., which may be obtained through non-radio measurements) and a comparison of a cell quality with a SpCell quality (e.g., radio measurements).

For example, a UE may (e.g., shall):
consider the entering condition for this event to be satisfied when condition J3-1 and condition J3-2, as specified below, are fulfilled; and/or
consider the leaving condition for this event to be satisfied when condition J3-3 or J3-4, as specified below, is fulfilled.

For example, an inequality J3-1 (e.g., an entering condition), such as where the device crosses into a specific zone in a coverage topology, may be defined as MI−Hys1<Thresh1.

For example, an inequality J3-2 (e.g., an entering condition) may be defined as Mn+Ofn +Ocn−Hys2>Mp+Ofp+Ocp+Off.

For example, an inequality J3-3 (e.g., a leaving condition) may be defined as MI+Hys1>Thresh1.

For example, an inequality J3-4 (e.g., a leaving condition) may be defined as Mn+Ofn +Ocn+Hys2<Mp+Ofp+Ocp+Off.

For example, any of the foregoing variables may be defined as follows:
MI may be the UE location, represented by the distance between UE and a reference location parameter for this event (e.g., not taking into account any offsets). The reference location is attributed to the specific zone to which this event is associated;
Hys1 may be the hysteresis parameter for this event (e.g., hysteresis as defined within reportConfigNR for this event) to be used in location conditions.
Thresh1 may be the threshold for this event defined as a distance from a reference location (e.g., reference gNB/TRP location of the reference zone) to a boundary of the coverage topology. A UE may derive Thresh1 from the coverage topology using the information of its current location, the reference gNB/TRP location, and/or a boundary definition according to the configuration. A boundary definition may correspond to the coverage of a RNA, TA, PLMN, and/or gNB/TRP coverage. The configuration provides the information whether Thresh1 is LOS distance (in that case, Thresh1 is the distance of the coverage boundary on the line joining the reference TRP and UE) or a different calculation is to be used;
Mn may be the measurement result of the neighbouring cell (e.g., not taking into account any offsets);
Ofn may be the measurement object specific offset of the neighbour cell (e.g., offsetMO as defined within measObjectNR corresponding to the neighbour cell);
Ocn may be the measurement object specific offset of the neighbour cell (e.g., cellIndividualOffset as defined within measObjectNR corresponding to the neighbour cell), and set to zero if not configured for the neighbour cell;
Mp may be the measurement result of the SpCell (e.g., not taking into account any offsets);
Ofp may be the measurement object specific offset of the SpCell (e.g., offsetMO as defined within measObjectNR corresponding to the SpCell);
Ocp may be the cell specific offset of the SpCell (e.g., cellIndividualOffset as defined within measObjectNR corresponding to the SpCell), and is set to zero if not configured for the SpCell;
Off may be the offset parameter for this event (e.g., a3-Offset as defined within reportConfigNR for this event);
Hys2 may be the hysteresis parameter for this event (e.g., hysteresis as defined within reportConfigNR for this event) to be used in cell measurement conditions;
MI may be expressed in meters;
Hys1 may be expressed in the same units as MI1;
Thresh1 may be expressed in the same units as MI1;
Mn, Mp may be expressed in dBm in case of RSRP, or in dB in case of RSRQ and RS-SINR; and/or
Ofn, Ocn, Ofp, Ocp, Hys2, Off may be expressed in dB.

### Joint Event LTM-J4 [LTM-OD2 && LTM-A3] (Device Orientation and Distance Matching Better the location of a Given TRP/Cell Than the Serving TRP/Cell According to the Configured Thresholds and the Reference Cell in this Zone Becomes Better than SpCell)

In certain representative embodiments, a joint event LTM-J4 may be used.

In certain representative embodiments, the joint event LTM-J4 may be used to trigger WTRU initiated reporting leading to LTM switching based upon radio measurements, device orientation and/or location coordinates providing a distance estimate. The event may also be used to increase the measurement and/or reporting periodicity for a target neighbor candidate.

For example, the joint event LTM-J4 may be set on location and orientation estimation (e.g., which may be obtained through radio, non-radio, or combined radio and non-radio measurements) and a comparison of cell quality with a SpCell quality (e.g., radio measurements). The event may provide (e.g., very) refined control when a UE should be moved from one LTM cell to another cell, such as under network control or UE control itself through a prior configuration.

For example, a UE may (e.g., shall):
consider the entering condition for this event to be satisfied when conditions J4-1, J4-2 and J4-3, as specified below, are fulfilled; and/or
consider the leaving condition for this event to be satisfied when any of the conditions J4-4, or J4-5 or J4-6, as specified below, is fulfilled.

For example, an inequality J4-1 (e.g., an entering condition 1), such as where the device has an absolute orientation aligning better with a target cell TRP than a serving cell orientation, may be defined as abs(Ou−On)−Hys1<abs(Ou−Op).

For example, an inequality J4-2 (e.g., an entering condition 2), such as where the device is within a suitable distance from a target TRP, may be defined as Dn−Hys2<Dp.

For example, an inequality J4-3 (e.g., an entering condition) may be defined as Mn+Ofn +Ocn−Hys3>Mp+Ofp+Ocp+Off.

For example, an inequality J4-4 (e.g., a leaving condition 1) may be defined as abs((Ou −On)+Hys1>abs(Ou−Op).

For example, an inequality J4-5 (e.g., a leaving condition 2) may be defined as Dn+Hys2>Dp.

For example, an inequality J4-6 (e.g., a leaving condition 3) may be defined as Mn+Ofn +Ocn+Hys3<Mp+Ofp+Ocp+Off.

For example, any of the foregoing variables may be defined as follows:
Ou may be the UE reference orientation in absolute units estimated by UE through its local sensors (e.g., not taking into account any offsets);
Op may be the orientation of the serving TRP in absolute units from the UE as estimated by UE using the location of the serving TRP received in the configuration;
On may be the orientation of the neighbour TRP in absolute units from the UE as estimated by UE using the location of the neighbour TRP received in the configuration;
Hys1 may be the hysteresis parameter for orientation condition used for this event;
Dp may be the distance between UE location and the location of the serving TRP where the location of the serving TRP is part of the configuration;
Dn may be the distance between UE location and the location of the neighbour TRP where the location of the neighbour TRP is part of the configuration;
Hys2 may be the hysteresis parameter for distance condition used for this event;
Mn may be the measurement result of the neighbouring cell (e.g., not taking into account any offsets);
Ofn may be the measurement object specific offset of the neighbour cell (e.g., offsetMO as defined within measObjectNR corresponding to the neighbour cell);
Ocn may be the measurement object specific offset of the neighbour cell (e.g., cellIndividualOffset as defined within measObjectNR corresponding to the neighbour cell), and set to zero if not configured for the neighbour cell;
Mp may be the measurement result of the SpCell (e.g., not taking into account any offsets); Ofp may be the measurement object specific offset of the SpCell (e.g., offsetMO as defined within measObjectNR corresponding to the SpCell);
Ocp may be the cell specific offset of the SpCell (e.g., cellIndividualOffset as defined within measObjectNR corresponding to the SpCell), and is set to zero if not configured for the SpCell;
Off may be the offset parameter for this event (e.g., a3-Offset as defined within reportConfigNR for this event);
Thresh3 is the threshold parameter for this event (e.g., a4-Threshold as defined within reportConfigNR for this event);
Ou may be expressed in degrees with respect to a configured measurement reference. Ou may be expressed in radians. The units for Ou may be configured as part of the configuration;
Op, On and Hys1 may be expressed in the same units as Ou;
Dn may be expressed in meters;
Dp and Hys2 may be expressed in the same units as Dn;

Mn, Mp may be expressed in dBm in case of RSRP, or in dB in case of RSRQ and RS-SINR; and/or
Ofn, Ocn, Ofp, Ocp, Hys3, Off may be expressed in dB.

### Joint Event LTM-J5 [LTM-CM2 && LTM-V1 && LTM-A4] (Device Entering a Specific Zone in the Coverage Topology, Velocity Larger Than a Configured Threshold and the Reference Cell in this Zone Becomes Better Than a Threshold)

In certain representative embodiments, a joint event LTM-J5 may be used.

In certain representative embodiments, the joint event LTM-J5 may be used to trigger UE initiated reporting leading to LTM switching based upon radio measurements and/or location coordinates. The event may also be used to increase the measurement and/or reporting periodicity for a target neighbor candidate.

For example, the joint event LTM-J5 may be set on location estimation (e.g., which may be obtained through radio, non-radio, or combined radio and non-radio Measurements), velocity estimation (e.g., non-radio measurements), and reference cell quality (e.g., radio measurements).

For example, the event may be triggered when a UE enters a specific zone with a velocity larger than a threshold and with a cell quality of a reference cell becoming better than another threshold. For example, this event may be used over highways to determine the whereabouts of a UE, and the network may switch the cell which is deployed after the reference cell, such as due to a high velocity indication as part of the event setup.

For example, a UE may (e.g., shall):
consider the entering condition for this event to be satisfied when condition J5-1, J5-2 and condition J5-3, as specified below, are fulfilled; and/or
consider the leaving condition for this event to be satisfied when condition J5-4 or J5-5 or J5-6, as specified below, is fulfilled.

For example, an inequality J5-1 (e.g., an entering condition 1), such as where the device crosses into a specific zone in a coverage topology, may be defined as MI−Hys1<Thresh1.

For example, an inequality J5-2 (e.g., an entering condition 2) may be defined as Mn+Ofn+Ocn−Hys2>Thresh2.

For example, an inequality J5-3 (e.g., an entering condition 3) may be defined as Mv−Hys3>Thresh3.

For example, an inequality J5-4 (e.g., a leaving condition 1) may be defined as MI+Hys1>Thresh1.

For example, an inequality J5-5 (e.g., a leaving condition 2) may be defined as Mn+Ofn +Ocn+Hys2<Thresh2.

For example, an inequality J5-6 (e.g., a leaving condition 3) may be defined as Mv+Hys1<Thresh3.

For example, any of the foregoing variables may be defined as follows:
MI may be the UE location, represented by the distance between UE and a reference location parameter for this event (e.g., not taking into account any offsets). The reference location is attributed to the specific zone to which this event is associated;
Hys1 may be the hysteresis parameter for this event (e.g., hysteresis as defined within reportConfigNR for this event) to be used in location conditions;
Thresh1 may be the threshold for this event defined as a distance from a reference location (e.g., reference gNB/TRP location of the reference zone) to a boundary of the coverage topology. A UE may derive Thresh1 from a coverage topology using the information of its current location, the reference gNB/TRP location, and/or a boundary definition according to the configuration. A boundary definition may correspond to the coverage of a RNA, TA, PLMN and/or gNB/TRP coverage. The configuration provides the information whether Thresh1 is LOS distance (in that case, Thresh1 is the distance of the coverage boundary on the line joining the reference TRP and UE) or a different calculation is to be used;
Mn may be the measurement result of the neighbouring cell (e.g., not taking into account any offsets);
Ofn may be the measurement object specific offset of the neighbour cell (e.g., offsetMO as defined within measObjectNR corresponding to the neighbour cell);
Ocn may be the measurement object specific offset of the neighbour cell (e.g., cellIndividualOffset as defined within measObjectNR corresponding to the neighbour cell), and set to zero if not configured for the neighbour cell;
Hys2 may be the hysteresis parameter for this event (e.g., hysteresis as defined within reportConfigNR for this event) to be used in cell measurement conditions;
Thresh2 may be the threshold parameter for this event (e.g., a4-Threshold as defined within reportConfigNR for this event);
Mv may be the UE velocity estimated by UE through its local sensors (e.g., not taking into account any offsets);
Hys3 may be the hysteresis parameter for this event (e.g., hysteresis as defined within configuration for this event) to be used for velocity condition evaluation;
Thresh3 may be the threshold for this event defined as a reference velocity within the configuration for this event and used as velocity threshold to enter/exit this event. Two separate thresholds may be configured for entry and exit conditions;
MI may be expressed in meters;
Hys1 may be expressed in the same units as MI1;
Thresh1 may be expressed in the same units as MI1;
Mn may be expressed in dBm in case of RSRP, or in dB in case of RSRQ and RS-SINR;
Ofn, Ocn, Hys2 may be expressed in dB;
Thresh2 may be expressed in the same units as Mn;
Mv may be expressed in Km/hour;
Hys3 may be expressed in the same units as Mv; and/or
Thresh3 may be expressed in the same units as Mv.

### Additional Examples of Non-Radio Events and Joint Events

In certain representative embodiments, any of the foregoing events may be used for procedures described herein. For example, the events may combine measurement quantities obtained over radio measurements and non-radio measurements which may be used to update LTM related measurements, trigger reporting, trigger LTM switching controlled by the network, and/or trigger LTM switching locally at the UE. These examples may be used to create additional events jointly over radio measurement and non-radio measurement quantities. For example, the additional events may identify a target scenario in a very precise manner and/or allow a UE to choose the most suitable candidate in intra-DU, inter-DU, and/or inter-CU scenarios.

In certain representative embodiments, the (e.g., new or additional) events may be defined over a set of non-radio measurement quantities. For example, this may be advantageous in cases where the environment is controlled, and/or the network may have thorough knowledge of the wireless environment in terms of terrain, buildings, and/or other objects.

In the examples of joint events, the events LTM-A3 and LTM-A4 may be combined with non-radio measurement quantities (e.g., combing device orientation, distance, and/or zone identity).

In an example, the event LTM-A5 may be combined with non-radio measurement quantities.

For example, the joint events LTM-J1, LTM-J2, LTM-J3 and LTM-J4 may be further combined with a speed and/or velocity condition (e.g., as used in event LTM-V1) to segregate high speed and low speed scenarios and trigger suitable action according to a given scenario.

For devices with heavy rotational mobility, the event LTM-R1 or event LTM-O1 may be combined with radio measurement quantity events (e.g., LTM-A3, LTM-A4 and/or LTM-A5) to create rotation focused conditional LTM events which may be used to trigger suitable actions leading to reporting, reporting updates, and/or monitoring updates.

In certain representative embodiments, joint events may be used where the execution conditions are set over a combination of legacy L3 measurement quantities and the LTM measurement quantities described herein.

In certain representative embodiments, WLAN, Bluetooth, and/or other RAT based events and/or conditions may be used (e.g., added). Such events and/or conditions may be defined where the network operator may have knowledge of the (e.g., public) deployment of such access points. For example, any of WLAN, Bluetooth, and/or other RAT based measurements may be combined with other radio and non-radio quantities to derive additional (e.g., further refined) joint events to the examples described above.

### WTRU Capability for Joint Radio and Non-Radio Measurements Based LTM Mobility

In certain representative embodiments, LTM mobility configurations and subsequent monitoring may require additional tracking at the UE for the cells and/or beams which may be potential targets for LTM mobility, such as whether in the activated or deactivated states. LTM mobility features may require additional (e.g., new) UE capabilities in terms of receiving and maintaining LTM configurations, handling LTM switches to intra-DU and inter-DU candidates, and/or to monitor and report LTM measurements.

With dense deployment of network access points (e.g., TRPs) and beam based transmission, with reference to LTM features and devices changing cells and/or beams more frequently than legacy systems, the number of measurements at different cells and/or beams may increase for UEs. A UE may (e.g., need to) make measurements on serving cells, the cells configured for LTM mobility, different levels of measurements for activated LTM cells as compared to deactivated LTM cells, in addition to all the measurements required for channel state information and MIMO, and/or the higher layer measurements for legacy cell change procedures. In certain representative embodiments, LTM measurements may be intra-cell or inter-cell, such as where inter-cell measurements may be on different frequencies in a same frequency band or in different frequency bands.

With beam based transmissions, a UE may need measurement gaps, such as with inter-frequency measurements. A UE may (e.g., need to) apply suitable beamforming, that is the UE may need to receive the signals having different QCL relations, and the UE may not be capable of receiving (e.g., even) intra-frequency signals from different QCL relations at a same time. A UE may need suitable measurement gaps to apply appropriate QCL relations and make measurements. For example, measurement gaps may potentially be larger than (e.g., just) the measurement time, such as to incorporate beam switching timings.

In certain representative embodiments, intra-frequency LTM Measurements may be distributed over any of: activated cells in a L1/L2 mobility configured set; deactivated cells in a L1/L2 mobility configured set; and/or current serving cells which are L1/L2 mobility candidates for PsCell.

In certain representative embodiments, inter-frequency LTM Measurements may be distributed over any of: activated cells in a L1/L2 mobility configured set; deactivated cells in a L1/L2 mobility configured set; and/or current serving cells which are L1/L2 mobility candidates for PsCell.

In certain representative embodiments, a minimal UE capability may be defined in terms of intra-frequency and/or inter-frequency LTM measurements that UEs must support to have a LTM feature enabled and/or activated.

In certain representative embodiments, for more capable UEs, an additional capability may be defined (e.g., used) for any UEs which are capable of supporting larger numbers of intra-frequency and/or inter-frequency LTM measurements than the minimal UE capability for LTM measurements.

In certain representative embodiments, any UEs having multiple antenna panels may be able to support and measure larger numbers of intra-frequency and/or intra-frequency LTM measurements. For example, these UEs may need fewer interruptions to make LTM measurements related to intra-and/or inter-frequency LTM measurements when they are able to use their unused panels for making these measurements. For example, one capability may be defined for UEs having multiple antenna panels to specify their supported number of LTM intra-frequency measurements and/or inter-frequency measurements and/or detailed information as to which of these may (e.g., can) be measured without measurement gaps. For example, a LTM measurement capability for a multi-panel UE may increase the number of supported measurements (e.g., in direct proportion to the number of antenna panels implemented). For example, the number of supported measurements may be defined explicitly for multi panel UEs. For example, a table may specify (e.g., indicate) the number of supported intra-frequency and/or inter-frequency LTM measurements for 2 panel UEs, another table for 4 panel UEs, and/or another panel for 8 panel UEs. For example, a table may specify (e.g., indicate) the supported measurements for different numbers of panels a UE may be (e.g., potentially) equipped with.

In certain representative embodiments, the measurements over radio and non-radio quantities and joint events are discussed. In addition to the 3GPP radio signal based capabilities, a UE may (e.g., need to) inform the network about its capabilities related to non-3GPP radio signals, local sensors and/or other interfaces that can or are available to be used for joint radio and non-radio measurements based LTM procedures. A UE may provide capability information to the network and based upon this knowledge, the network may choose a suitable set of joint radio and non-radio measurement quantities as part of LTM measurements and configurations. For example, a UE may provide a source of these non-3GPP RATs, local sensors and/or other interfaces, and/or other relevant parameters, such as availability and/or accuracy levels, to help the network choose the suitable set of quantities to be used in joint radio and non-radio measurements based LTM procedures.

### Joint Radio and Non-Radio Measurements Based LTM—Execution

In certain representative embodiments, an execution phase for joint radio and non-radio measurements based LTM procedure is provided. In an example, the execution phase of the LTM procedure may include the UE monitoring and reporting based upon joint radio and non-radio measurement quantities, network decision to switch the cell and issue the cell switch command, and the UE actions to perform the cell switching.

### WTRU Monitoring, Evaluation and Reporting for Radio and Non-Radio Measurements

In certain representative embodiments, once configured, a UE may (e.g., will) start to monitor the configured measurement quantities. In some examples, there may be an activation phase either based upon timers or through explicit commands. LTM reporting configuration provides the necessary parameters to report the LTM measurements to the network. The measurement reports comprise of the radio measurement quantities and non-radio measurement quantities configured as part of LTM measurement configurations.

LTM reporting configuration can be configured such that LTM measurements are reported as part of UCI. In this design, LTM measurements are reported over PUCCH or PUSCH as specified in LTM reporting configuration with suitable parameters and periodicities.

LTM reporting configuration can be configured for some quantities such that LTM measurements may be reported as RRC messages. This design may be more suitable when latency is not an issue.

LTM reporting configuration can be provided as a hybrid reporting configuration. In a hybrid design, LTM measurements reporting may be configured partly as UCI transmitted over PUCCH/PUSCH (or used to trigger lower layer events) and partly reported over RRC messages. In one variation of hybrid design, LTM reporting is configured such that the reporting takes place over RRC when certain conditions are fulfilled. If these conditions are not fulfilled, UE starts to report LTM measurements as part of UCI (PUCCH/PUSCH). The RRC configuration and UCI (PUCCH/PUSCH) configuration to report LTM measurements are part of LTM reporting configuration. The LTM reporting configuration also provides the conditions which UE uses to select one specific reporting type and the conditions to switch to the other reporting type. These conditions can be specified in terms of when a UE is enjoying good channel conditions with its serving cell/beam. When the serving cell/beam quality is better than configured thresholds, UE may be configured to report LTM measurements over RRC. The associated latency may not be an issue as UE is under good channel conditions. When the channel conditions deteriorate, according to the conditions and thresholds provided as part of the configuration, UE will switch to more agile lower layer reporting. In lower layer reporting, the periodicities may be shorter and resource overhead may be larger but that may be justified as the UE may be in risk of link degradation and these measurements may enable fast LTM switching to suitable neighboring cells and beams.

### LTM Cell Switching Command

For the network controlled LTM procedures, the network makes the decision when a given UE will switch from a serving cell, be it a serving cell or primary cell of any of its cell groups, to an LTM target cell. The network may configure suitable measurements to aid in its decision, these measurements were discussed herein. In addition to UE measurements and feedback, the network may use other criteria and system level aspects to make the mobility decisions.

Once the network decides to move a UE from a serving cell to a target LTM cell, the network provides the cell switch indication or command to the UE. One key aspect of the LTM procedures is that the cell switching command is transmitted over lower layers (e.g., L1 or L2). The cell switch command is provided to the UE along with necessary information enabling it to switch to the target cell. The cell switch command comprises of the LTM target configuration and the beam indication. The beam indication can be provided as the SSB index, CSI-RS index or a suitable QCL identity, where this QCL is already configured by the network at the UE providing the reference signal against which this QCL is set. The beam indication can be an explicit or implicit indication. The cell switch command can also provide the indication about how to handle the data and control plane at the UE when performing the cell switch. This indication can be provided as explicit indication as if MAC/RLC entities need a reset and PDCP needs data recovery etc. In another compatible design, the network can indicate whether the cell switch is intra-DU or inter-DU, and the UE may be programmed a-priori to perform the MAC/RLC/PDCP handling as per the inter-/intra-DU indication. In one example, MAC and RLC entities may be reset and PDCP can perform data recovery whenever inter-DU indication is transmitted by the network. And in case of intra-DU, no reset or data recovery are initiated. The cell switch command can, in addition, indicate the type of signaling that the UE should use on the target cell while performing cell switching. As an example, the cell switching command can provide whether the UE should transmit RACH, or some specific PUCCH or some other signal on the target cell. These signaling mechanisms are detailed herein. In a compatible design, this information can be implicit as a function of other parameters of LTM target cell configuration. These may include if, for example, the target cell is already a serving cell or an activated cell etc. The cell switching command may also provide a timing advance in an explicit or implicit manner. As an example, if the deployment is for very small cells, the UE may need to apply no timing advance. This may be known from the configuration or indicated explicitly. In another example of no timing advance, the target cell may have the same timing as of the current serving cell, potentially within the margin of the cyclic prefix. In other cases, the network can explicitly indicate the timing advance value that the UE should apply while transmitting in the uplink direction to the target cell.

The network can transmit the cell switching command in a MAC-CE. MAC-CE based indication has the advantage that other relevant pieces of information required with cell switch command can easily be provided to the UE.

In a compatible design, the cell switch command can be provided over the PHY signaling. This can be achieved by designing a downlink control indication (DCI) with special fields suitable to carry LTM cell switch command parameters as described earlier. The PHY signaling can have lower latency and can reduce further the mobility interruptions.

In a hybrid design, the network can keep both MAC and PHY based design. Thus, a UE is configured to receive LTM cell switching command through MAC and PHY signaling. Depending upon the situation, in terms of UE application requirements, UE report of radio and non-radio measurement quantities, and the availability of transmission occasions, the network can choose MAC or PHY signaling to provide the suitable LTM cell switch command to the UE in a timely manner.

### UE Data and Control Plane Handling Upon LTM Switching

In certain representative embodiments, when a UE performs LTM switching to an LTM target candidate, the UE applies the configuration of the LTM target candidate. Two primary use cases of LTM switching are when the LTM switching is performed to a target cell and/or beam candidate which is being served by a same DU (e.g., intra-DU switching) or being served by a different DU (e.g., inter-DU switching) compared to the cell (or beam) it replaces. As a function of intra-DU or inter-DU LTM switching, a UE may need to handle the internal control and data plane entities, such as the MAC entity, RLC entity and PDCP in a different manner.

For an intra-DU LTM switch, a UE may be configured to keep the MAC, RLC and PDCP entities unchanged (e.g., no resetting).

For an inter-DU LTM switch, a UE may reset its MAC and RLC entities and create new MAC and RLC entities according to the configuration of the target LTM candidate. For the PDCP layer, the UE may need to initiate data recovery (or re-establish), such as where RLC (e.g., buffered data) gets reset.

For example, the determination of behavior to apply for MAC, RLC and PDCP layers reset (or at an LTM switching event) may be left for the UE to decide, such as a function of whether an intra-DU or inter-DU LTM switching occurred. The UE may derive the information of an LTM switch being intra-DU or inter-DU through the configuration of the serving cell and the candidate LTM configuration that is applied.

For example, each LTM configuration may provide indications whether MAC and/or RLC entities need to be reset or not, and if PDCP recovery is required.

In an example, for network controlled LTM switching, the LTM switching command can indicate the UE whether MAC and RLC entities need to be reset or not, and if PDCP recovery is required.

### UL Indication to the Network Upon LTM Switching

When a UE performs LTM switching to an LTM target candidate, the UE may (e.g., will) transmit an indication to the LTM target candidate so that both the UE and the LTM target candidate have the same knowledge as to which cell/beam UE is performing LTM switching. The selection of UL indication can be part of LTM configuration.

For network controlled LTM switching, the LTM switching command can indicate the UE which type of UL indication to transmit at LTM switching event.

The design details for uplink indications transmitted from the UE to the network upon LTM switching are described as follows.

### PRACH Transmission Based Indication

In certain representative embodiments, a UE may (e.g., will) perform a PRACH procedure to the LTM candidate cell and/or beam. A contention-free RACH configuration may be provided for LTM candidates (e.g., to speed up the RACH procedure).

In some cases, this may be helpful when there is a considerable timing advance difference and this type of signaling may let the network determine and provide the correct timing advance value to the UE for the target cell.

### RACH Preamble Based Indication

In certain representative embodiments, a UE may (e.g., will) perform the transmission of RACH preamble (e.g., only). The preamble identity and/or the resources may be assigned for the LTM candidate cell and/or beam. If the network has already provided the necessary cell configurations, and the timing advance is either zero or known to within cyclic prefix limits, the whole RACH procedure may not be necessary. For example, transmitting only the RACH preamble to the LTM target candidate may save transmission resources and speed up the reliable data communication over the selected target candidate. This latency saving may be very important for improving the latencies when cells and/or beams need to be switched in mobility procedures.

### Reference Signal Based Indication

In certain representative embodiments, a UE may be configured to transmit one or more reference signals to the LTM target candidate cell and/or beam. For example, the reference signal can be one or more sounding reference signals (SRSs). The configuration parameters for the SRS transmission including sequence, power, and/or time-frequency resources may be provided to the UE as part of the LTM configuration. For example, the source cell may have already communicated and coordinated the SRS transmission possibility and relevant parameters to the LTM target candidate which may be intra-DU or inter-DU switching. Here, the LTM target candidate may (e.g., will) recognize the transmission of the RSs (e.g., SRS) from the UE and may register that this UE has performed the LTM switch locally.

### PUCCH Based Indication

In certain representative embodiments, a UE may be configured with a PUCCH transmission to the LTM target candidate upon LTM switching to the target LTM candidate. The configuration of the PUCCH transmission (e.g., including PUCCH format assignment, sequence assignment and/or PUCCH time-frequency resources) may be specific to the target LTM candidate. Here, a configured PUCCH transmission may (e.g., will) indicate to the LTM target that the UE has performed the LTM switch.

For example, a UE may be configured to transmit a scheduling request (SR) to the LTM target candidate over the configured PUCCH resources. For example, the transmission may be restricted to short PUCCH (e.g., sequence based PUCCH format 0 transmission).

### Joint Radio and Non-Radio Measurement Quantities Based LTM Procedure

In certain representative embodiments, a UE may perform any (e.g., all) of the steps or actions below as part of a joint radio and non-radio measurement based LTM procedures. For example, the UE may be assumed to start the LTM procedure from the RRC_Connected state.

For example, the UE may send capability information associated with lower layer mobility/LTM handling and relevant assistance information. For example, the capability information may be accompanied with measurement reporting information associated with a set of radio and/or non-radio measurements. Along with LTM relevant capability information (e.g., in a suitable format), the UE may also provide mobility assistance information to the network.

For example, the UE may receive coverage and/or deployment topology information and/or the relevant configurations thereof.

For example, the UE may receive LTM configuration information which may include one or more LTM configurations, along with suitable LTM radio and/or non-radio measurement quantities, and/or one or more events for reporting purpose.

For example, the UE may perform the configured radio and/or non-radio measurements, such as location and/or orientation information.

For example, the UE may detect a change in radio and/or non-radio measurement quantities (e.g., based on the measurements thereof).

For example, the UE may determine a (e.g., current) zone in the UE is located based on the (e.g., non-radio) measurements.

For example, the UE may perform evaluation of the configured event with the conditions set over measurements of radio and non-radio quantities.

For example, the UE may perform event-based UE reporting of its zone, location/position and radio measurement quantities according to the configuration, in case of event triggering.

For example, the UE may receive the network command to perform LTM mobility switch where the network may use the UE reporting of radio and non-radio measurement quantities and other system level aspects to determine the suitable target cell/beam configuration for the UE.

For example, the UE may perform the LTM mobility switch as per the network command.

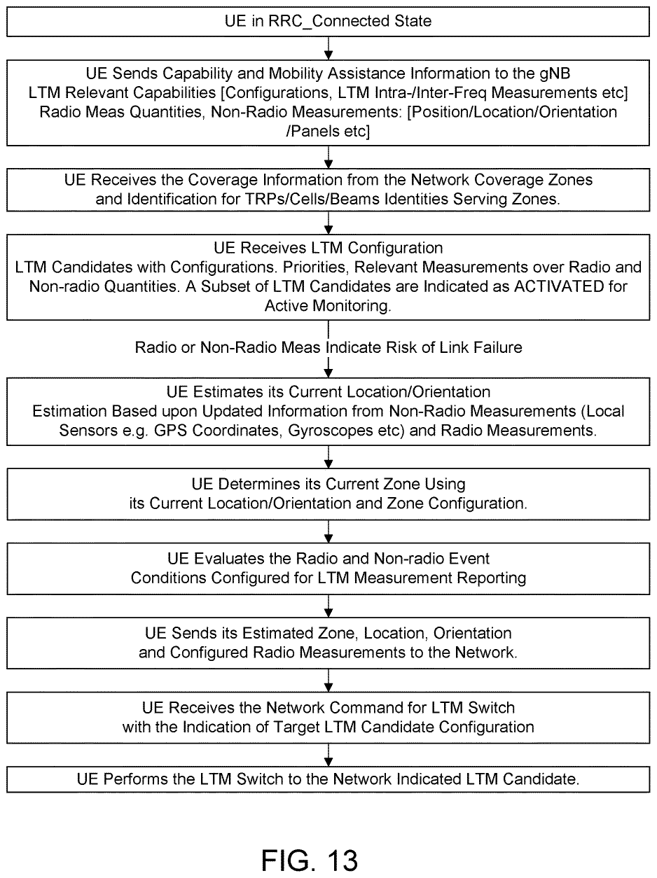

Various embodiments and examples described herein related to lower layer mobility procedure with UE aiding the mobility through the reporting of radio and non-radio measurements is shown in FIG. 13. The black font text in all the blocks represents the UE actions while the blue font text provides the UE status, or additional details and auxiliary information related to the UE action in the associated block. This procedure starts for a UE in RRC_CONNECTED state by UE providing its capability to handle different aspects of lower layer mobility procedure. This capability can be grouped in suitable formats covering different aspects of handling intra-DU, inter-DU configurations and mobility handling, maximum number of configurations a UE can be configured with, the number of intra-frequency and inter-frequency measurements a UE is capable of making etc. More details on UE capability for LTM procedure. Along with LTM relevant capability in suitable format, the UE can also provide mobility assistance information. This information can comprise of suitable measurements and the capability to perform various non-radio measurements. The set of measurements sent to the network which the network uses for preparation of suitable mobility configurations can be the lower layer measurements, legacy L3 measurements, or a combination thereof.

After receiving the capability and mobility assistance information, the network can provide the coverage information to the UE. The coverage information is a suitable snapshot of the network deployment in proximity to the UE location. The coverage information is provided to the UE with suitable granularity according to the assistance information and the QoS/QoE requirements of the services that the UE is using or intends to use. The details on the coverage information configuration, suitable granularities are provided herein.

In addition to the coverage configuration, the network provides the suitable lower layer mobility configuration to the UE. Lower layer mobility configuration, or LTM configuration, can comprise of several candidate configurations. These configurations can be provided as serving cell configuration, cell group configuration or a bigger RRC reconfiguration message. In addition, these candidate configurations may be provided as individual configurations or as delta configuration against a suitable reference configuration. The suitable reference configuration could be configured to be the configurations of the serving cell or provided as a standalone configuration. Different configuration messages and styles for LTM target configurations are proposed. A suitable subset of the LTM candidate configurations can be marked by the network in ACTIVATED or ENABLE state whereas others may be treated as DE-ACTIVATED. The UE will monitor the ACTIVATED candidates for potential LTM switching.

One of the key inventive steps in this disclosure is the network configuring the UE with suitable radio and non-radio measurement quantities and associated reporting as part of the LTM configuration step. The lower layer LTM measurements framework, suitable radio and non-radio measurement quantities, filtering, events and reporting conditions/triggers are discussed herein. After having received the suitable LTM configurations, UE will monitor the configured radio and non-radio measurement quantities in periodic, semi-persistent, aperiodic or event triggered fashion as per the received configuration.

When UE estimates degradation in the current serving link, where the degradation determination in link/beam quality is part of the configuration itself, the UE estimates it current location, position and orientation. There may be additional non-radio measurements configured either through local sensors at the UE device or information received through different interfaces. The link quality degradation detection can be configured over the beam based signals or cell based signals. The thresholds configured for the degradation determination are different from the legacy beam failure detection or radio link failure detection as the objective here is to run the procedure prior to having a beam or link failure. In a compatible design, the UE can be configured to periodically make the non-radio measurements without any explicit determination of link quality degradation.

After getting the updated estimates of its non-radio measurements in terms of location/position and orientation, the UE determines its current zone according to the network provided coverage information. The parameters and constants to derive the zone information as a function of non-radio measurements of one or more of position, location and orientation is part of coverage configuration.

After measuring the configured radio and non-radio measurement quantities, the UE will evaluate the conditions set as the measurement reporting trigger. If the conditions get fulfilled, the UE will move to the next step of reporting of the configured measurement quantities.

In this step, the UE will transmit a report of configured radio and non-radio measurements for the LTM measurement configuration for which reporting event conditions get satisfied. If the reporting conditions for event based reporting are not satisfied, the UE will not send the corresponding event based report and keep on monitoring the quantities according to the configuration periodicities. The LTM measurement reporting may be periodic based. In this case, the UE may send the measurement report according to the periodicity or the timer expiry against which measurement report should be transmitted. In a compatible design not shown in this flowchart, the reporting may be aperiodic and could have been triggered by a suitable mechanism such as RRC command or a PDCCH order by transmitting a DCI.

Once the UE has determined the reporting needs to be done, the UE will send the non-radio measurement quantities such its determined zone, position, location, orientation and other radio measurement quantities to the network as per the configured reporting configuration.

The UE reporting of the radio and non-radio measurements allows the network to select a suitable LTM candidate among the prior configured LTM candidates in the ACTIVATED or enable state. Although not shown in this flowchart, the network can update the LTM configurations with updated measurement reports received from the UE. The network can also choose not to perform the LTM switching.

If the network chooses to switch the cell for the UE through LTM procedure, the UE receives the network command to perform the LTM switch. The LTM switching command comprises of the indication of the target LTM candidate configuration. In addition to the target LTM candidate configuration, the network command of LTM switching may indicate the UE behavior for MAC/RLC reset and the type of UL indication UE will transmit subsequent to LTM switch event.

After having received the LTM candidate configuration to perform switching, the UE will perform the LTM switching to the target candidate. The switching may comprise of local handling of MAC and RLC entities at the UE. In one design, the indication to perform the reset of MAC/RLC entities can be provided to the UE explicitly as part of the LTM configuration candidates and UE performs the reset of MAC and/or RLC entities as per the configuration of selected LTM candidate. In another design, the UE can derive such information based upon whether the LTM target candidate involves intra-DU switching or inter-DU switching and by performing the pre-configured MAC/RLC reset actions for each of the intra-DU or inter-DU switching scenarios. In yet another design, MAC/RLC reset handling can be indicated as part of LTM switching command. The details on MAC/RLC reset and different intra-DU/inter-DU scenarios are provided.

The other part of the LTM switching is related to providing the network an indication of LTM switch execution by the UE. This is necessary so that both the UE and the network have the common view to communicate with each other after the LTM switching without any interruption. The UE transmits an UL indication on the network provided LTM target candidate. This UL indication, relevant sequence selection and the selection of transmission resources where this indication is transmitted is part of LTM configuration itself. In a compatible design, the UE selects the UL LTM switch indication as received in the network command to perform LTM switch. The details on UL indication subsequent to LTM switching are provided.

It would be important to highlight that the conventional radio measurements may require some significant time for the purpose of estimation, filtering, reporting which may simply be unacceptable to achieve service continuity with mobility for dense deployment of narrow beam systems. Thus, the proposed strategy of basing the lower layer mobility decisions jointly on radio and non-radio measurement quantities may provide a greater latency advantage which may simply not be achievable for procedure operating solely based upon radio measurements or non-radio measurements. The proposed procedure thus brings significant benefits in service continuity while in mobility and lower interruption times compared to legacy approaches.

### Generalized Framework and Embodiment

The current embodiment for L1/L2 triggered mobility procedure can be described based upon FIG. 13. This procedure can start for a UE in RRC connected state. The UE can provide its capability information relevant for lower layer mobility/LTM handling and additional assistance information. This step may be accompanied with the reporting of a set of radio and non-radio measurements. The capability and assistance information transfer can be triggered by UE itself, for example if its radio or non-radio measurements indicate some degradation in the coverage or the UE is running or starting to run an application requiring low mobility interruptions. In another design, the network can trigger the UE sending the capability and assistance information by sending an explicit request to the UE. The network request may be sent as an RRC message as an example. After receiving the UE capability and assistance information, the network may provide the coverage and deployment topology to the UE in suitable format. This information can be provided either as UE dedicated signaling or the system information broadcast signaling. In another design, the basic coverage information can be transmitted as system information broadcast and then refined in UE dedicated signaling. The network then provides the LTM configurations to the UE along with suitable LTM Radio and Non-Radio measurement quantities and suitable events for reporting purposes. The coverage information and the LTM configurations can be transmitted simultaneously or in any order by the network. The UE starts to measure and monitor the configured radio and non-radio measurement quantities once the configuration has been completed by the network. In some cases, there may be an additional activation step for the measurement configurations upon which the UE will start to measure and monitor the configured quantities. If the UE detects a change in its radio or non-radio measurement quantities, it may move to the next step of making fresh measurements and evaluating the reporting conditions. The UE may estimate its radio and non-radio measurement quantities which let it determine its zone from the network provided coverage topology configuration. For event based LTM measurement configurations, the UE uses the measurement quantities according to the configured or standardized measurement model where the measurement quantities may be L1, L3, a combination or biased quantities. After estimating the radio and non-radio measurement quantities, the UE will evaluate the conditions set as event trigger conditions for the measurement report. If the conditions get fulfilled resulting in triggering of the event in question, the UE will proceed to report the measurement back to the network for the report for which event gets triggered. The UE will report the radio and non-radio measurement quantities to the network which are configured as part of the measurement configuration. The report received at the UE lets the network choose the appropriate next step. The network can choose to move the UE from its current serving cell to one of the configured and activated LTM cell configurations for which it gets the visibility from the UE measurement report. If the network decides to change the UE serving cell to one of the LTM candidate cells, it sends the LTM cell switch command to the UE. Once UE receives the network command to perform LTM mobility switch where the network may use the UE reporting of radio and non-radio measurement quantities and other system level aspects to determine the suitable target cell/beam configuration for the UE, the UE will perform the mobility switch to the network commanded target cell configuration.

The LTM switching command comprises of the indication of the target LTM candidate configuration. In addition to the target LTM candidate configuration, the network command of LTM switching may indicate the UE behavior for MAC/RLC reset and the type of UL indication UE will transmit subsequent to LTM switch event.

After having received the LTM candidate configuration to perform switching, the UE will perform the LTM switching to the target candidate. The switching may comprise of local handling of MAC and RLC entities at the UE. In one design, the indication to perform the reset of MAC/RLC entities can be provided to the UE explicitly as part of the LTM configuration candidates and UE performs the reset of MAC and/or RLC entities as per the configuration of selected LTM candidate. In another design, the UE can derive such information based upon whether the LTM target candidate involves intra-DU switching or inter-DU switching and by performing the pre-configured MAC/RLC reset actions for each of the intra-DU or inter-DU switching scenarios. In yet another design, MAC/RLC reset handling can be indicated as part of LTM switching command. The details on MAC/RLC reset and different intra-DU/inter-DU scenarios are provided below.

The other part of the LTM switching is related to providing the network an indication of LTM switch execution by the UE. This is necessary so that both the UE and the network have the common view to communicate with each other after the LTM switching without any interruption. The UE transmits an UL indication on the network provided LTM target candidate. This UL indication, relevant sequence selection and the selection of transmission resources where this indication is transmitted is part of LTM configuration itself. In a compatible design, the UE selects the UL LTM switch indication as received in the network command to perform LTM switch. The details on UL indication subsequent to LTM switching are provided below.

### LTM Procedure Based Upon Joint Radio and Non-Radio Quantities (Location and Orientation) without Network Deployment Information

In this embodiment, the UE is provided the configuration of zone determination but is not provided the network deployment information. The UE makes use of non-radio quantities, notably location and orientation information, combined with 3GPP radio measurements to trigger the lower layer reporting to the network. The reporting lets the network know the suitable cell and beam for the UE for which it issues cell switch command to the UE.

UE capability transfer for lower layer mobility/LTM handling and relevant assistance information to support LTM procedure based upon radio and non-radio measurement quantities.

The UE may receive the configuration to determine zone information and the orientation specific parameters and references (e.g., reference TRP selection).

The UE may receive LTM Configurations along with suitable LTM Radio and Non-Radio measurement quantities and suitable events for reporting purpose set over a combination configured measurements. In this embodiment, the non-radio measurements and events on zone entry (LTM-CM2) and orientation matching a given TRP (LTM-OT1) are combined with radio signal measurements. The network can configure the UE with events capturing radio and non-radio measurements. The network configuration can indicate the joint events such as LTM-J1, LTM-J2, . . . LTM-J5. In an alternative design, the network can configure a set of individual events such as LTM-CM2O1 for non-radio measurements and LTM-A3/LTM-A4 for radio measurements. The configuration can indicate that triggering of these events will trigger the UE reporting.

The UE may perform configured radio and non-Radio Measurements over its location and orientation according to the configured periodicity.

The UE may detect the change in non-radio or radio measurement quantities.

The UE may determine its zone through non-radio measurements.

The UE may evaluate the configured events with the conditions set over location and orientation.

Event based UE reporting of its zone, location/position and configured radio measurement quantities according to the configuration, in case of event triggering for UE entering a specific zone and having orientation matching a given TRP according to the configuration.

The UE may receive the network command to perform LTM mobility switch where the network may use the UE reporting and other system level aspects to determine the suitable target cell/beam configuration for the UE.

The UE may perform the LTM mobility switch as per the network command.

The UE may perform the protocol stack handling as per the network indication in dynamic signaling or part of the LTM configuration.

The UE may transmit UL indication as per the network configuration/indication where the network may indicate through LTM switching command or through prior configuration to transmit an RS or PUCCH based indication.

### LTM Based Upon Radio and Non-Radio Measurements with UE Autonomous Activation of Measurement Configurations Based Upon UE Determined Zone Determination

In this embodiment, the UE is provided the configuration of zone determination but is not provided the network deployment information. The UE makes use of its location information to determine its zone according to the network configuration. As part of the LTM procedure, the network configures the UE with suitable LTM candidates. To reduce the measurements and tracking overhead associated to LTM candidate tracking/synchronization, the LTM measurements are mapped to relevant zones. These measurements thus need to be estimated and reported only upon UE determining itself in those zones. Thus, this provides a selection mechanism for UE to activate suitable set of measurement configurations. Thus, upon entering in specific locations/zones, the UE will activate the relevant measurement configurations. This activation results in UE tracking the radio and non-radio measurements quantities which are part of these active measurement configurations. These measurements can then result in UE reporting to the network according to the reporting and triggers in these measurements.

UE capability transfer for lower layer mobility/LTM handling and relevant assistance information to support LTM procedure based upon radio and non-radio measurement quantities.

UE receiving the configuration and suitable parameters to determine zone information.

UE receiving LTM Configurations for candidate cells.

UE receiving LTM relevant measurement configurations. The measurement configurations include the definitions and parameters for radio and non-radio measurement quantities which are linked to LTM candidate configurations. In addition, the measurement configuration provides the information of association to certain zones where these measurement configurations become activated and need to be estimated/monitored/tracked. The measurement can be part of measConfig in RRCreconfiguration or through a new information element especially designed for LTM procedures. The association of measurement configuration to zones may be achieved through explicitly providing a set of zone identities where this measurement configuration gets activated, or this information can be provided in a different information element.

UE performing configured Non-Radio Measurements over its location according to the configured periodicity.

UE detecting the change in non-radio or radio measurement quantities.

UE determining its zone through non-radio measurements.

Upon change of UE zone, UE activates the measurement configurations which are configured to be activated in the new zone. UE de-activates the measurement configurations which are not configured to be activated in the new zone.

UE estimating the radio and non-radio measurement quantities associated to the activated measurement configurations.

UE evaluation of the configured radio and non-radio events with the conditions set over measurements of radio and non-radio quantities.

Event based UE reporting of its zone, location/position and radio measurement quantities according to the configuration, in case of event triggering.

UE receiving the network command to perform LTM mobility switch where the network may use the UE reporting and other system level aspects to determine the suitable target cell/beam configuration for the UE.

UE performing the LTM mobility switch as per the network command.

UE performing the protocol stack handling as per the network indication in dynamic signaling or part of the LTM configuration.

UE transmitting UL indication as per the network configuration/indication where the network may indicate through LTM switching command or through prior configuration to transmit an RS or PUCCH based indication.

### LTM Based Upon Radio and Non-Radio Measurements where the Processing of Radio Measurements [e.g., Filtering Duration, Coefficients] Depends Upon Non-Radio Measurement

In this embodiment, the UE is provided the configuration of zone determination but is not provided the network deployment information. The UE makes use of its location information to determine its zone and orientation with respect to a reference TRP according to the network configuration.

In this embodiment, the UE is configured with non-radio events on UE location entering in specific zone, and/or UE distance from a reference TRP and/or UE orientation with respect to a reference TRP. If these quantities fall within a first set of configured thresholds, UE measures the radio quantities and processes with a first set of periodicity and filtering duration and coefficients etc. Similarly, a second set of radio measurements processing is used if non-radio measurements satisfy a second set of thresholds. This sub-selection can be extended to larger granularities. If non-radio quantities do not fulfill any configured set of thresholds, the UE can be configured to no make associated radio measurements. A brief sketch of this embodiment can be as in the following:
UE measures and evaluates non-radio quantities;
Non-radio measurements satisfy a first set of thresholds—UE applies a first set of parameters to measure and process radio measurement quantities;
Non-radio measurements satisfy a second set of thresholds—UE applies a second set of parameters to measure and process radio measurement quantities; and/or
Non-radio measurements don't satisfy a first or second set of thresholds—UE does not measure and track radio measurement quantities.

This embodiment shows the use of non-radio measurements to apply sub-selection on radio measurements, and to select suitable processing on the radio measurements.

### LTM Based Upon Joint Events on Radio and Non-Radio Quantities and Network Deployment Information

UE capability transfer for lower layer mobility/LTM handling and relevant assistance information to support LTM procedure based upon joint radio and non-radio measurement quantities.

UE receiving coverage and deployment topologies and the relevant configurations from the network.

UE receiving LTM Configurations along with suitable LTM Radio and Non-Radio measurement quantities and suitable Joint events for reporting purpose set over a combination of radio measurements and non-radio measurements. The network may indicate any of the proposed joint events such as LTM-J1 to LTM-J6 as part of the configuration.

UE performing configured Radio and Non-Radio Measurements.

UE detecting the change in non-radio and radio measurement quantities.

UE determining its zone through non-radio measurements.

UE evaluation of the configured joint event with the conditions set over measurements of radio and non-radio quantities.

Event based UE reporting of its zone, location/position and radio measurement quantities according to the configuration, in case of event triggering.

UE receiving the network command to perform LTM mobility switch where the network may use the UE reporting of radio and non-radio measurement quantities and other system level aspects to determine the suitable target cell/beam configuration for the UE.

UE performing the LTM mobility switch as per the network command.

UE performing the protocol stack handling as per the network indication in dynamic signaling or part of the LTM configuration.

UE transmitting UL indication as per the network configuration/indication where the network may indicate through LTM switching command or through prior configuration to transmit an RS or PUCCH based indication.

### LTM Based Upon Periodic Reporting of Radio and Non-Radio Quantities

UE capability transfer for lower layer mobility/LTM handling and relevant assistance information to support LTM procedure based upon joint radio and non-radio measurement quantities.

UE receiving coverage and deployment topologies and the relevant configurations.

UE receiving LTM Configurations along with suitable LTM Radio and Non-Radio measurement quantities and suitable periodic reporting configuration.

UE performing configured Radio and Non-Radio Measurements.

UE determining its zone through non-radio measurements.

Upon timer expiry, UE reporting non-radio measurement quantities such as its zone, location/position and radio measurement quantities according to the configuration.

Upon receiving the UE measurement report, the network compares the radio and non-radio measurement quantities with the thresholds and previous measurements.

The network can choose one of the activated suitable LTM configuration based upon UE report and other system level considerations.

UE receiving the network command to perform LTM mobility switch where the network may use the UE reporting and other system level aspects to determine the suitable target cell/beam configuration for the UE.

UE performing the LTM mobility switch as per the network command.

UE performing the protocol stack handling as per the network indication in dynamic signaling or part of the LTM configuration.

UE transmitting UL indication as per the network configuration/indication where the network may indicate through LTM switching command or through prior configuration to transmit an RS or PUCCH based indication.

### Activation of LTM Candidate Configurations Based Upon UE Reporting

The current embodiment proposes the network controlled activation and de-activation of suitable LTM candidate configurations. As part of the configuration, the network provides the coverage topology information and also the parameters relevant to derive the UE zone information. The network also provides the necessary measurements information which allows UE to derive its zone information. The zone information can be derived from location information which UE can obtain from local GNSS measurements. This can be done through the local GNSS receiver. The location information can be derived or improved for accuracy through other 3GPP based or non-3GPP based measurements. The UE has a-priori informed the network about its capabilities in making non-3GPP radio and non-radio measurements.

The network provides the UE with LTM candidate configurations. These candidate configurations comprise of the cell configuration, and the events and conditions over radio and non-radio measurements which the UE will evaluate and use to report those measurements.

The UE will closely monitor the ACTIVATED L1/L2 configurations and report to the network. Thus, activation of the suitable configurations is key to L1/L2 mobility. The network can configure the UE to periodically estimate certain radio and non-radio measurements such as its location etc. Based upon the location estimation, the UE derives its zone information as per the coverage topology configuration. The UE is configured to report the configured measurements and zone information to the network. The reporting can be configured with suitable periodicity according to the UE mobility and the QoS requirements. To reduce the reporting overhead, the UE reporting can be event based and only reported if the UE estimated zone changes from the previous zone. The UE report can be transmitted to the network as part of the UCI. A new MAC-CE can be designed to provide this information. Upon receiving the updated measurements and zone information, the network can update the ACTIVATED set of LTM configurations. The network can send an “LTM config activation” MAC-CE which can activate the suitable LTM configurations. Two different MAC-CEs can be designed to accommodate a different number of LTM configurations which may need to be activated for an eventual LTM procedure. Customized MAC-CEs can be designed for this purpose where the identities of the LTM configurations provide pointers to the LTM configurations configured through RRC signaling. One design for activation MAC-CE can be bitmap based where the network can indicate the activation status for each configured LTM configuration. For more reactive situations, a PHY based signaling such as DCI can be used to activate one of the configured LTM configurations.

Thus, this scheme has a significant advantage in terms of resource overhead and latency reduction. The UE will keep on making the configured radio and non-radio measurements only for the suitable LTM configurations corresponding to its location for the ACTIVATED configurations selected by the network. This saves the UE from making unnecessary measurements over the candidate configurations which are not suitable anymore for its updated location.

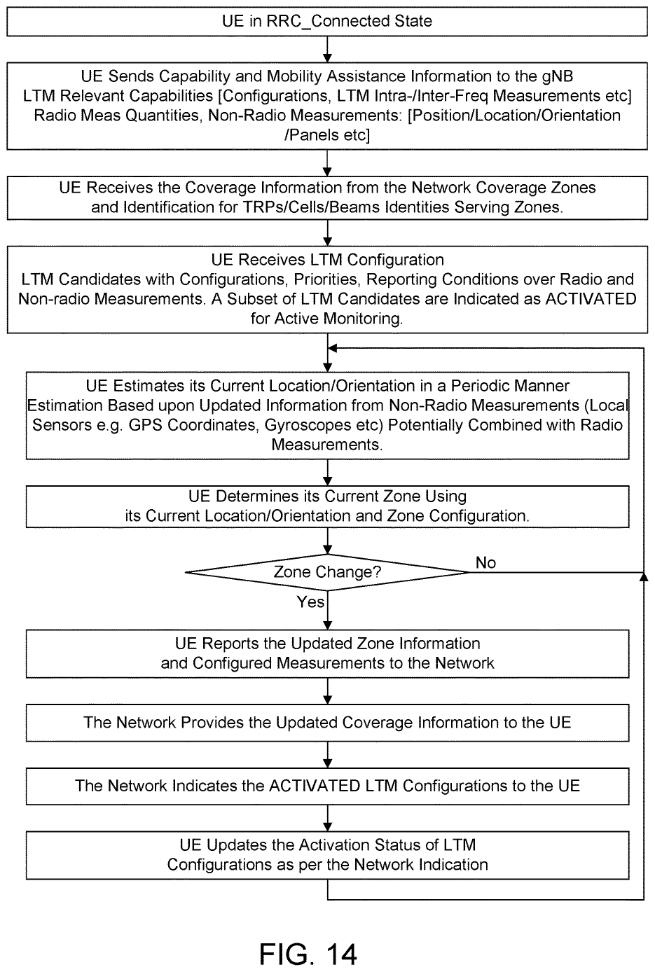

The current embodiment is shown as flowchart in FIG. 14 and it uses one or more following operations:

UE capability transfer for lower layer mobility/LTM handling and relevant assistance information to support LTM procedure based upon joint radio and non-radio measurement quantities.

UE receiving coverage and deployment topologies and the relevant configurations.

UE receiving LTM Configurations along with suitable LTM Radio and Non-Radio measurement quantities and suitable Joint events for reporting. A subset of LTM configurations can be indicated as ACTIVATED by the network as part of the configuration/initialization. UE may be configured with a set of additional periodic measurements for aiding in configuration activation/de-activation. These measurements may be a combination of radio and non-radio measurements, with particular focus on UE zone information.

UE performing configured Radio and Non-Radio Measurements associated to the ACTIVATED LTM configurations.

UE performing configured measurements for configuration activation/de-activation purpose.

UE determining its zone through non-radio measurements.

If newly determined zone is different from the previous zone, UE transmitting UL report of configured measurements and its newly estimated zone information to the network. UE receiving network update of coverage topology. UE receiving the updated list of activated and de-activated LTM configuration. The network can add or remove some of the configured LTM candidates. UE makes an update for the activation status of the configured LTM candidates, updating the status as per the network indication.

### LTM Based Upon UE Reporting Potential Target Configuration Candidate

The current embodiment proposes the network controlled LTM switching procedure where the UE performs radio and non-radio measurements and assists in the LTM switching by providing the indication of the suitable LTM target configuration to the network. The selection of the suitable LTM target configuration is performed by UE through tracking, measuring and evaluating radio and non-radio quantities as per the network configuration.

As part of the configuration for the proposed procedure, the network provides the coverage topology information and also the parameters relevant to derive the UE zone information. The network also provides the necessary measurements information which allows the UE to derive its zone information. The zone information can be derived from location information which UE can obtain from local GNSS measurements. This can be done through the local GNSS receiver. The location information can be derived or improved for accuracy through other 3GPP based or non-3GPP based measurements. The UE has a-priori informed the network about its capabilities in making non-3GPP radio and non-radio measurements.

The network configures the UE with a set of LTM candidate configurations. These candidate configurations comprise of the cell configuration. The network configuration also provides the events and conditions over radio and non-radio measurement quantities which the UE will measure and evaluate. The triggering of the configured events indicates that the LTM candidate configuration satisfies the selection criteria, thus, UE will report the indication of the LTM candidate configuration to the network for which events get triggered. The UE can be configured to provide periodic reporting to the network about the configured measurements for ACTIVATED configurations. To reduce the reporting overhead, the UE reporting can be event based and only reported if at least one of the ACTIVATED configurations meets the selection criteria. The UE report can be transmitted to the network as part of the UCI over the resource configured for UCI. This can be achieved by defining the configuration indication as part of the UCI. In a compatible design, a new MAC-CE can be designed to provide this information. Two MAC CEs can be designed. One short MAC-CE can only provide the selected configuration identity to the network for which selection events get triggered. A long MAC-CE can provide the configuration identity with other relevant measurements. Upon receiving the indication of the candidate configuration meeting the selection criteria and potentially the other radio and non-radio measurements from the UE, the network can select a suitable LTM candidate target. The network selection of the target configuration can incorporate other system level aspects like load balancing, cell capabilities and other aspects which may not be visible to the UE. The network sends the LTM switching command to the UE through other relevant switching parameters as described earlier. The UE performs LTM switching to the network issued target according to the configuration and the network switching command.

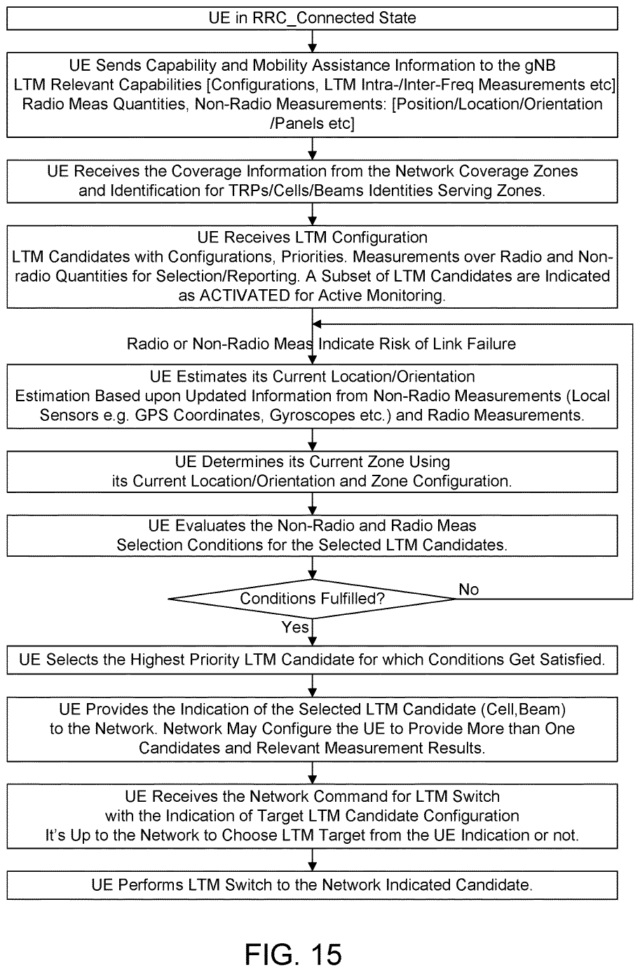

The current embodiment is shown as flowchart in FIG. 15 and it uses one or more following operations:

UE capability may be transferred for lower layer mobility/LTM handling and relevant assistance information to support LTM procedure based upon joint radio and non-radio measurement quantities.

UE receiving coverage and deployment topologies and the relevant configurations from the network.

UE receiving LTM Configurations along with suitable LTM Radio and Non-Radio measurement quantities and suitable Joint events for configuration selection purpose over a combination of radio measurements and non-radio measurements. The network may indicate any of the proposed joint events such as LTM-J1 to LTM-J6 as part of the configuration with suitable parameters and thresholds for the selection of the candidate configuration.

UE performing configured Radio and Non-Radio Measurements.

UE detecting the change in non-radio and radio measurement quantities.

UE determining its zone through non-radio measurements.

UE evaluation of the configured joint events with the conditions set over measurements of radio and non-radio quantities for ACTIVATED LTM configuration candidates.

If events associated to the configuration selection get triggered for at least one of the ACTIVATED configuration candidate, UE selects the associated configuration candidate for network reporting. UE transmitting UL indication of the selected configuration candidate.

UE receiving the network command to perform LTM mobility switch to a target candidate where the network indicated target may or may not be the same as selected by the UE.

UE performing the protocol stack handling as per the network indication in dynamic signaling or part of the LTM configuration.

UE transmitting UL indication as per the network configuration/indication where the network may indicate through LTM switching command or through prior configuration to transmit an RS or PUCCH based indication.

The above embodiment may include one or more following operations:

In case of more than one candidate configurations triggering the selection events, the UE selects the highest priority configuration for UL indication to the network where the priority indication can be part of the LTM candidate configurations.

In case of more than one candidate configurations triggering the selection events, the UE selects the candidate configuration being transmitted from its current DU where the DU information may be provided as part of the LTM configured candidate configurations.

In case of more than one candidate configurations triggering the selection events, the UE provides the N successful candidates as part of the UL indication where N is part of the network configuration.

### LTM Based Upon UE Transmitting UL Indication Over the Target Configuration Candidate

The current embodiment proposes the network controlled LTM switching procedure where the UE performs radio and non-radio measurements and assists in the LTM switching by providing the indication of the suitable LTM target configuration. The selection of the suitable LTM target configuration is performed by the UE through tracking, measuring and evaluating radio and non-radio quantities as per the network configuration. One key aspect of this embodiment is that the UE is configured with transmission parameters for the candidate configurations such that the indication relevant to the selected candidate is transmitted over the resource of the selected candidate. The signaling to the selected candidate can be RACH, a slim RACH preamble, or the transmission of a specific RS such as SRS. The UE can be provided with relevant QCL parameters for indication transmission over the configured resource.

As part of the configuration for the proposed procedure, the network provides the coverage topology information and also the parameters relevant to derive the UE zone information. The network also provides the necessary measurements information which allows UE to derive its zone information. The zone information can be derived from location information which UE can obtain from local GNSS measurements. This can be done through the local GNSS receiver. The location information can be derived or improved for accuracy through other 3GPP based or non-3GPP based measurements. The UE has a-priori informed the network about its capabilities in making non-3GPP radio and non-radio measurements.

The network configures the UE with a set of LTM candidate configurations. These candidate configurations comprise of the cell configuration. The network configuration also provides the events and conditions over radio and non-radio measurement quantities which the UE will measure and evaluate. The triggering of the configured events indicates that the LTM candidate configuration satisfies the selection criteria, thus, UE will report the indication of the LTM candidate configuration to the network for which events get triggered. The UE can be configured to provide periodic reporting to the network about the configured measurements for ACTIVATED configurations. To reduce the reporting overhead, the UE reporting can be event based and only reported if at least one of the ACTIVATED configurations meets the selection criteria. As part of the configuration for this embodiment, the network provides the suitable transmission resource associated to each candidate configuration where the UE will transmit the candidate selection indication when this candidate configuration is the selected candidate by the UE. In one design for RACH preamble based indication, each candidate configuration provides the RACH parameters (time, frequency, periodicity, sequence selection etc.). In a compatible design based upon a special PUCCH sequence based transmission, each candidate configuration provides the PUCCH resource, format and sequence number or initialization parameters etc. required to determine the resource and the signaling for selection indication. In another design based upon RS (e.g., SRS) transmission, each candidate configuration provides the relevant configuration for resource and signaling parameters. Once a configuration meets the configured selection criteria, the UE provides the UL indication using the resource and signaling associated to the selected candidate.

Upon receiving the indication of the candidate configuration meeting the selection criteria and potentially the other radio and non-radio measurements from the UE, the network can select a suitable LTM candidate target. The network selection of the target configuration can incorporate other system level aspects like load balancing, cell capabilities and other aspects which may not be visible to the UE. The network sends the LTM switching command to the UE through other relevant switching parameters as described earlier. The UE performs LTM switching to the network issued target according to the configuration and the network switching command.

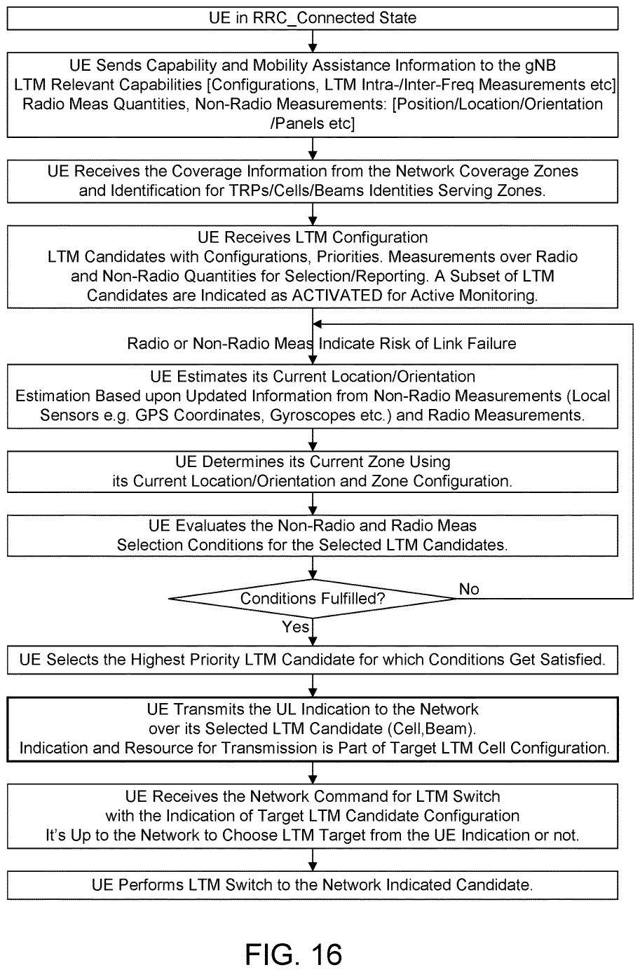

The current embodiment is shown as flowchart in FIG. 16 and it uses one or more following operations:

In an embodiment, referring to FIG. 16, a UE may be in RRC_Connected state, and the UE may send capability and mobility assistance information to the network (e.g., gNB), such as LTM relevant capabilities (e.g., configurations, LTM intra-/Inter-frequency measurements), radio measurement quantities, non-radio measurements (e.g., position/location/orientation, panels). UE capability may be transferred for lower layer mobility/LTM handling and relevant assistance information to support LTM procedure based upon joint radio and non-radio measurement quantities.

UE receiving coverage and deployment topologies and the relevant configurations from the network.

UE receiving LTM Configurations along with suitable LTM Radio and Non-Radio measurement quantities and suitable Joint events for configuration selection purpose over a combination of radio measurements and non-radio measurements. The network may indicate any of the proposed joint events such as LTM-J1 to LTM-J6 as part of the configuration for its selection. Each candidate configuration provides the UL indication resource and signaling parameters through which UE provides the UL indication upon selection of a candidate configuration.

UE performing configured Radio and Non-Radio Measurements.

UE detecting the change in non-radio and radio measurement quantities.

UE determining its zone through non-radio measurements.

UE evaluation of the configured joint events with the conditions set over measurements of radio and non-radio quantities for ACTIVATED LTM configuration candidates.

If events associated to the configuration selection get triggered for at least one of the ACTIVATED configuration candidate, UE selecting the associated configuration candidate. UE selecting the UL indication resource associated to the selected candidate configuration. UE transmitting UL indication over the selected resource using the signaling parameters associated to the selected candidate configuration.

UE receiving the network command from its serving cell to perform LTM mobility switch to a target candidate where the network indicated target may or may not be the same as selected by the UE.

UE performing the LTM mobility switch to the network indicated target as per the network command.

UE performing the protocol stack handling as per the network indication in dynamic signaling or part of the LTM configuration.

UE transmitting UL indication as per the network configuration/indication where the network may indicate through LTM switching command or through prior configuration to transmit an RS or PUCCH based indication.

The above embodiment where: in case of more than one candidate configurations triggering the selection events, the UE selects the highest priority configuration for UL indication to the network where the priority indication can be part of the LTM candidate configurations. In case of more than one candidate configurations triggering the selection events, the UE selects the candidate configuration being transmitted from its current DU where the DU information may be provided as part of the LTM configured candidate configurations.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method implemented by a wireless transmit/receive unit (WTRU), the method comprising:
sending information indicating a capability of measuring radio quantities and non-radio quantities associated with measurement of one or more rotational or translational motions;
receiving configuration information indicating 1) a zone configuration for determining a zone from radio and/or non-radio measurements and/or 2) a set of mobility configurations associated with the radio and/or non-radio measurements and a set of joint events;
estimating, based on the configuration information, the radio and/or non-radio measurements; and
transmitting, based on a joint event of the set of joint events being triggered, a measurement report indicating 1) the radio and/or non-radio measurements and 2) zone information derived from the estimated non-radio measurements, wherein at least a portion of the estimated non-radio measurements are associated with an orientation of the WTRU.

2. The method of claim 1, further comprising:
receiving an indication for a mobility switch using a target candidate configuration.

3. The method of claim 2, further comprising:
performing the mobility switch to a network based on the indication.

4. The method of claim 1, further comprising:
determining a current zone of the WTRU based on a second set of non-radio measurements; and
selecting at least one L1/L2 triggered mobility (LTM) configuration based on the current zone of the WTRU,
wherein a first set of radio and non-radio measurements are performed based on the at least one LTM configuration, and mobility switch is performed based on the at least one LTM configuration.

5. The method of claim 1, further comprising:
performing the radio and/or non-radio measurements.

6. The method of claim 1, further comprising:
detecting a change in radio and/or non-radio measurement quantities.

7. The method of claim 1, further comprising:
determining the zone through the non-radio measurements.

8. The method of claim 1, further comprising:
deriving a coverage zone from a coverage topology using the estimated non-radio measurements.

9. The method of claim 1, further comprising:
evaluating the set of joint events over radio and non-radio quantities using the estimated radio and/or non-radio measurements.

10. A wireless transmit/receive unit (WTRU) comprising circuitry, including a transmitter, receiver, a processor and memory, the WTRU configured to:
send information indicating a capability of measuring radio quantities and non-radio quantities associated with measurement of one or more rotational or translational motions;
receive configuration information indicating 1) a zone configuration for determining a zone from radio and/or non-radio measurements and/or 2) a set of mobility configurations associated with the radio and/or non-radio measurements and a set of joint events;
estimate, based on the configuration information, the radio and/or non-radio measurements; and
transmit, based on a joint event of the set of joint events being triggered, a measurement report indicating 1) the radio and/or non-radio measurements and 2) zone information derived from the estimated non-radio measurements, wherein at least a portion of the estimated non-radio measurements are associated with an orientation of the WTRU.

11. The WTRU of claim 10, wherein the WTRU is further configured to:
receive an indication for a mobility switch using a target candidate configuration.

12. The WTRU of claim 11, wherein the WTRU is further configured to:
perform the mobility switch to a network based on the indication.

13. The WTRU of claim 10, wherein the WTRU is further configured to:
determine a current zone of the WTRU based on a second set of non-radio measurements; and
select at least one L1/L2 triggered mobility (LTM) configuration based on the current zone of the WTRU,
wherein a first set of radio and non-radio measurements are performed based on the at least one LTM configuration, and mobility switch is performed based on the at least one LTM configuration.

14. The WTRU of claim 10, wherein the WTRU is further configured to:
perform the radio and/or non-radio measurements.

15. The WTRU of claim 10, wherein the WTRU is further configured to:
detect a change in radio and/or non-radio measurement quantities.

16. The WTRU of claim 10, wherein the WTRU is further configured to:
determine the zone through the non-radio measurements.

17. The WTRU of claim 10, wherein the WTRU is further configured to:
derive a coverage zone from a coverage topology using the estimated non-radio measurements.

18. The WTRU of claim 10, wherein the WTRU is further configured to:
evaluate the set of joint events over radio and non-radio quantities using the estimated radio and/or non-radio measurements.
